(19) United States
(12) Patent Application Publication
(10) Pub. No.: US 2018/0294484 A1
(43) Pub. Date: Oct. 11, 2018

(54) LOW-GASSING CARBON MATERIALS FOR IMPROVING PERFORMANCE OF LEAD ACID BATTERIES

(71) Applicants: Sarah FREDRICK, Seattle, WA (US); Avery SAKSHAUG, Everett, WA (US); Benjamin E. KRON, Seattle, WA (US); Dion HUBBLE, Seattle, WA (US); Henry R. COSTANTINO, Woodinville, WA (US); Aaron M. FEAVER, Seattle, WA (US); Leah A. THOMPKINS, Seattle, WA (US); Virginia Katherine ALSPAUGH, Seattle, WA (US); Phil HAMILTON, Seattle, WA (US); Katharine GERAMITA, Seattle, WA (US); Corey MEKELBURG, Middletown, MD (US); Frank REUTER, Undenheim (DE); Jacob Ebenstein GROSE, Ardsley, NY (US); Rebekka VON BENTEN, Ludwigshafen (DE); EnerG2 Technologies, Inc., Seattle, WA (US)

(72) Inventors: Sarah Fredrick, Seattle, WA (US); Avery J. Sakshaug, Everett, WA (US); Benjamin E. Kron, Seattle, WA (US); Dion Hubble, Seattle, WA (US); Henry R. Costantino, Woodinville, WA (US); Aaron M. Feaver, Seattle, WA (US); Leah A. Thompkins, Seattle, WA (US); Virginia Katherine Alspaugh, Seattle, WA (US); Phil Hamilton, Seattle, WA (US); Katharine Geramita, Seattle, WA (US); Cory Mekelburg, Middletown, MD (US); Frank Reuter, Undenheim (DE); Jacob Ebenstein Grose, Ardsley, NY (US); Rebekka Von Benten, Ludwigshafen (DE)

(73) Assignee: ENERG2 TECHNOLOGIES, INC., Seattle, WA (US)

(21) Appl. No.: 15/766,321

(22) PCT Filed: Oct. 14, 2016
(86) PCT No.: PCT/US2016/057216

§ 371 Date: Apr. 5, 2018

Related U.S. Application Data
(60) Provisional application No. 62/242,181, filed on Oct. 15, 2015.

(51) Int. Cl. H01M 4/66; H01M 4/14; C01B 32/05; G01N 27/30; H01M 4/62

(52) U.S. Cl. CPC H01M 4/663; H01M 4/14; C01B 32/05; H01M 2004/029; H01M 4/627; C01P 2006/12; C01P 2006/14; G01N 27/308

(57) ABSTRACT

Carbon materials having low gassing properties and electrodes and electrical energy storage devices, especially lead-acid batteries, comprising the same are provided.

### BACKGROUND

### Technical Field

The present application relates to carbon-based additives for addition to lead acid batteries and other related energy storage systems. The carbons disclosed herein improve the electrochemical properties, for example improved charge acceptance and cycle life, while providing for very low gassing, a known problem for previously described carbon-based and other additives employed for this purpose.

### Description of the Related Art

To meet current demands with respect to lead acid battery applications, a solution is required to achieve higher levels of charge acceptance to boost system efficiency and delay common failure mechanisms such as sulfation or dendritic growth. In modern cars, many advanced systems (navigation, heating, air conditioning, etc.) can increase electrical energy consumption beyond that which the alternator can replenish during normal periods. In order to maintain batteries at partial states of charge (SOC) and avoid irreversible sulfation on the negative active material (NAM), higher surface area and increased charge acceptance are necessary, and carbon-based additives can provide a solution.

Carbon has been added to the NAM during paste preparation in a variety of forms including carbon nanotubes, carbon black, and activated carbon. When incorporated in small weight percentages (e.g., 0.1-5%) in the NAM, carbon can increase charge acceptance by a factor of 2 or greater (200% or greater). However, carbon can also increase the propensity for gassing, and this undesirable result can be further exacerbated if the carbon contains impurities such as iron that may lead to more gas evolution and resulting water loss, which ultimately will lead to battery failure. Solving this carbon gassing issue is critical to improving the utility of carbons as additives in lead-acid and related battery systems. The current disclosure meets this need.

Conventional lead-acid energy storage devices may have limited active life and power performance. Hybrid energy storage devices employing either carbon or lead-acid electrodes (but not their combination at the same electrode) may provide some improvement and advantages over conventional lead-acid devices; however, their active life, energy capacity and power performance can likewise be limited. For example, lead dioxide-based positive electrodes often fail due to a loss of electronic contact of the active lead dioxide paste to the current collector grid after multiple charge/discharge cycles. Additionally, corrosion of the current collector (also referred to as the grid) increases resistance on the positive plate, and can lead to battery failure.

The negative electrodes of these devices also deteriorate upon multiple charge/discharge cycles, but by different mechanisms than the positive electrodes. Upon discharge, lead sulfate crystals are formed, and the dissolution of these crystals is vital for cell rechargability. The size of these sulfate crystals increases as a battery is required to maintain a partial-state-of-charge for normal battery function and this leads to ‘densification’ of the negative plate resulting in reduced charge acceptance, increased battery resistance and loss of capacity. In addition, the low surface area of the lead electrodes results in larger sulfate crystals, which limits the power performance and cycle life of these devices.

Carbon has been established in the art as an additive to lead acid battery and other related systems that has the potential to improve charge acceptance and improve cycle life. Yet, all carbon materials used as additives suffer from the negative side effect of increased gassing. Gassing in a lead acid battery is the production of hydrogen and oxygen gasses from the negative and positive plates, respectively, as a result of battery operation in voltage windows where water splitting is thermodynamically favorable. Typically, the operation of lead acid and related battery systems, for example in the context of a hybrid electric vehicle, will occur in partial state of charge and discharge with high currents. A high-rate discharge is associated with engine cranking, and high rate charge associated with regenerative braking. These high current pulses can result in significant increases in gassing reactions. Gassing leads to a reduction in the water content of the sulfuric acid electrolyte, increasing acid concentration—and as a result reduces charging efficiency—and in exacerbated conditions, leads to drying out of the battery entirely. This is not only a battery failure mechanism, but also a safety issue since batteries in this state can catch fire. It is in the interest of all battery makers to adopt a solution to improve battery performance (specifically charge acceptance and cycle life in partial-state-of-charge applications) while also maintaining low gassing (and therefore low water loss from the battery).

A primary reason to add carbon materials to the negative paste is to increase the surface area of the plate. This allows for greater charge acceptance and extended cycle life, however, it also increases hydrogen generation on the negative plate. The increased surface area of the plate creates a larger electrochemically active surface area, which allows for more reaction sites for the production of hydrogen gas. Additionally, the hydrogen evolution reaction occurs at a lower potential on a carbon surface than it does on a lead surface. So as a natural result of adding carbon, hydrogen generation at the negative plate is increased. While carbon has been proven to enhance positive performance attributes of lead acid batteries when added to the negative plate, to date, it has proven difficult to identify carbon-based additives that can provide the advantages of increased charge acceptance and improved cycle life, while not exhibiting high gassing.

Although the need for improved carbon materials for use in hybrid lead-carbon energy storage devices has been recognized, so far there is no carbon based solution identified to improve charge acceptance and cycle life while providing low gassing. Accordingly, there continues to be a need in the art for improved electrode materials for use in hybrid lead-carbon electrical energy storage devices, as well as for methods of making the same and devices containing the same. The present invention fulfills these needs and provides further related advantages.

### BRIEF SUMMARY

In general terms, the current invention is directed to compositions and devices for energy storage and distribution that employ a physical blend of carbon particles and lead particles that exhibits low gassing and other desirable electrochemical properties such as high cycle life and charge acceptance in the context of lead acid battery systems. These blends of lead with the low-gassing carbon materials exhibit desirable electrochemical properties suitable for use in hybrid carbon-lead energy storage devices. In some embodiments the low-gassing carbon particles are pyrolyzed carbon particles or activated carbon particles. In certain embodiments, the low-gassing carbon particles are ultrapure. In other embodiments the low-gassing carbon particles comprise a total PIXE impurity content of greater than 1000 PPM (i.e., “non-ultrapure”). The low-gassing carbon material may also comprise certain additives.

Accordingly, in one embodiment the present invention provides a low-gassing carbon additive for employment in lead acid and related battery systems, wherein said carbon material provides certain electrochemical enhancements, particularly increase in charge acceptance, while providing very low levels of gas generation compared to materials previously known. These novel, low-gassing carbon-based additives can be produced by a variety of methods as described herein.

Negative active materials comprising the low-gassing carbon-lead blends are also provided. Furthermore, energy storage devices comprising the negative active material are also provided. In addition, methods of using the novel compositions and devices are also provided.

In some embodiments, the invention provides a carbon material comprising less than an absolute value of 10 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

In other embodiments is provided a carbon material producing less than 100 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

In some other embodiments, the invention includes a carbon material producing less than 200 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

In different embodiments is provided a carbon material producing less than 5:1 (mA/mg current at −1.6 V vs Hg/Hg₂SO₄): (mA/mg current at 1.2 V vs Hg/Hg₂SO₄) when tested by cyclic voltammetry as a working electrode on a substrate comprising lead and employing a platinum counter electrode in the presence of electrolyte comprising sulfuric acid.

In more embodiments is provided a carbon material producing between 0.75:1 to 1.25:1 (mA/mg current at −1.4 V vs Hg/Hg₂SO₄): (mA/mg current at 1.2 V vs Hg/Hg₂SO₄) when tested by cyclic voltammetry as a working electrode on a substrate comprising lead and employing a platinum counter electrode in the presence of electrolyte comprising sulfuric acid.

In yet different embodiments, the invention is directed to a carbon material comprising at least 15% nitrogen by weight and a BET specific surface area of at least 300 m²/g.

Electrical energy storage devices comprising any of the disclosed carbon materials, and use of the disclosed carbon materials for storage and distribution of electrical energy is also provided.

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

In the figures, identical reference numbers identify similar elements. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 compares the normalized gassing current of commercial carbon black and Carbon 17-1 as a function of voltage.

FIG. 2 shows a comparison of the mass normal gassing current as a function of time for Carbon 17-1 and commercial carbon black measured at 2.4 and 2.67 V.

FIG. 3 is a plot of normalized charge acceptance as a function of time for Carbon 17-1 and commercial carbon black.

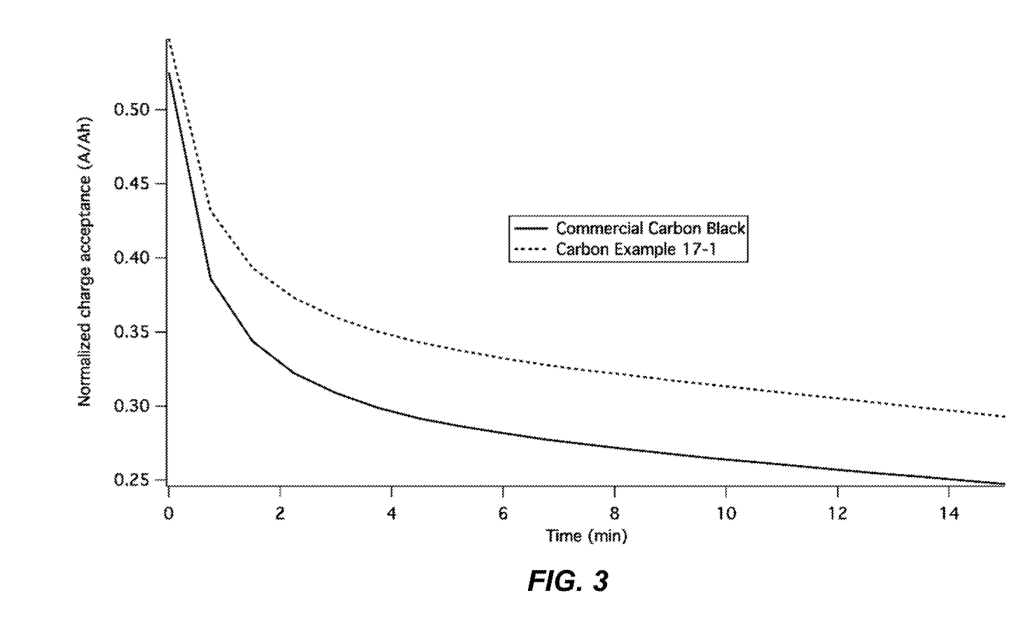

FIG. 4 shows the pore size distribution of Carbon 17-9 and Carbon 17-24.

FIG. 5 is thermogravimetric analysis (TGA) results comparing Carbon 17-25, Carbon 17-26, and Carbon 17-27.

FIG. 6 shows a plot of cyclic voltammetry results for carbon slurries of Carbon 17-1 (small particle size), Carbon 17-10 (micronized, no sieving), Carbon 17-20 (intermediate particle size), and Carbon 17-23 (passed through 212 μm sieves).

FIG. 7 shows a voltammogram of Carbon 17-15 after treatment with sulfuric acid, Carbon 17-16 after thermal treatment, and untreated Carbon 17-23.

FIG. 8 depicts gassing levels as measured by cyclic voltammetry using a 2 V cell.

FIG. 9 illustrates the gassing current, as measured by cyclic voltammetry, for carbon materials prepared using different methods of pyrolysis.

FIG. 10 shows a comparison of gassing current for carbons prepared using urea as measured by cyclic voltammetry.

FIG. 11 is a plot showing the increased gassing properties when carbons are treated with peroxide materials.

FIG. 12 shows cyclic voltammetry results comparing pyrolyzed carbons prepared with nitrogen-rich polymer gels.

FIG. 13 illustrates the effect of urea treatment on carbons prepared using nitrogen-rich polymer gels using cyclic voltammetry.

FIG. 14 depicts a plot of the first and second derivatives of low gassing as measured via cyclic voltammetry for Carbon 17-9.

FIG. 15 depicts a plot of the first and second derivatives of low gassing as measured via cyclic voltammetry for Carbon 17-16.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### Definitions

As used herein, and unless the context dictates otherwise, the following terms have the meanings as specified below.

“Absolute value” refers to the magnitude of a real number without regard to its sign. For example, a current of −5 mA/mg corresponds to an absolute value of 5 mA/mg.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like.

“Amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

“Crystalline” refers to a material whose constituent atoms, molecules, or ions are arranged in an orderly repeating pattern. Examples of crystalline carbon materials include, but are not limited to, diamond and graphene.

“Synthetic” refers to a substance which has been prepared by chemical means rather than from a natural source. For example, a synthetic carbon material is one which is synthesized from precursor materials and is not isolated from natural sources.

“Impurity” or “impurity element” refers to an undesired foreign substance (e.g., a chemical element) within a material which differs from the chemical composition of the base material. For example, an impurity in a carbon material refers to any element or combination of elements, other than carbon, which is present in the carbon material. Impurity levels are typically expressed in parts per million (ppm).

“PIXE impurity” or “PIXE element” is any impurity element having an atomic number ranging from 11 to 92 (i.e., from sodium to uranium). The phrases “total PIXE impurity content” and “total PIXE impurity level” both refer to the sum of all PIXE impurities present in a sample, for example, a polymer gel or a carbon material. Electrochemical modifiers are not considered PIXE impurities as they are a desired constituent of the carbon materials. For example, in some embodiments an element may be intentionally added to a carbon material, for example lead, and will not be considered a PIXE impurity, while in other embodiments the same element may not be desired and, if present in the carbon material, will be considered a PIXE impurity. PIXE impurity concentrations and identities may be determined by proton induced x-ray emission (PIXE).

“TXRF impurity” or “TXRF element” refers to any impurity or any element as detected by total X-ray reflection fluorescence (TXRF). The phrases “total TXRF impurity content” and “total TGXRF impurity level” both refer to the sum of all TXRF impurities present in a sample, for example, a polymer gel or a carbon material. Electrochemical modifiers are not considered TXRF impurities as they are a desired constituent of the carbon materials. For example, in some embodiments an element may be intentionally added to a carbon material, for example lead, and will not be considered a TXRF impurity, while in other embodiments the same element may not be desired and, if present in the carbon material, will be considered a TXRF impurity.

“Ultrapure” refers to a substance having a total PIXE impurity content or a total TXRF impurity content of less than 0.010%. For example, an “ultrapure carbon material” is a carbon material having a total PIXE impurity content of less than 0.010% or a total TXRF impurity content of less than 0.010% (i.e., 1000 ppm).

“Ash content” refers to the nonvolatile inorganic matter which remains after subjecting a substance to a high decomposition temperature. Herein, the ash content of a carbon material is calculated from the total PIXE impurity content as measured by proton induced x-ray emission or the total TXRF impurity content as measured by total X-ray reflection fluorescence, assuming that nonvolatile elements are completely converted to expected combustion products (i.e., oxides).

“Polymer” refers to a macromolecule comprised of two or more structural repeating units.

“Synthetic polymer precursor material” or “polymer precursor” refers to compounds used in the preparation of a synthetic polymer. Examples of polymer precursors that can be used in certain embodiments of the preparations disclosed herein include, but are not limited to, aldehydes (i.e., HC(═O)R, where R is an organic group), such as for example, methanal (formaldehyde); ethanal (acetaldehyde); propanal (propionaldehyde); butanal (butyraldehyde); glucose; benzaldehyde and cinnamaldehyde. Other exemplary polymer precursors include, but are not limited to, phenolic compounds such as phenol and polyhydroxy benzenes, such as dihydroxy or trihydroxy benzenes, for example, resorcinol (i.e., 1,3-dihydroxy benzene), catechol, hydroquinone, and phloroglucinol. Mixtures of two or more polyhydroxy benzenes are also contemplated within the meaning of polymer precursor.

“Monolithic” refers to a solid, three-dimensional structure that is not particulate in nature.

“Sol” refers to a colloidal suspension of precursor particles (e.g., polymer precursors), and the term “gel” refers to a wet three-dimensional porous network obtained by condensation or reaction of the precursor particles.

“Polymer gel” refers to a gel in which the network component is a polymer; generally a polymer gel is a wet (aqueous or non-aqueous based) three-dimensional structure comprised of a polymer formed from synthetic precursors or polymer precursors.

“Sol gel” refers to a sub-class of polymer gel where the polymer is a colloidal suspension that forms a wet three-dimensional porous network obtained by reaction of the polymer precursors.

“Polymer hydrogel” or “hydrogel” refers to a subclass of polymer gel or gel wherein the solvent for the synthetic precursors or monomers is water or mixtures of water and one or more water-miscible solvent.

“Carbon hydrogel” refers to a sub-class of a hydrogel wherein the synthetic polymer precursors are largely organic in nature.

“RF polymer hydrogel” refers to a sub-class of polymer gel wherein the polymer was formed from the catalyzed reaction of resorcinol and formaldehyde in water or mixtures of water and one or more water-miscible solvent.

“Acid” refers to any substance that is capable of lowering the pH of a solution. Acids include Arrhenius, Brønsted and Lewis acids. A “solid acid” refers to a dried or granular compound that yields an acidic solution when dissolved in a solvent. The term “acidic” means having the properties of an acid.

“Base” refers to any substance that is capable of raising the pH of a solution. Bases include Arrhenius, Brønsted and Lewis bases. A “solid base” refers to a dried or granular compound that yields basic solution when dissolved in a solvent. The term “basic” means having the properties of a base.

“Mixed solvent system” refers to a solvent system comprised of two or more solvents, for example, two or more miscible solvents. Examples of binary solvent systems (i.e., containing two solvents) include, but are not limited to: water and acetic acid; water and formic acid; water and propionic acid; water and butyric acid and the like. Examples of ternary solvent systems (i.e., containing three solvents) include, but are not limited to: water, acetic acid, and ethanol; water, acetic acid and acetone; water, acetic acid, and formic acid; water, acetic acid, and propionic acid; and the like. The present invention contemplates all mixed solvent systems comprising two or more solvents.

“Miscible” refers to the property of a mixture wherein the mixture forms a single phase over certain ranges of temperature, pressure, and composition.

“Catalyst” is a substance which alters the rate of a chemical reaction. Catalysts participate in a reaction in a cyclic fashion such that the catalyst is cyclically regenerated. The present disclosure contemplates catalysts which are sodium free. The catalyst used in the preparation of a ultrapure polymer gel as described herein can be any compound that facilitates the polymerization of the polymer precursors to form an ultrapure polymer gel. A “volatile catalyst” is a catalyst which has a tendency to vaporize at or below atmospheric pressure. Exemplary volatile catalysts include, but are not limited to, ammoniums salts, such as ammonium bicarbonate, ammonium carbonate, ammonium hydroxide, and combinations thereof. Generally such catalysts are used in the range of molar ratios of 10:1 to 2000:1 phenolic compound: catalyst. Typically, such catalysts can be used in the range of molar ratios of 20:1 to 200:1 phenolic compound: catalyst. For example, such catalysts can be used in the range of molar ratios of 25:1 to 100:1 phenolic compound: catalyst.

“Solvent” refers to a substance which dissolves or suspends reactants (e.g., ultrapure polymer precursors) and provides a medium in which a reaction may occur. Examples of solvents useful in the preparation of the gels, ultrapure polymer gels, ultrapure synthetic carbon materials and ultrapure synthetic amorphous carbon materials disclosed herein include, but are not limited to, water, alcohols and mixtures thereof. Exemplary alcohols include ethanol, t-butanol, methanol and mixtures thereof. Such solvents are useful for dissolution of the synthetic ultrapure polymer precursor materials, for example dissolution of a phenolic or aldehyde compound. In addition, in some processes such solvents are employed for solvent exchange in a polymer hydrogel (prior to freezing and drying), wherein the solvent from the polymerization of the precursors, for example, resorcinol and formaldehyde, is exchanged for a pure alcohol. In one embodiment of the present application, a cryogel is prepared by a process that does not include solvent exchange.

“Dried gel” or “dried polymer gel” refers to a gel or polymer gel, respectively, from which the solvent, generally water, or mixture of water and one or more water-miscible solvents, has been substantially removed.

“Pyrolyzed dried polymer gel” refers to a dried polymer gel which has been pyrolyzed but not yet activated, while an “activated dried polymer gel” refers to a dried polymer gel which has been activated.

“Cryogel” refers to a dried gel that has been dried by freeze drying.

“RF cryogel” refers to a dried gel that has been dried by freeze drying wherein the gel was formed from the catalyzed reaction of resorcinol and formaldehyde.

“Pyrolyzed cryogel” is a cryogel that has been pyrolyzed but not yet activated.

“Activated cryogel” is a cryogel which has been activated to obtain activated carbon material.

“Xerogel” refers to a dried gel that has been dried by air drying, for example, at or below atmospheric pressure.

“Pyrolyzed xerogel” is a xerogel that has been pyrolyzed but not yet activated.

“Activated xerogel” is a xerogel which has been activated to obtain activated carbon material.

“Aerogel” refers to a dried gel that has been dried by supercritical drying, for example, using supercritical carbon dioxide.

“Pyrolyzed aerogel” is an aerogel that has been pyrolyzed but not yet activated.

“Activated aerogel” is an aerogel which has been activated to obtain activated carbon material.

“Activate” and “activation” each refer to the process of heating a raw material or carbonized/pyrolyzed substance at an activation dwell temperature during exposure to oxidizing atmospheres (e.g., carbon dioxide, oxygen, steam or combinations thereof) to produce an “activated” substance (e.g., activated cryogel or activated carbon material). The activation process generally results in a stripping away of the surface of the particles, resulting in an increased surface area. Alternatively, activation can be accomplished by chemical means, for example, by impregnation of carbon-containing precursor materials with chemicals such as acids like phosphoric acid or bases like potassium hydroxide, sodium hydroxide or salts like zinc chloride, followed by carbonization. “Activated” refers to a material or substance, for example a carbon material, which has undergone the process of activation.

“Carbonizing”, “pyrolyzing”, “carbonization” and “pyrolysis” each refer to the process of heating a carbon-containing substance at a pyrolysis dwell temperature in an inert atmosphere (e.g., argon, nitrogen or combinations thereof) or in a vacuum such that the targeted material collected at the end of the process is primarily carbon. “Pyrolyzed” refers to a material or substance, for example a carbon material, which has undergone the process of pyrolysis.

“Dwell temperature” refers to the temperature of the furnace during the portion of a process which is reserved for maintaining a relatively constant temperature (i.e., neither increasing nor decreasing the temperature). For example, the pyrolysis dwell temperature refers to the relatively constant temperature of the furnace during pyrolysis, and the activation dwell temperature refers to the relatively constant temperature of the furnace during activation.

“Pore” refers to an opening or depression in the surface, or a tunnel in a carbon material, such as for example activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. A pore can be a single tunnel or connected to other tunnels in a continuous network throughout the structure.

“Pore structure” refers to the layout of the surface of the internal pores within a carbon material, such as an activated carbon material. Components of the pore structure include pore size, pore volume, surface area, density, pore size distribution and pore length. Generally the pore structure of activated carbon material comprises micropores and mesopores.

“Mesopore” generally refers to pores having a diameter between about 2 nanometers and about 50 nanometers while the term “micropore” refers to pores having a diameter less than about 2 nanometers. Mesoporous carbon materials comprise greater than 50% of their total pore volume in mesopores while microporous carbon materials comprise greater than 50% of their total pore volume in micropores.

“Surface area” refers to the total specific surface area of a substance measurable by the BET technique. Surface area is typically expressed in units of m²/g. The BET (Brunauer/Emmett/Teller) technique employs an inert gas, for example nitrogen, to measure the amount of gas adsorbed on a material and is commonly used in the art to determine the accessible surface area of materials.

“Connected” when used in reference to mesopores and micropores refers to the spatial orientation of such pores.

“Effective length” refers to the portion of the length of the pore that is of sufficient diameter such that it is available to accept salt ions from the electrolyte.

“Electrode” refers to a conductor through which electricity enters or leaves an object, substance or region.

“Binder” refers to a material capable of holding individual particles of a substance (e.g., a carbon material) together such that after mixing a binder and the particles together the resulting mixture can be formed into sheets, pellets, disks or other shapes. Non-exclusive examples of binders include fluoro polymers, such as, for example, PTFE (polytetrafluoroethylene, Teflon), PFA (perfluoroalkoxy polymer resin, also known as Teflon), FEP (fluorinated ethylene propylene, also known as Teflon), ETFE (polyethylenetetrafluoroethylene, sold as Tefzel and Fluon), PVF (polyvinyl fluoride, sold as Tedlar), ECTFE (polyethylenechlorotrifluoroethylene, sold as Halar), PVDF (polyvinylidene fluoride, sold as Kynar), PCTFE (polychlorotrifluoroethylene, sold as Kel-F and CTFE), trifluoroethanol and combinations thereof.

“Expander” refers to an additive used for adjusting the electrochemical and physical properties of a carbon-lead blend. Expanders may be included in electrodes comprising carbon-lead blends. Suitable expanders are known in the art and are available from commercial sources such as Hammond Expanders, USA.

“Inert” refers to a material that is not active in the electrolyte of an electrical energy storage device, that is it does not absorb a significant amount of ions or change chemically, e.g., degrade.

“Conductive” refers to the ability of a material to conduct electrons through transmission of loosely held valence electrons.

“Current collector” refers to a part of an electrical energy storage and/or distribution device which provides an electrical connection to facilitate the flow of electricity in to, or out of, the device. Current collectors often comprise metal and/or other conductive materials and may be used as a backing for electrodes to facilitate the flow of electricity to and from the electrode.

“Electrolyte” means a substance containing free ions such that the substance is electrically conductive. Electrolytes are commonly employed in electrical energy storage devices. Examples of electrolytes include, but are not limited to, sulfuric acid.

“Elemental form” refers to a chemical element having an oxidation state of zero (e.g., metallic lead).

“Oxidized form” form refers to a chemical element having an oxidation state greater than zero.

“Total Pore Volume” refers to single point nitrogen sorption.

“DFT Pore Volume” refers to pore volume within certain pore size ranges calculated by density functional theory from nitrogen sorption data.

“Charge acceptance” related specifically to lead acid battery and related systems, wherein “charge acceptance” generally refers to the quantity of charge passed during a potentiostatic hold.

“Low-gassing carbon” carbon refers a novel carbon material (as disclosed herein) that exhibits low extent of gas generation when incorporated into the NAM of a lead acid battery. In the context of the current disclosure, the novel low-gassing carbon materials herein provide lower gas generation relative to previously described carbon materials, including carbon blacks.

“Cycle life” refers generally to the number of cycles of energy storage and discharge for a given energy storage system, for example a lead acid battery, between a upper and lower bounds of said device's energy storage capability, before exhibiting a undesirable drop in energy storage capability.

A. Blends of Low-Gassing Carbon Additives for Lead Acid and Related Battery Systems

The present disclosure is directed to carbon additives for use in lead acid and related battery systems. These carbon materials provide certain electrochemical enhancements, including, but not limited to, increased charge acceptance and improved cycle life, while also providing very low gas generation compared to previously disclosed carbon materials for this purpose. The low-gassing carbon can be provided as a powder comprised of low-gassing carbon particles, and this powder can be blended with lead particles to create a blend of low-gassing carbon and lead particles.

The disclosed low-gassing blend comprises a plurality of low-gassing carbon particles and a plurality of lead particles. The mass percent of low-gassing carbon particles as a percentage of the total mass of low-gassing carbon particles and lead particles can be varied from 0.01% to 99.9%. In other various embodiments the mass percent of low-gassing carbon particles as a percentage of the total mass of low-gassing carbon particles and lead particles ranges from 0.01% to 20%, for example from 0.1% to 10% or from 1.0% to 2.0%. In other embodiments, the mass percent of low-gassing carbon particles as a percentage of the total mass of low-gassing carbon particles and lead particles ranges from 0.01% to 2%, from 0.5% to 2.5% or from 0.75% to 2.25%, or from 0.1 to 5.0, or from 0.5 to 5.0. In some other embodiments, the mass percent of low-gassing carbon particles as a percentage of the total mass of low-gassing carbon particles and lead particles ranges from 0.9% to 1.1%, from 1.1% to 1.3%, from 1.3% to 1.5%, from 1.5% to 1.7%, from 1.7% to 1.9% or from 1.9% to 2.1%. In some embodiments the mass percent of low-gassing carbon particles as a percentage of the total mass of low-gassing carbon particles and lead particles is about 50%.

Alternatively, in other embodiments the mass percent of low-gassing carbon particles as a percentage of the total mass of low-gassing carbon particles and lead particles ranges from 0.1% to 50%, from 0.1% to 10%, from 1% to 10%, from 1% to 5% or 1% to 3%. In still other embodiments, the mass percent of low-gassing carbon particles as a percentage of the total mass of low-gassing carbon particles and lead particles ranges from 50% to 99.9%, from 90% to 99.9% or from 90% to 99%.

The volume percent of low-gassing carbon particles as a percentage of the total volume of low-gassing carbon particles and lead particles can be varied from 0.1% to 99.9%. In various embodiments the volume percent of low-gassing carbon particles as a percentage of the total volume of low-gassing carbon particles and lead particles ranges from 1% to 99%, from 2% to 99%, from 3% to 99%, from 4% to 99%, from 5% to 99%, from 6% to 99%, from 7% to 99%, from 8% to 99%, from 9% to 99%, from 10% to 90%, from 20% to 80%, from 20% to 40%, from 1% to 20%, from 40% to 80% or from 40% to 60%. In some certain embodiment the volume percent of low-gassing carbon particles as a percentage of the total volume of low-gassing carbon particles and lead particles is about 50%.

In other alternative embodiments, the volume percent of low-gassing carbon particles as a percentage of the total volume of low-gassing carbon particles and lead particles ranges from 0.1% to 50%, from 0.1% to 10% or from 1% to 10%. In other embodiments, the volume percent of low-gassing carbon particles as a percentage of the total volume of low-gassing carbon particles and lead particles ranges from 50% to 99.9%, from 90% to 99.9% or from 90% to 99%.

The surface area percent of low-gassing carbon particles as a percentage of the total surface area of low-gassing carbon particles and lead particles can also be varied, for example from 0.1% to 99.9%. In some embodiments the surface area percent of low-gassing carbon particles as a percentage of the total surface area of low-gassing carbon particles and lead particles ranges from 1% to 99%, from 10% to 90%, from 20% to 80% or from 40% to 60%. In another embodiment, the surface area percent of low-gassing carbon particles as a percentage of the total surface area of low-gassing carbon particles and lead particles is about 50%.

In related embodiments, the surface area percent of low-gassing carbon particles as a percentage of the total surface area of low-gassing carbon particles and lead particles ranges from 0.1% to 50%, from 0.1% to 10% or from 1% to 10%. In other embodiments, the surface area percent of low-gassing carbon particles as a percentage of the total surface area of low-gassing carbon particles and lead particles ranges from 80% to 100%, for example from 80% to 99.9%, from 80% to 99%, from 85% to 99% or from 90% to 99%. For example, in some embodiments the surface area percent of low-gassing carbon particles as a percentage of the total surface area of low-gassing carbon particles and lead particles ranges from 90% to 92%, from 92%, from 92% to 94%, from 94% to 96%, from 96% to 98% or from 93% to 99% or even to 99.9%. Alternatively, the surface area percent of low-gassing carbon particles as a percentage of the total surface area of low-gassing carbon particles and lead particles ranges from 50% to 99.9%, from 90% to 99.9% or from 90% to 99%.

The low-gassing carbon particle surface area residing in pores less than 20 angstroms as a percentage of the total surface area of low-gassing carbon particles and lead particles can be varied from 0.1% to 99.9%. In some embodiments, the low-gassing carbon particle surface area residing in pores less than 20 angstroms as a percentage of the total surface area of low-gassing carbon particles and lead particles ranges from 1% to 99%, from 10% to 90%, from 20% to 80%, from 20% to 60% or from 40% to 60%. In another embodiment, the low-gassing carbon particle surface area residing in pores less than 20 angstroms as a percentage of the total surface area of low-gassing carbon particles and lead particles is about 50%.

In other related embodiments, the low-gassing carbon particle surface area residing in pores less than 20 angstroms as a percentage of the total surface area of low-gassing carbon particles and lead particles ranges from 0.1% to 50%, 0.1% to 10% or from 1% to 10%. Alternatively, the low-gassing carbon particle surface area residing in pores less than 20 angstroms as a percentage of the total surface area of low-gassing carbon particles and lead particles ranges from 50% to 99.9%, from 90% to 99.9% or from 90% to 99%.

In another embodiment, the low-gassing carbon particle surface area residing in pores greater than 20 angstroms as a percentage of the total surface area of low-gassing carbon particles and lead particles ranges from 0.1% to 99.9%. For example, in various embodiments, the low-gassing carbon particle surface area residing in pores greater than 20 angstroms as a percentage of the total surface area of low-gassing carbon particles and lead particles ranges from 1% to 99%, from 10% to 90%, from 20% to 80% or from 40% to 6%. In a certain embodiment, the low-gassing carbon particle surface area as a percentage of the total surface area of low-gassing carbon particles and lead particles ranges from is about 50%.

Alternatively, in a different embodiment, the low-gassing carbon particle surface area residing in pores greater than 20 angstroms as a percentage of the total surface area of low-gassing carbon particles and lead particles ranges from 0.1% to 50%. For example, in some embodiments, the low-gassing carbon particle surface area residing in pores greater than 20 angstroms as a percentage of the total surface area of low-gassing carbon particles and lead particles ranges from 0.1% to 10% or from 1% to 10%. In another embodiment, the low-gassing carbon particle surface area residing in pores greater than 20 angstroms as a percentage of the total surface area of low-gassing carbon particles and lead particles ranges from 50% to 99.9%, from 90% to 99.9% or from 90% to 99%.

Alternatively, in a different embodiment, the low-gassing carbon particle surface area residing in pores greater than 500 angstroms as a percentage of the total surface area of low-gassing carbon particles and lead particles ranges from 0.1% to 30%. For example, in some embodiments, the low-gassing carbon particle surface area residing in pores greater than 500 angstroms as a percentage of the total surface area of low-gassing carbon particles and lead particles ranges from 0.1% to 20% or from 1% to 20%. In another embodiment, the low-gassing carbon particle surface area residing in pores greater than 500 angstroms as a percentage of the total surface area of low-gassing carbon particles and lead particles ranges from 0.1% to 10% or from 1% to 10%. In another embodiment, the low-gassing carbon particle surface area residing in pores greater than 20 angstroms as a percentage of the total surface area residing in pores greater than 20 angstroms of low-gassing carbon particles and lead particles ranges from 50% to 99.9%, from 90% to 99.9% or from 90% to 99%.

In some embodiments, the volume average particle size of the low-gassing carbon particles relative to the volume average particle size of the lead particles ranges from 0.000001:1 to 100000:1. For example, in some embodiments the volume average particle size of low-gassing carbon particles relative to the volume average particle size of lead particles ranges from 0.0001:1 to 10000:1, from 0.001:1 to 1000:1, from 0.01:1 to 100:1, from 0.01:1 to 10:1, from 0.1:1 to 2:1, from 0.1:1 to 10:1 or from 1:1 to 1000:1. In one embodiment the volume average particle size of the low-gassing carbon particles relative to the volume average particle size of the lead particles is about 1.1.

In certain embodiments, the composition of particles is comprised of more than one population of low-gassing carbon particles and/or more than one population of lead particles. The different populations can be different with respect to various physical-chemical attributes such as, particle size, extent of meso- or microporosity, surface functionality, and the like. For example, in some embodiments, the blend comprises a multi-modal low-gassing carbon particle size distribution and lead particles. For example, the low-gassing carbon particles can be comprised of two size modes. For example, in some embodiments the ratio between the two size modes ranges from 0.000001:1 to 100000:1, for example in a one embodiment the ratio between the two size modes is about 0.001:1.

The lead particles can be any type of particle that comprises lead. For example, the lead particles may comprise elemental lead, oxidized lead and/or lead salts. In certain embodiments, the lead particles comprise lead (II) oxide, lead (IV) oxide, lead acetate, lead carbonate, lead sulfate, lead orthoarsenate, lead pyroarsenate, lead bromide, lead caprate, lead carproate, lead caprylate, lead chlorate, lead chloride, lead fluoride, lead nitrate, lead oxychloride, lead orthophosphate sulfate, lead chromate, lead chromate, basic, lead ferrite, lead sulfide, lead tungstate or combinations thereof.

The blends described herein may also be provided in the form of a composition comprising the blend and a solvent (e.g., electrolyte), a binder, and expander or combinations thereof. In certain embodiments the compositions are in the form of a paste. The compositions can be prepared by admixing the low-gassing carbon particles, lead particles and the solvent (e.g., electrolyte), binder, expander or combinations thereof. The density of the compositions varies from about 2.0 g/cc to about 8 g/cc, from about 3.0 g/cc to about 7.0 g/cc or from about 4.0 g/cc to about 6.0 g/cc. In still other embodiments, the density of the composition is from about 3.5 g/cc to about 4.0 g/cc, from about 4.0 g/cc to about 4.5 g/cc, from about 4.5 g/cc to about 5.0 g/cc, from about 5.0 g/cc to about 5.5 g/cc, from about 5.5 g/cc to about 6.0 g/cc, from about 6.0 g/cc to about 6.5 g/cc, or from about 6.5 g/cc to about 7.0 g/cc.

The purity of the low-gassing carbon-lead blends can contribute to the electrochemical performance of the same. In this regard, the purity is determined by methods known in the art. Exemplary methods to determine purity include PIXE analysis and tXRF. For the purpose of the current disclosure, impurities are described with respect to the blend excluding any lead content. Below and through this disclosure, all descriptions of impurity apply to PIXE, tXRF, or other impurity method determinations as known in the art. In some embodiments, impurities are measures by PIXE. In other embodiments, impurities are measured by tXRF.

In some embodiments, the blend comprises a total impurity content of elements (excluding any lead) of less than 500 ppm and an ash content (excluding any lead) of less than 0.08%. In further embodiments, the blend comprises a total impurity content of all other elements of less than 300 ppm and an ash content of less than 0.05%. In other further embodiments, the blend comprises a total impurity content of all other elements of less than 200 ppm and an ash content of less than 0.05%. In other further embodiments, the blend comprises a total impurity content of all other elements of less than 200 ppm and an ash content of less than 0.025%. In other further embodiments, the blend comprises a total impurity content of all other elements of less than 100 ppm and an ash content of less than 0.02%. In other further embodiments, the blend comprises a total impurity content of all other elements of less than 50 ppm and an ash content of less than 0.01%.

The amount of individual impurities present in the disclosed blends can be determined by proton induced x-ray emission. Individual impurities may contribute in different ways to the overall electrochemical performance of the disclosed low-gassing carbon materials. Thus, in some embodiments, the level of sodium present in the blend is less than 1000 ppm, less than 500 ppm, less than 100 ppm, less than 50 ppm, less than 10 ppm, or less than 1 ppm. In some embodiments, the level of magnesium present in the blend is less than 1000 ppm, less than 100 ppm, less than 50 ppm, less than 10 ppm, or less than 1 ppm. In some embodiments, the level of aluminum present in the blend is less than 1000 ppm, less than 100 ppm, less than 50 ppm, less than 10 ppm, or less than 1 ppm. In some embodiments, the level of silicon present in the blend is less than 500 ppm, less than 300 ppm, less than 100 ppm, less than 50 ppm, less than 20 ppm, less than 10 ppm or less than 1 ppm. In some embodiments, the level of phosphorous present in the blend is less than 1000 ppm, less than 100 ppm, less than 50 ppm, less than 10 ppm, or less than 1 ppm. In some embodiments, the level of sulfur present in the blend is less than 1000 ppm, less than 100 ppm, less than 50 ppm, less than 30 ppm, less than 10 ppm, less than 5 ppm or less than 1 ppm. In some embodiments, the level of chlorine present in the blend is less than 1000 ppm, less than 100 ppm, less than 50 ppm, less than 10 ppm, or less than 1 ppm. In some embodiments, the level of potassium present in the blend is less than 1000 ppm, less than 100 ppm, less than 50 ppm, less than 10 ppm, or less than 1 ppm. In other embodiments, the level of calcium present in the blend is less than 100 ppm, less than 50 ppm, less than 20 ppm, less than 10 ppm, less than 5 ppm or less than 1 ppm. In some embodiments, the level of chromium present in the blend is less than 1000 ppm, less than 100 ppm, less than 50 ppm, less than 10 ppm, less than 5 ppm, less than 4 ppm, less than 3 ppm, less than 2 ppm or less than 1 ppm. In other embodiments, the level of iron present in the blend is less than 50 ppm, less than 20 ppm, less than 10 ppm, less than 5 ppm, less than 4 ppm, less than 3 ppm, less than 2 ppm or less than 1 ppm. In other embodiments, the level of nickel present in the blend is less than 20 ppm, less than 10 ppm, less than 5 ppm, less than 4 ppm, less than 3 ppm, less than 2 ppm or less than 1 ppm. In some other embodiments, the level of copper present in the blend is less than 140 ppm, less than 100 ppm, less than 40 ppm, less than 20 ppm, less than 10 ppm, less than 5 ppm, less than 4 ppm, less than 3 ppm, less than 2 ppm or less than 1 ppm. In yet other embodiments, the level of zinc present in the blend is less than 20 ppm, less than 10 ppm, less than 5 ppm, less than 2 ppm or less than 1 ppm. In yet other embodiments, the sum of all other impurities (excluding the lead) present in the blend is less than 1000 ppm, less than 500 pm, less than 300 ppm, less than 200 ppm, less than 100 ppm, less than 50 ppm, less than 25 ppm, less than 10 ppm or less than 1 ppm. As noted above, in some embodiments other impurities such as hydrogen, oxygen and/or nitrogen may be present in levels ranging from less than 10% to less than 0.01%.

In some embodiments, the blend comprises undesired impurities near or below the detection limit of the proton induced x-ray emission analysis. For example, in some embodiments the blend comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm, technetium, less than 7 ppm rubidium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hafnium, less than 1 ppm tantalum, less than 1 ppm tungsten, less than 1.5 ppm rhenium, less than 1 ppm osmium, less than 1 ppm iridium, less than 1 ppm platinum, less than 1 ppm silver, less than 1 ppm mercury, less than 1 ppm thallium, less than 1.5 ppm bismuth, less than 2 ppm thorium, or less than 4 ppm uranium.

In some specific embodiments, the blend comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission. In other specific embodiments, the blend comprises less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, the blend comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the blend comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In other embodiments, the blend comprises less than 5 ppm chromium, less than 10 ppm iron, less than 5 ppm nickel, less than 20 ppm silicon, less than 5 ppm zinc, and bismuth, silver, copper, mercury, manganese, platinum, antimony and tin are not detected as measured by proton induced x-ray emission.

In other embodiments, the blend comprises less than 75 ppm bismuth, less than 5 ppm silver, less than 10 ppm chromium, less than 30 ppm copper, less than 30 ppm iron, less than 5 ppm mercury, less than 5 ppm manganese, less than 20 ppm nickel, less than 5 ppm platinum, less than 10 ppm antimony, less than 100 ppm silicon, less than 10 ppm tin and less than 10 ppm zinc as measured by proton induced x-ray emission.

In other embodiments, the blend comprises less than 5 ppm chromium, 10 ppm iron, less than 5 ppm nickel, less than 20 ppm silicon, less than 5 ppm zinc and bismuth, silver, copper, mercury, manganese, platinum, antimony and tin are not detected as measured by proton induced x-ray emission as measured by proton induced x-ray emission.

Other embodiments of the present invention include use of the disclosed low-gassing carbon-lead blends in an electrical energy storage device. In some embodiments, the electrical energy storage device is a battery. In other embodiments, the electrical energy storage device is in a microhybrid, start-stop hybrid, mild-hybrid vehicle, vehicle with electric turbocharging, vehicle with regenerative braking, hybrid vehicle, an electric vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system. Electrical energy storage devices are described in more detail below.

B. Low-Gassing Carbon Materials

A variety of approaches are envisioned to achieve low gassing for the disclosed carbon materials. In a certain embodiment, the extent of gassing is related to the surface functionality of the carbon, for example the content of oxygen and different species comprising oxygen that are present on the surface of the carbon particle. Minimizing this surface oxygen, in turn, reduces the gassing propensity for the carbon when used as an additive in a lead acid battery or other related energy storage system. In certain embodiments, the reactive oxygen is present on an edge site, for example a graphitic edge plane or other defect present in the carbon surface. In certain embodiments, the low gassing carbon has less than 10% oxygen content, for example less than 5% oxygen, for example less than 3% oxygen, for example less than 2% oxygen, for example less than 1% oxygen, for example less than 0.5% oxygen, for example less than 0.3% oxygen, for example less than 0.2% oxygen, for example less than 0.1% oxygen, for example less than 0.05% oxygen, for example less than 0.02% oxygen, for example less than 0.01% oxygen. In some embodiments, the low gassing carbon has a content of oxygen present on edge sites that comprise, for example less than 10% oxygen, for example less than 5% oxygen, for example less than 3% oxygen, for example less than 2% oxygen, for example less than 1% oxygen, for example less than 0.5% oxygen, for example less than 0.3% oxygen, for example less than 0.2% oxygen, for example less than 0.1% oxygen, for example less than 0.05% oxygen, for example less than 0.02% oxygen, for example less than 0.01% oxygen. In some embodiments, the surface functionality of the carbon can be ascertained by and related to pH. For such embodiments, the pH of the carbon can be greater than pH 6.0, for example greater than pH 7.0, for example greater than pH 8.0, for example greater than pH 9.0, for example greater than pH 10.0, for example greater than pH 11.0. In certain embodiments, the low gassing carbon exhibits a pH between pH 6.0 and pH 11.0, for example between pH 6.0 and pH 10.0, for example between pH 7.0 and pH 9.0, for example between pH 8.0 and pH 10.0, for example between pH 7.0 and pH 9.0, for example between pH 8.0 and pH 9.0.

In preferred embodiments, the pH of the low gassing carbon is below 7.5, for example between 7.0 and 7.4, for example between 6.5 and 7.0, for example between 6.0 and 6.5, for example between 5.5 and 6.0, for example between 5.0 and 5.5.

In certain embodiments the surface oxygen on the carbon is reacted with certain moiety(ties) to remove the surface oxygen or otherwise convert it to a species that results in a low gassing carbon material when used as an additive in a lead acid battery or other related energy storage system. Such moieties for removing or converting the oxygen functionality on the carbon includes, but are not limited to, amine (including, but not limited to, diethylenetriamine, diethylamine, triethylamine, and the like), and polypyrols (and other polymer systems capable of oxygen reactions).

In another embodiment, the carbon oxygen groups on the carbon are eliminated, or other rendered incapable of contributing to gassing by the addition of a second coating of carbon on the carbon particle to cover its surface. In this context, the second carbon layer can be applied as known in the art, for example by chemical vapor deposition (CVD).

In some embodiments, the low-gassing carbon comprises a smooth surface, namely with reduced surface roughness that can contribute to its potential for gassing. For example, the ratio of the characteristic length of surface roughness to the characteristic particle size can be less than 1:10, for example less than 1:20, for example less than 1:30, for example less than 1:40, for example less than 1:50, for example less than 1:60, for example less than 1:80, for example less than 1:100, for example less than 1:200, for example less than 1:250, for example less than 1:500, for example less than 1:1000, for example less than 1:2500, for example less than 1:5000, for example less than 1:10,000, for example less than 1:100,000, for example less than 1:1,000,000, for example less than 1:10,000,000, for example less than 1:100,000,000, for example less than 1:1,000,000,000.

In some embodiments, the low-gassing carbon is produced by a heat treatment or passivation approach. For instance, the carbon can be exposed to elevated temperature in the presence of a non-oxidizing (or reducing) gas for a certain period of time. The dwell time can be varied, for example, the dwell time can be about 10 min, or about 30 min, for about 60 min, or about 120 min. In some embodiments, the dwell time in greater than 120 min. The gas can be varied, for exemplary gases including but are not limited to, nitrogen, hydrogen, ammonia, and combinations thereof. The elevated temperature can be between 550 and 650 C, for example between 650 and 750 C, for example between 700 and 800 C, for example between 750 and 850 C, for example between 850 and 950 C, for example between 950 and 1050 C. In certain embodiments, the heat treatment can be carried out at a temperature in excess of 1050 C, for example in excess of 1100 C, for example in excess of 1200 C, for example in excess of 1300 C, for example in excess of 1400 C, for example in excess of 1600 C, for example in excess of 1800 C, for example in excess of 2000 C, for example in excess of 2200 C, for example in excess of 2400 C. In many of these embodiments, the heat treatment not only provides for reduction in surface oxygen functionality and increased pH (see exemplary ranges above), but also provides for a certain degree of graphitization. The extent of graphitization can be quantitated by methods known in the art, for instance by x-ray diffraction of Raman spectroscopy. The degree of graphitization can be varied, for example the extent of graphitization can be between 1% and 5%. In other embodiments, the extent of graphitization can be between 5% and 15%. In alternate embodiments, the extent of graphitization can be between 15% and 25%. In alternate embodiments, the extent of graphitization can be between 20% and 40%. In alternate embodiments, the extent of graphitization can be between 30% and 70%. In alternate embodiments, the extent of graphitization can be between 60% and 90%. In alternate embodiments, the extent of graphitization can greater than 90%.

In certain embodiments, the low-gassing carbon is heat treated in the presence of a nitrogen-containing compound. The nitrogen containing compound can be in the gas phase, and examples nitrogen-containing gases suitable for this purpose include, but are not limited to, ammonia gas. The nitrogen-containing compounds can also be a solid or liquid, and the nitrogen-containing solid or liquid can be mixed with the carbon, and the mixture can be heat treated for a certain temperature and time, and in the presence of a non-oxidizing (or reducing) gas according to the various exemplary ranges discussed above. Nitrogen-containing compounds suitable for this purpose include, but are limited to, urea, melamine, cyanuric acid, ammonium salts, and combinations thereof.

The specific surface functional groups on the carbon, as measured by techniques known in the art such as Boehm titration method, can be varied.

In certain embodiments, the total carboxyl groups are present at less than 1 mMol/g carbon, for example less than 0.1 mMol/g carbon, for example less than 0.01 mMol/g carbon. In certain embodiments, the total lactone groups are present at less than 1 mMol/g carbon, for example less than 0.1 mMol/g carbon, for example less than 0.01 mMol/g carbon. In certain embodiments, the total phenol groups are present at less than 1 mMol/g carbon, for example less than 0.1 mMol/g carbon, for example less than 0.01 mMol/g carbon. In certain embodiments, the total acid groups are present at less than 1 mMol/g carbon, for example less than 0.1 mMol/g carbon, for example less than 0.01 mMol/g carbon.

In some embodiments, the carbon is hydrophobic. The extent of hydrophobocity can be measured by methods known in the art, for example calorimetry coupled with n-butanol adsorption. The non-polar surface area of the carbon can be varied, for example, the non-polar surface area can comprise more than 30% of the total surface area, for example more than 40% of the total surface area, for example more than 50% of the total surface area, for example more than 60% of the total surface area, for example more than 70% of the total surface area, for example more than 80% of the total surface area, for example more than 90% of the total surface area. In certain embodiments, the carbon is comprised of micropores and mesopores, in combination with certain extent of hydrophobocity. In some embodiments, the carbon is comprised of greater than 80% micropores, less than 20% mesopores, and the non-polar surface area comprises more than 50% of the total surface area. In other embodiments, the carbon is comprised of greater than 80% micropores, less than 20% mesopores, and the non-polar surface area comprises more than 80% of the total surface area. In other embodiments, the carbon is comprised of greater than 80% micropores, less than 20% mesopores, and the non-polar surface area comprises more than 90% of the total surface area. In some embodiments, the carbon is comprised of less than 80% micropores, more than 20% mesopores, and the non-polar surface area comprises more than 50% of the total surface area. In other embodiments, the carbon is comprised of less than 80% micropores, more than 20% mesopores, and the non-polar surface area comprises more than 80% of the total surface area. In other embodiments, the carbon is comprised of less than 80% micropores, more than 20% mesopores, and the non-polar surface area comprises more than 90% of the total surface area.

In some embodiments, the carbon is subject to atomic layer deposition (ALD) to place a thin atomic layer on the surface of the carbon. The selection of moieties for the deposition, and the deposition conditions (time and temperature) are known in the art. Exemplary compounds as moieties for deposition include, but are not limited to, Al2O3, TiO2, ZrO2, TiN, lead oxide and other lead-containing compounds. Accordingly, ALD can be applied to the carbon to achieve a thick layer of atoms, wherein exemplary atoms for coating the carbon includes, but are not limited to, aluminum, zinc, titanium, and lead. The thickness of the ALD layer can be varied, for example the ALD layer can be less than 100 nm, for example less than 50 nm, for example less than 40 nm, for example less than 30 nm, for example less than 20 nm, for example less than 10 nm, for example less than 5 nm. In certain embodiments, the ALD layer is essentially a monolayer. In other embodiments, the ALD layer is between 100 and 1000 nm, for example between 200 and 500 nm.

Alternatively, the surface of the carbon particle can be coated by electrodeposition, via processing conditions known in the art. Exemplary compounds for such electrochemical deposition include, but are not limited to, lead compounds such as lead halide, lead nitrate, and nickel compounds.

In other embodiments, the carbon surface is coated with a sulfate compounds, for example barium sulfate. The surface layer of barium sulfate can be achieved by coating wherein the barium sulfate is in solid form, or alternatively, is dissolved in a suitable liquid, for example water. The solid or liquid containing barium sulfate can be employed for coating on the carbon surface by a variety of methods as known in the art, including, but not limited to, spin coating, spray coating, evaporative coating, electrostatic powder coating, sputter coating, and thermoplastic powder coating.

Alternatively, the sulfate compound, for example barium sulfate, can be present within pores within the carbon material. The impregnation of the barium sulfate or other sulfate compounds can be achieved by methods known in the art, for example by soaking the carbon particles in the presence of a barium sulfate solution for conditions sufficient to accomplish diffusion of the barium sulfate into the carbon pores.

In some embodiments, the carbon surface is modified with silicon. The carbon can be coated with silicon according to various techniques known in the art. In preferred embodiments, the silicon coating is applied by subjecting the carbon particles to silane gas at elevated temperature and the presence of a silicon-containing gas, preferably silane, in order to achieve silicon deposition via chemical vapor deposition (CVD). The silane gas can be mixed with other inert gases, for example, nitrogen gas. The temperature and time of processing can be varied, for example the temperature can be between 300 and 400 C, for example between 400 and 500 C, for example between 500 and 600 C, for example between 600 and 700 C, for example between 700 and 800 C, for example between 800 and 900 C. The mixture of gas can comprise between 0.1 and 1% silane and remainder inert gas. Alternatively, the mixture of gas can comprise between 1% and 10% silane and remainder inert gas. Alternatively, the mixture of gas can comprise between 10% and 20% silane and remainder inert gas. Alternatively, the mixture of gas can comprise between 20% and 50% silane and remainder inert gas. Alternatively, the mixture of gas can comprise above 50% silane and remainder inert gas. Alternatively, the gas can essentially be 100% silane gas. Other silicon-containing gases can be employed for the purpose described above, including but not limited to, longer-chained molecules such as disilane, trisilane and the like, and chlorinated species such as chlorosilane, dichlorosilane, trichlorsilane and the like, and combinations thereof.

The reactor in which the CVD process is carried out is according to various designs as known in the art, for example in a fluid bed reactor, a static bed reactor, an elevator kiln, a rotary kiln, a box kiln, or other suitable reactor type. The reactor materials are suitable for this task, as known in the art. In a preferred embodiment, the porous carbon particles are process under condition that provide uniform access to the gas phase, for example a reactor wherein the porous carbon particles are fluidized, or otherwise agitated to provide said uniform gas access.

In some embodiments, the CVD process is a plasma-enhanced chemical vapor deposition (PECVD) process. This process is known in the art to provide utility for depositing thin films from a gas state (vapor) to a solid state on a substrate. Chemical reactions are involved in the process, which occur after creation of plasma comprising the reacting gases. The plasma is generally created by RF (AC) frequency or DC discharge between two electrodes, the space between which is filled with the reacting gases. In certain embodiments, the PECVD process is utilized for porous carbon that is coated on a substrate suitable for the purpose, for example a copper foil substrate. The PECVD can be carried out at various temperatures, for example between 300 and 800 C, for example between 300 and 600 C, for example between 300 and 500 C, for example between 300 and 400 C, for example at 350 C. The power can be varied, for example 25W RF, and the silicon-containing (for example, silane) gas flow required for processing car be varied, and the processing time can be varied as known in the art.

In addition to silicon, other candidate atoms for surface-doping of the carbon include, but are not limited to, zinc, lead, sulfur, nickel, sodium, calcium, or combination thereof, with said doping accomplished by various methods known in the art and as described elsewhere in this disclosure. Other incorporation methods, including melt diffusion (especially in the context of elemental deposition of sulfur, lead, or phosphorus) are also envisioned.

For the various embodiments above where the carbon is modified by introducing a non-carbonaceous moiety(ies), said non-carbonaceous moiety(ies) can be located at various sites within the carbon. For example, the non-carbonaceous moiety(ies) can be located on the carbon outer surface, in the carbon bulk (for example as embedded particles or molecularly incorporated), on the surface of or inside micropores, on the surface of or inside mesopores, and on the surface of or inside macropores. Without being bound by theory, quantitative descriptions of the absolute content and distribution of the non-carbonaceous moiety(ies) are envisioned. In one embodiment, the carbon contains between 0.1 and 1% of the non-carbonaceous moiety(ies) and at least 50% of the non-carbonaceous moiety(ies) are located on sum of all carbon surfaces (outer surface, and micropore, mesopore, and macropore surfaces. In another embodiment, the carbon contains between 1% and 10% of the non-carbonaceous moiety(ies) and at least 50% of the non-carbonaceous moiety(ies) are located on sum of all carbon surfaces (outer surface, and micropore, mesopore, and macropore surfaces. In yet another embodiment, the carbon contains between 0.1% and 10% of the non-carbonaceous moiety(ies) and at least 50% of the non-carbonaceous moiety(ies) are located on the surface of or inside mesopores. In yet another embodiment, the carbon contains between 10% and 30% of the non-carbonaceous moiety(ies) and at least 50% of the non-carbonaceous moiety(ies) are located on the surface of or inside mesopores.

In certain embodiments, the carbon surface is modified by creation of a carbide layer. Exemplary carbides in the context include, but are not limited to, silicon carbon, tungsten carbon, and aluminum carbide.

Alternatively, the carbon can be coated with non-conductive or low-conductive materials to reduce the propensity for gassing when employed as an additive in lead acid batteries and other related energy systems. Exemplary materials in this context include low or non-conductive polymers, and pyrolyzed or partially pyrolyzed versions thereof. Polymers in this context include, but are not limited to, phenolic resins, polysaccharides, and lignins.

C. Carbon Compositions to Achieve Low Gassing

In addition to, and potentially in combination with the approaches discussed above to achieve low gassing carbon materials, the gassing potential for the carbon can be further lowered by the composition around the carbon, that is the carbon formulation that is added into the NAM of a lead acid battery or other related energy storage system.

In some embodiments, the carbon formulation for addition to the NAM comprises a compound capable of hydrogen uptake, or otherwise converts molecular hydrogen into hydrogenation of organic compounds. Biological examples are known in the art, for example hydrogen uptake via hydrogenases, wherein the uptake of hydrogen is coupled to the reduction of electron acceptors such as oxygen, nitrate, sulfate, carbon dioxide, and fumarate. Both low-molecular weight compounds and proteins such as ferrodoxins and cytochromes can act as physiological electron donors or acceptors for hydrogenases. There are also biomimetic examples of hydrogenases, including designs incorporated metal organic frameworks.

In other embodiments, the carbon formulation for addition to the NAM comprises a compound capable of oxygen uptake, or otherwise converts molecular oxygen. Examples of such anti-oxidants include, but are not limited to, ascorbic acid, uric acid, lipocic acid, glutathione, carotenes, ubiquinol, and a-tocopherol. There are also examples that are comprised of enzymes for the same purpose; examples include superoxide dismutase, catalase and peroxiredoxins.

In certain embodiments, blends of various types of carbons may be employed to achieve a low-gassing carbon particle blend. In this context, a plurality of different types of carbons can be blends, and the blend further blended into other components of the NAM. Carbon blends in the context comprise various types of carbon particles. The types of carbons in the blend include activated carbons, pyrolyzed carbons, carbon blacks, amorphous carbon, glassy carbon, graphite, and graphene. In some embodiments, the carbon blend is comprised a pyrolyzed carbon with a specific surface area greater than 500 m2/g and an activated carbon with a specific surface area greater than 1500 m2/g. In this context, the ratio of pyrolyzed to activated carbon can be varied, for example the ratio can between 1:100 and 100:1, for example the ratio can be between 1:100 and 1:50, for example between 1:50 and 1:10, for example between 1:10 and 1:5, for example between 1:5 and 1:2, for example between 1:2 and 2:1, for example between 2:1 and 5:1, for example between 5:1 and 10:1, for example between 10:1 and 50:1, for example between 50:1 and 100:1.

In another embodiment, the carbon blend is comprised of a carbon black and a pyrolyzed carbon with a specific surface area greater than 500 m2/g. In this context, the ratio of carbon black to pyrolyzed carbon can be varied, for example the ratio can between 1:100 and 100:1, for example the ratio can be between 1:100 and 1:50, for example between 1:50 and 1:10, for example between 1:10 and 1:5, for example between 1:5 and 1:2, for example between 1:2 and 2:1, for example between 2:1 and 5:1, for example between 5:1 and 10:1, for example between 10:1 and 50:1, for example between 50:1 and 100:1.

In another embodiment, the carbon blend is comprised of a carbon black and an activated carbon with a specific surface area greater than 1500 m2/g. In this context, the ratio of carbon black to activated carbon can be varied, for example the ratio can between 1:100 and 100:1, for example the ratio can be between 1:100 and 1:50, for example between 1:50 and 1:10, for example between 1:10 and 1:5, for example between 1:5 and 1:2, for example between 1:2 and 2:1, for example between 2:1 and 5:1, for example between 5:1 and 10:1, for example between 10:1 and 50:1, for example between 50:1 and 100:1.

In other embodiments, the carbon blend is comprised of a microporous carbon and a mesoporous carbon. In this context, the microporous carbon can have greater than 80% micropores, and the mesoporous carbon can have greater than 70% mesopores. Further in this context, the ratio of microporous carbon to mesoporous carbon can be varied, for example the ratio can between 1:100 and 100:1, for example the ratio can be between 1:100 and 1:50, for example between 1:50 and 1:10, for example between 1:10 and 1:5, for example between 1:5 and 1:2, for example between 1:2 and 2:1, for example between 2:1 and 5:1, for example between 5:1 and 10:1, for example between 10:1 and 50:1, for example between 50:1 and 100:1.

Regarding the blends described above of microporous and mesoporous carbons, and blends of pyrolyzed and activated carbons, it is further envisioned that such blends can be further blended with carbon blacks of other types of carbons, also as described above.

D. Various Properties of Low-Gassing Carbon Materials

Various properties of the low-gassing carbon particles can be varied to obtain the desired electrochemical result. As discussed above, electrodes comprising low-gassing carbon materials comprising metals and/or metal compounds and having residual levels of various impurities (e.g., sodium, chlorine, nickel, iron, etc.) are known to have decreased cycle life, durability and performance. Accordingly, one embodiment provides blends comprising a plurality of low-gassing carbon particles which are significantly more pure than other known carbon materials and are thus expected to improve the operation of any number of electrical energy storage and/or distribution devices.

The high purity of the disclosed carbon particles in certain embodiments can be attributed to the disclosed sol gel processes. Applicants have discovered that when one or more polymer precursors, for example a phenolic compound and an aldehyde, are co-polymerized under acidic conditions in the presence of a volatile basic catalyst, an ultrapure polymer gel results. This is in contrast to other reported methods for the preparation of polymer gels which result in polymer gels comprising residual levels of undesired impurities. The ultrapure polymer gels can be pyrolyzed by heating in an inert atmosphere (e.g., nitrogen) to yield the carbon particles comprising a high surface area and high pore volume. These carbon materials can be further activated without the use of chemical activation techniques—which introduce impurities—to obtain ultrapure activated carbon materials. The carbon particles are prepared from activated carbon materials or, in some instances, pyrolyzed but not activated carbon materials.

In certain embodiments, the low-gassing carbon particles comprise lead within the pores or on the surface of the low-gassing carbon particles. Thus the blends may comprise a plurality of low-gassing carbon particles, which comprise lead, and a plurality of lead particles. Lead can be incorporated into the low-gassing carbon materials at various stages of the sol gel process. For example, leads and/or lead compounds can be incorporated during the polymerization stage, into the polymer gel or into the pyrolyzed or activated low-gassing carbon particles. The unique porosity and high surface area of the low-gassing carbon particles provides for optimum contact of the electrode active material with the electrolyte in, for example, a lead/acid battery. Electrodes prepared from the disclosed blends comprise improved active life and power performance relative to electrodes prepared from known low-gassing carbon materials.

In some embodiments, the low-gassing carbon particles are a pyrolyzed dried polymer gel, for example, a pyrolyzed polymer cryogel, a pyrolyzed polymer xerogel or a pyrolyzed polymer aerogel. In other embodiments, the low-gassing carbon particles are activated (i.e., a synthetic activated low-gassing carbon material). For example, in further embodiments the low-gassing carbon particles are an activated dried polymer gel, an activated polymer cryogel, an activated polymer xerogel or an activated polymer aerogel.

The low-gassing carbon particles can be varying purity. For example, in some embodiments, the low-gassing carbon particles can be ultrapure activated low-gassing carbon, wherein the low-gassing carbon particles comprises less than 1000 PPM, for example less than 500 PPM for example less than 200 ppm, for example less than 100 ppm, for example less than 50 ppm, or even less than 10 PPM of impurities. In other examples, the low-gassing carbon has levels of impurities ranging from 0.1 to 1000 ppm. In other embodiments, the low-gassing carbon particles have impurities levels ranging from 900 to 1000 ppm. In other embodiments, the low-gassing carbon particles have impurities levels ranging from 800 to 900 ppm. In other embodiments, the low-gassing carbon particles have impurities levels ranging from 700 to 800 ppm. In other embodiments, the low-gassing carbon particles have impurities levels ranging from 600 to 700 ppm. In other embodiments, the low-gassing carbon particles have impurities levels ranging from 500 to 600 ppm. In other embodiments, the low-gassing carbon particles have impurities levels ranging from 400 to 500 ppm. In other embodiments, the low-gassing carbon particles have impurities levels ranging from 300 to 400 ppm. In other embodiments, the low-gassing carbon particles have impurities levels ranging from 200 to 300 ppm. In other embodiments, the low-gassing carbon particles have impurities levels ranging from 100 to 200 ppm. In other embodiments, the low-gassing carbon particles have impurities levels ranging from 0.1 to 100 ppm. In other embodiments, the low-gassing carbon particles have impurities levels ranging from 0.1 to 50 ppm. In other embodiments, the low-gassing carbon particles have impurities levels ranging from 0.1 to 10 ppm.

The low-gassing carbon particles may also be “non-ultrapure” (i.e., greater than 100 PPM of impurities. For example, in some embodiments, the level of total impurities in the non-ultrapure activated low-gassing carbon (as measured by proton induced x-ray emission) is in the range of about 1000 ppm or greater, for example 2000 ppm. The ash content of the non-ultrapure low-gassing carbon is in the range of about 0.1% or greater, for example 0.41%. In addition, the non-ultrapure low-gassing carbon materials can be incorporated into devices suitable for energy storage and distribution, for example in lead acid batteries.

The low-gassing carbon particles may also comprise lead in addition to being physically blended with lead particles. This results in a blend of lead containing low-gassing carbon particles and lead particles. Such blends find particular utility in the hybrid devices described herein. In this regard, the low-gassing carbon particles may be of any purity level, and the lead may be incorporated into the pores of the low-gassing carbon particles and/or on the surface of the low-gassing carbon particles. Accordingly, in some embodiments the low-gassing carbon composition comprises a plurality of low-gassing carbon particles and a plurality of lead particles, wherein the low-gassing carbon particles comprise lead, for example at least 1000 PPM of lead. In certain other embodiments of the foregoing, the low-gassing carbon particles comprise lead and less than 500 PPM of all other impurities. In some other embodiments, the low-gassing carbon particles comprise at least 0.10%, at least 0.25%, at least 0.50%, at least 1.0%, at least 5.0%, at least 10%, at least 25%, at least 50%, at least 75%, at least 90%, at least 95%, at least 99% or at least 99.5% of lead. For example, in some embodiments, the low-gassing carbon particles comprise between 0.5% and 99.5% activated low-gassing carbon and between 0.5% and 99.5% lead. The percent of lead is calculated on weight percent basis (wt %).

The lead in any of the embodiments disclosed herein can be in any number of forms. For example, in some embodiments, the lead is in the form of elemental lead, lead (II) oxide, lead (IV) oxide or combinations thereof. In other embodiments, the lead is in the form of lead acetate, lead carbonate, lead sulfate, lead orthoarsenate, lead pyroarsenate, lead bromide, lead caprate, lead carproate, lead caprylate, lead chlorate, lead chloride, lead fluoride, lead nitrate, lead oxychloride, lead orthophosphate sulfate, lead chromate, lead chromate, basic, lead ferrite, lead sulfide, lead tungstate or combinations thereof. Other lead salts are also contemplated.

In some embodiments, the low-gassing carbon particles comprise at least 1,000 ppm of lead. In other embodiments, the low-gassing carbon material comprises a total of less than 500 ppm of elements (excluding any intentionally added lead) having atomic numbers ranging from 11 to 92, for example, less than 200 ppm, less than 100 ppm, less than 50 ppm, less than 25 ppm, less than 10 ppm, less than 5 ppm or less than 1 ppm. In certain embodiments the lead content and/or the impurity content is measured by proton induced x-ray emission analysis (PIXE). In other embodiments, the purity determination is accomplished by total X-ray fluorescence (tXRF).

Certain metal elements such as iron, cobalt, nickel, chromium, copper, titanium, vanadium and rhenium may decrease the electrical performance of electrodes comprising the blends. Accordingly, in some embodiments, the low-gassing carbon particles comprise low levels of one or more of these elements. For example, in certain embodiments, the low-gassing carbon particles comprise less than 100 ppm iron, less than 50 ppm iron, less than 25 ppm iron, less than 10 ppm iron, less than 5 ppm iron or less than 1 ppm iron. In other embodiments, the low-gassing carbon particles comprise less than 100 ppm cobalt, less than 50 ppm cobalt, less than 25 ppm cobalt, less than 10 ppm cobalt, less than 5 ppm cobalt or less than 1 ppm cobalt. In other embodiments, the low-gassing carbon particles comprise less than 100 ppm nickel, less than 50 ppm nickel, less than 25 ppm nickel, less than 10 ppm nickel, less than 5 ppm nickel or less than 1 ppm nickel. In other embodiments, the low-gassing carbon particles comprise less than 100 ppm chromium, less than 50 ppm chromium, less than 25 ppm chromium, less than 10 ppm chromium, less than 5 ppm chromium or less than 1 ppm chromium. In other embodiments, the low-gassing carbon particles comprise less than 100 ppm copper, less than 50 ppm copper, less than 25 ppm copper, less than 10 ppm copper, less than 5 ppm copper or less than 1 ppm copper. In other embodiments, the low-gassing carbon particles comprise less than 100 ppm titanium, less than 50 ppm titanium, less than 25 ppm titanium, less than 10 ppm titanium, less than 5 ppm titanium or less than 1 ppm titanium. In other embodiments, the low-gassing carbon particles comprise less than 100 ppm vanadium, less than 50 ppm vanadium, less than 25 ppm vanadium, less than 10 ppm vanadium, less than 5 ppm vanadium or less than 1 ppm vanadium. In other embodiments, the low-gassing carbon particles comprise less than 100 ppm rhenium, less than 50 ppm rhenium, less than 25 ppm rhenium, less than 10 ppm rhenium, less than 5 ppm rhenium or less than 1 ppm rhenium.

In other embodiments, the low-gassing carbon particles comprise less than 5 ppm chromium, less than 10 ppm iron, less than 5 ppm nickel, less than 20 ppm silicon, less than 5 ppm zinc, and bismuth, silver, copper, mercury, manganese, platinum, antimony and tin are not detected as measured by proton induced x-ray emission.

In other embodiments, the carbon particles comprise less than 75 ppm bismuth, less than 5 ppm silver, less than 10 ppm chromium, less than 30 ppm copper, less than 30 ppm iron, less than 5 ppm mercury, less than 5 ppm manganese, less than 20 ppm nickel, less than 5 ppm platinum, less than 10 ppm antimony, less than 100 ppm silicon, less than 10 ppm tin and less than 10 ppm zinc as measured by proton induced x-ray emission.

In other embodiments, the carbon particles comprise less than 5 ppm chromium, 10 ppm iron, less than 5 ppm nickel, less than 20 ppm silicon, less than 5 ppm zinc and bismuth, silver, copper, mercury, manganese, platinum, antimony and tin are not detected as measured by proton induced x-ray emission as measured by proton induced x-ray emission.

The porosity of the carbon particles is an important parameter for electrochemical performance of the blends. Accordingly, in one embodiment the carbon particles comprise a DFT pore volume of at least 0.35 cc/g, at least 0.30 cc/g, at least 0.25 cc/g, at least 0.20 cc/g, at least 0.15 cc/g, at least 0.10 cc/g, at least 0.05 cc/g or at least 0.01 cc/g for pores less than 20 angstroms. In other embodiments the carbon particles are devoid of any measurable pore volume. In other embodiments, the carbon particles comprise a DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g or at least 0.65 cc/g for pores greater than 20 angstroms.

In other embodiments, the carbon particles comprise a DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g, at least 0.20 cc/g, at least 0.15 cc/g, or at least 0.10 cc/g for pores ranging from 20 angstroms to 500 angstroms.

In other embodiments, the carbon particles comprise a DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g, at least 0.20 cc/g, at least 0.15 cc/g, or at least 0.10 cc/g for pores ranging from 20 angstroms to 1000 angstroms.

In other embodiments, the carbon particle comprises a DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g, at least 0.20 cc/g, at least 0.15 cc/g, or at least 0.10 cc/g for pores ranging from 20 angstroms to 2000 angstroms.

In other embodiments, the carbon particles comprises a DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g, at least 0.20 cc/g, at least 0.15 cc/g, or at least 0.10 cc/g for pores ranging from 20 angstroms to 5000 angstroms.

In yet other embodiments, the carbon particles comprise a total DFT pore volume of at least 4.00 cc/g, at least 3.75 cc/g, at least 3.50 cc/g, at least 3.25 cc/g, at least 3.00 cc/g, at least 2.75 cc/g, at least 2.50 cc/g, at least 2.25 cc/g, at least 2.00 cc/g, at least 1.90 cc/g, 1.80 cc/g, 1.70 cc/g, 1.60 cc/g, 1.50 cc/g, 1.40 cc/g, at least 1.30 cc/g, at least 1.20 cc/g, at least 1.10 cc/g, at least 1.00 cc/g, at least 0.85 cc/g, at least 0.80 cc/g, at least 0.75 cc/g, at least 0.70 cc/g, at least 0.65 cc/g, at least 0.60 cc/g, at least 0.55 cc/g, at least 0.50 cc/g, at least 0.45 cc/g, at least 0.40 cc/g, at least 0.35 cc/g, at least 0.30 cc/g, at least 0.25 cc/g, at least 0.20 cc/g, at least 0.15 cc/g, or at least 0.10 cc/g.

In certain embodiments mesoporous carbon particles having very little microporosity (e.g., less than 30%, less than 20%, less than 10% or less than 5% microporosity) are provided. The pore volume and surface area of such carbon particles are advantageous for inclusion of lead and electrolyte ions in certain embodiments. For example, the mesoporous carbon can be a polymer gel that has been pyrolyzed, but not activated. In some embodiments, the mesoporous carbon comprises a specific surface area of at least 100 m²/g, at least 200 m²/g, at least 300 m²/g, at least 400 m²/g, at least 500 m²/g, at least 600 m²/g, at least 675 m²/g or at least 750 m²/g. In other embodiments, the mesoporous carbon particles comprise a total pore volume of at least 0.50 cc/g, at least 0.60 cc/g, at least 0.70 cc/g, at least 0.80 cc/g, at least 0.90 cc/g, at least 1.0 cc/g or at least 1.1 cc/g. In yet other embodiments, the mesoporous carbon particles comprise a tap density of at least 0.30 g/cc, at least 0.35 g/cc, at least 0.40 g/cc, at least 0.45 g/cc, at least 0.50 g/cc or at least 0.55 g/cc.

In addition to low content of undesired PIXE impurities, the disclosed carbon particles may comprise high total carbon content. In addition to carbon, the carbon particles may also comprise oxygen, hydrogen, nitrogen and the electrochemical modifier. In some embodiments, the particles comprises at least 75% carbon, 80% carbon, 85% carbon, at least 90% carbon, at least 95% carbon, at least 96% carbon, at least 97% carbon, at least 98% carbon or at least 99% carbon on a weight/weight basis. In some other embodiments, the carbon particles comprises less than 10% oxygen, less than 5% oxygen, less than 3.0% oxygen, less than 2.5% oxygen, less than 1% oxygen or less than 0.5% oxygen on a weight/weight basis. In other embodiments, the carbon particles comprises less than 10% hydrogen, less than 5% hydrogen, less than 2.5% hydrogen, less than 1% hydrogen, less than 0.5% hydrogen or less than 0.1% hydrogen on a weight/weight basis. In other embodiments, the carbon particles comprises less than 5% nitrogen, less than 2.5% nitrogen, less than 1% nitrogen, less than 0.5% nitrogen, less than 0.25% nitrogen or less than 0.01% nitrogen on a weight/weight basis. The oxygen, hydrogen and nitrogen content of the disclosed carbon particles can be determined by combustion analysis. Techniques for determining elemental composition by combustion analysis are well known in the art.

In some embodiments, the nitrogen content of the low-gassing carbon materials is between 5% and 50% nitrogen. For example, the nitrogen content of the low-gassing carbon is between 5% and 10%, for example between 10% and 20%, for example between 20% and 30%. In other embodiments, the nitrogen content of the low-gassing carbon is between 5% and 15%, for example between 15% and 25%, for example between 25% and 35%. In a preferred embodiment, the nitrogen content of the low-gassing carbon is 15-20%.

The total ash content of the carbon particles may, in some instances, have an effect on the electrochemical performance of the blends. Accordingly, in some embodiments, the ash content (excluding any intentionally added lead) of the carbon particles ranges from 0.1% to 0.001% weight percent ash, for example in some specific embodiments the ash content of the carbon particles is less than 0.1%, less than 0.08%, less than 0.05%, less than 0.03%, than 0.025%, less than 0.01%, less than 0.0075%, less than 0.005% or less than 0.001%.

In other embodiments, the carbon particles comprises a total impurity content of elements (excluding any intentionally added lead) of less than 500 ppm and an ash content (excluding any intentionally added lead) of less than 0.08%. In further embodiments, the carbon particles comprises a total impurity content of all other elements of less than 300 ppm and an ash content of less than 0.05%. In other further embodiments, the carbon particles comprises a total PIXE impurity content of all other elements of less than 200 ppm and an ash content of less than 0.05%. In other further embodiments, the carbon particles comprises a total impurity content of all other elements of less than 200 ppm and an ash content of less than 0.025%. In other further embodiments, the carbon particles comprises a total impurity content of all other elements of less than 100 ppm and an ash content of less than 0.02%. In other further embodiments, the carbon particles comprises a total impurity content of all other elements of less than 50 ppm and an ash content of less than 0.01%.

The disclosed carbon particles also comprise a high surface area. While not wishing to be bound by theory, it is thought that such high surface area may contribute, at least in part, to the superior electrochemical performance of the blends. Accordingly, in some embodiments, the carbon particles comprise a BET specific surface area of at least 100 m²/g, at least 200 m²/g, at least 300 m²/g, at least 400 m²/g, at least 500 m²/g, at least 600 m²/g, at least 700 m²/g, at least 800 m²/g, at least 900 m²/g, at least 1000 m²/g, at least 1500 m²/g, at least 2000 m²/g, at least 2400 m²/g, at least 2500 m²/g, at least 2750 m²/g or at least 3000 m²/g. For example, in some embodiments of the foregoing, the carbon particles are activated.

In another embodiment, the carbon particles comprise a tap density between 0.1 and 1.0 g/cc, between 0.2 and 0.8 g/cc, between 0.3 and 0.5 g/cc or between 0.4 and 0.5 g/cc. In another embodiment, the carbon particles has a total pore volume of at least 0.1 cm³/g, at least 0.2 cm³/g, at least 0.3 cm³/g, at least 0.4 cm3/g, at least 0.5 cm³/g, at least 0.7 cm³/g, at least 0.75 cm³/g, at least 0.9 cm³/g, at least 1.0 cm³/g, at least 1.1 cm³/g, at least 1.2 cm³/g, at least 1.3 cm³/g, at least 1.4 cm³/g, at least 1.5 cm³/g or at least 1.6 cm³/g.

The pore size distribution of the disclosed carbon particles is one parameter that may have an effect on the electrochemical performance of the blends. Accordingly, in one embodiment, the carbon particles comprise a fractional pore volume of pores at or below 100 nm that comprises at least 50% of the total pore volume, at least 75% of the total pore volume, at least 90% of the total pore volume or at least 99% of the total pore volume. In other embodiments, the carbon particle comprises a fractional pore volume of pores at or below 20 nm that comprises at least 50% of the total pore volume, at least 75% of the total pore volume, at least 90% of the total pore volume or at least 99% of the total pore volume.

In another embodiment, the carbon particles comprise a fractional pore surface area of pores at or below 100 nm that comprises at least 50% of the total pore surface area, at least 75% of the total pore surface area, at least 90% of the total pore surface area or at least 99% of the total pore surface area. In another embodiment, the carbon particles comprise a fractional pore surface area of pores at or below 20 nm that comprises at least 50% of the total pore surface area, at least 75% of the total pore surface area, at least 90% of the total pore surface area or at least 99% of the total pore surface area.

In another embodiment, the carbon particles comprise pores predominantly in the range of 1000 angstroms or lower, for example 100 angstroms or lower, for example 50 angstroms or lower. Alternatively, the carbon particles comprise micropores in the range of 0-20 angstroms and mesopores in the range of 20-1000 angstroms. The ratio of pore volume or pore surface in the micropore range compared to the mesopore range can be in the range of 95:5 to 5:95.

In other embodiments, the carbon particles are mesoporous and comprise monodisperse mesopores. As used herein, the term “monodisperse” when used in reference to a pore size refers generally to a span (further defined as (Dv90−Dv10)/Dv, 50 where Dv10, Dv50 and Dv90 refer to the pore size at 10%, 50% and 90% of the distribution by volume of about 3 or less, typically about 2 or less, often about 1.5 or less.

Yet in other embodiments, the carbons particles comprise a total pore volume of at least 0.2 cc/g. at least 0.5 cc/g, at least 0.75 cc/g, at least 1 cc/g, at least 2 cc/g, at least 3 cc/g, at least 4 cc/g or at least 7 cc/g. In one particular embodiment, the carbon particles comprise a pore volume of from 0.5 cc/g to 1.0 cc/g.

In other embodiments, the carbon particles comprise at least 50% of the total pore volume residing in pores with a diameter ranging from 50 Å to 5000 Å. In some instances, the carbon particles comprise at least 50% of the total pore volume residing in pores with a diameter ranging from 50 Å to 500 Å. Still in other instances, the carbon particles comprise at least 50% of the total pore volume residing in pores with a diameter ranging from 500 Å to 1000 Å. Yet in other instances, the carbon particles comprise at least 50% of the total pore volume residing in pores with a diameter ranging from 1000 Å to 5000 Å.

In some embodiments, the mean particle diameter for the carbon particles ranges from 1 to 1000 microns. In other embodiments the mean particle diameter for the carbon particles ranges from 1 to 100 microns. Still in other embodiments the mean particle diameter for the carbon particles ranges from 5 to 50 microns. Yet in other embodiments, the mean particle diameter for the carbon particles ranges from 5 to 15 microns or from 3 to 5 microns. Still in other embodiments, the mean particle diameter for the carbon particles is about 10 microns.

In some embodiments, the carbon particles comprise pores having a peak pore volume ranging from 2 nm to 10 nm. In other embodiments, the peak pore volume ranges from 10 nm to 20 nm. Yet in other embodiments, the peak pore volume ranges from 20 nm to 30 nm. Still in other embodiments, the peak pore volume ranges from 30 nm to 40 nm. Yet still in other embodiments, the peak pore volume ranges from 40 nm to 50 nm. In other embodiments, the peak pore volume ranges from 50 nm to 100 nm.

While not wishing to be bound by theory, a carbon particle comprising small pore sizes (i.e., pore lengths) may have the advantage of decreased diffusion distances to facilitate impregnation of lead or a lead salt. For example, it is believed that the employment of carbon particles with a substantial fraction of pores in the mesopore range (as discussed above) will provide a significant advantage compared to carbon particles which comprise much larger pore sizes, for example micron or millimeter size pores.

In certain embodiments, the water absorbing properties (i.e., total amount of water the carbon particles can absorb) of the carbon particles are predictive of the carbon's electrochemical performance when incorporated into a carbon-lead blend. The water can be absorbed into the pore volume in the carbon particles and/or within the space between the individual carbon particles. The more water absorption, the greater the surface area is exposed to water molecules, thus increasing the available lead-sulfate nucleation sites at the liquid-solid interface. The water accessible pores also allow for the transport of electrolyte into the center of the lead pasted plate for additional material utilization. Accordingly, in some embodiments the carbon particles are activated carbon particles and have a water absorption of greater than 0.2 g H₂O/cc (cc=pore volume in the carbon particle), greater than 0.4 g H₂O/cc, greater than 0.6 g H₂O/cc, greater than 0.8 g H₂O/cc, greater than 1.0 g H₂O/cc, greater than 1.25 g H₂O/cc, greater than 1.5 g H₂O/cc, greater than 1.75 g H₂O/cc, greater than 2.0 g H₂O/cc, greater than 2.25 g H₂O/cc, greater than 2.5 g H₂O/cc or even greater than 2.75 g H₂O/cc. In other embodiments the particles are unactivated particles and have a water absorption of greater than 0.2 g H₂O/cc, greater than 0.4 g H₂O/cc, greater than 0.6 g H₂O/cc, greater than 0.8 g H₂O/cc, greater than 1.0 g H₂O/cc, greater than 1.25 g H₂O/cc, greater than 1.5 g H₂O/cc, greater than 1.75 g H₂O/cc, greater than 2.0 g H₂O/cc, greater than 2.25 g H₂O/cc, greater than 2.5 g H₂O/cc or even greater than 2.75 g H₂O/cc. Methods for determining water absorption of exemplary carbon particles are known in the art and described in Example 26.

The water absorption of the carbon particles can also be measured in terms of an R factor, wherein R is the maximum grams of water absorbed per gram of carbon. In some embodiments, the R factor is greater than 2.0, greater than 1.8, greater than 1.6, greater than 1.4, greater than 1.2, greater than 1.0, greater than 0.8, or greater than 0.6. In other embodiments, the R value ranges from 1.2 to 1.6, and in still other embodiments the R value is less than 1.2.

The R factor of a carbon particle can also be determined based upon the carbon particles' ability to absorb water when exposed to a humid environment for extended periods of time (e.g., 2 weeks). For example, in some embodiments the R factor is expressed in terms of relative humidity. In this regard, the carbon particles comprise an R factor ranging from about 0.1 to about 1.0 at relative humidities ranging from 10% to 100%. In some embodiments, the R factor is less than 0.1, less than 0.2, less than 0.3, less than 0.4, less than 0.5, less than 0.6, less than 0.7 or even less than 0.8 at relative humidities ranging from 10% to 100%. In embodiments of the foregoing, the carbon particles comprise a total pore volume between about 0.1 cc/g and 2.0 cc/g, between about 0.2 cc/g and 1.8 cc/g, between about 0.4 cc/g and 1.4 cc/g, between about 0.6 cc/g and 1.2 cc/g. In other embodiments of the foregoing, the relative humidity ranges from about 10% to about 20%, from about 20% to about 30%, from about 30% to about 40%, from about 40% to about 50%, from about 50% to about 60%, from about 60%, to about 70%, from about 70% to about 80%, from about 80% to about 90% or from about 90% to about 99% or even 100%. The above R factors may be determined by exposing the carbon particles to the specified humidities at room temperature for two weeks.

In another embodiment of the present disclosure, the carbon particles are prepared by a method disclosed herein, for example, in some embodiments the carbon particles are prepared by a method comprising pyrolyzing a dried polymer gel as disclosed herein. In some embodiments, the pyrolyzed polymer gel is further activated to obtain an activated carbon material. In some embodiments, the activated carbon material is particle size reduced using approaches known in the art, for example, jet milling or ball milling. Carbon particles comprising lead can also be prepared by any number of methods described in more detail below.

E. Preparation of the Carbon Materials

Particles of carbon can be made by the polymer gel methods disclosed herein and in U.S. application Ser. No. 12/965,709 and U.S. Publication No. 2001/002086, both of which are hereby incorporated by reference in their entireties. Particles of lead can be made by methods known in the art, for example milling, grinding and the like. Blending of the two different particles can be accomplished also by methods known. In the case of blending multiple populations of carbon particles with lead particles, blending can be done preferentially or in bulk. For example, two particle populations can be initially blended and a third can be added to this mixture. In one embodiment, this first mixture exhibits bimodal carbon particle size. In a further embodiment, the first mixture represents a bimodal distribution of carbon particles and lead particles. In a further embodiment, the first mixture represents a mixture of carbon particles and lead particles of similar size. Details for preparation of the carbon particles are described below.

The polymer gels may be prepared by a sol gel process. For example, the polymer gel may be prepared by co-polymerizing one or more polymer precursors in an appropriate solvent. In one embodiment, the one or more polymer precursors are co-polymerized under acidic conditions. In some embodiments, a first polymer precursor is a phenolic compound and a second polymer precursor is an aldehyde compound. In one embodiment, of the method the phenolic compound is phenol, resorcinol, catechol, hydroquinone, phloroglucinol, or a combination thereof; and the aldehyde compound is formaldehyde, acetaldehyde, propionaldehyde, butyraldehyde, benzaldehyde, cinnamaldehyde, or a combination thereof. In a further embodiment, the phenolic compound is resorcinol, phenol or a combination thereof, and the aldehyde compound is formaldehyde. In yet further embodiments, the phenolic compound is resorcinol and the aldehyde compound is formaldehyde.

A wide variety of other polymer precursors are also available and described in the art. Exemplary polymer precursor materials as disclosed herein include (a) alcohols, phenolic compounds, and other mono- or polyhydroxy compounds and (b) aldehydes, ketones, and combinations thereof. Representative alcohols in this context include straight chain and branched, saturated and unsaturated alcohols. Suitable phenolic compounds include polyhydroxy benzene, such as a dihydroxy or trihydroxy benzene. Representative polyhydroxy benzenes include resorcinol (i.e., 1,3-dihydroxy benzene), catechol, hydroquinone, and phloroglucinol. Mixtures of two or more polyhydroxy benzenes can also be used. Phenol (monohydroxy benzene) can also be used. Representative polyhydroxy compounds include sugars, such as glucose, and other polyols, such as mannitol. Aldehydes in this context include: straight chain saturated aldehydes such as methanal (formaldehyde), ethanal (acetaldehyde), propanal (propionaldehyde), butanal (butyraldehyde), and the like; straight chain unsaturated aldehydes such as ethenone and other ketenes, 2-propenal (acrylaldehyde), 2-butenal (crotonaldehyde), 3 butenal, and the like; branched saturated and unsaturated aldehydes; and aromatic-type aldehydes such as benzaldehyde, salicylaldehyde, hydrocinnamaldehyde, and the like. Suitable ketones include: straight chain saturated ketones such as propanone and 2 butanone, and the like; straight chain unsaturated ketones such as propenone, 2 butenone, and 3-butenone (methyl vinyl ketone) and the like; branched saturated and unsaturated ketones; and aromatic-type ketones such as methyl benzyl ketone (phenylacetone), ethyl benzyl ketone, and the like. Other precursors of interest include bisphenols (such as bisphenol A) and the like. The polymer precursor materials can also be combinations of the precursors described above.

In some embodiments, one polymer precursor is an alcohol-containing species and another polymer precursor is a carbonyl-containing species. The relative amounts of alcohol-containing species (e.g., alcohols, phenolic compounds and mono- or poly-hydroxy compounds or combinations thereof) reacted with the carbonyl containing species (e.g., aldehydes, ketones or combinations thereof) can vary substantially. In some embodiments, the ratio of alcohol-containing species to aldehyde species is selected so that the total moles of reactive alcohol groups in the alcohol-containing species is approximately the same as the total moles of reactive carbonyl groups in the aldehyde species. Similarly, the ratio of alcohol-containing species to ketone species may be selected so that the total moles of reactive alcohol groups in the alcohol containing species is approximately the same as the total moles of reactive carbonyl groups in the ketone species. The same general 1:1 molar ratio holds true when the carbonyl-containing species comprises a combination of an aldehyde species and a ketone species. In addition to aldehydes such as formaldehyde, another exemplary cross-linking agent is hexamethylenetetramine.

The sol gel polymerization process is generally performed under catalytic conditions. Accordingly, in some embodiments, preparing the polymer gel comprises co-polymerizing one or more polymer precursors in the presence of a catalyst. In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

The molar ratio of catalyst to phenolic compound may have an effect on the final properties of the polymer gel as well as the final properties of the carbon materials, for example. Thus, in some embodiments such catalysts are used in the range of molar ratios of 5:1 to 2000:1 phenolic compound:catalyst. In some embodiments, such catalysts can be used in the range of molar ratios of 20:1 to 200:1 phenolic compound:catalyst. For example in other embodiments, such catalysts can be used in the range of molar ratios of 5:1 to 100:1 phenolic compound:catalyst.

The reaction solvent is another process parameter that may be varied to obtain the desired properties (e.g., surface area, porosity, purity, etc.) of the polymer gels and carbon materials. In some embodiments, the solvent for preparation of the polymer gel is a mixed solvent system of water and a miscible co-solvent. For example, in certain embodiments the solvent comprises a water miscible acid. Examples of water miscible acids include, but are not limited to, propionic acid, acetic acid, and formic acid. In further embodiments, the solvent comprises a ratio of water-miscible acid to water of 99:1, 90:10, 75:25, 50:50, 25:75, 10:90 or 1:90. In other embodiments, acidity is provided by adding a solid acid to the reaction solvent.

In some other embodiments of the foregoing, the solvent for preparation of the polymer gel is acidic. For example, in certain embodiments the solvent comprises acetic acid. For example, in one embodiment, the solvent is 100% acetic acid. In other embodiments, a mixed solvent system is provided, wherein one of the solvents is acidic. For example, in one embodiment of the method the solvent is a binary solvent comprising acetic acid and water. In further embodiments, the solvent comprises a ratio of acetic acid to water of 99:1, 90:10, 75:25, 50:50, 25:75, 20:80, 10:90 or 1:90. In other embodiments, acidity is provided by adding a solid acid to the reaction solvent.

The polymer gel particles can be dried by various techniques known in the art, including rapid freezing followed by lyophilization as described in U.S. application Ser. No. 12/965,709 and U.S. Publication No. 2001/002086, both of which are hereby incorporated by reference in their entireties. Likewise, these same references provide descriptions of the pyrolysis and activated of dried (for example freeze dried) polymer gels.

F. Characterization of Carbon Materials

The properties of the low-gassing carbon material can be measured, for example, using Nitrogen sorption at 77K, a method known to those of skill in the art. The final performance and characteristics of the finished carbon material is important, but the intermediate products (both dried polymer gel and pyrolyzed, but not activated, polymer gel), can also be evaluated, particularly from a quality control standpoint, as known to those of skill in the art. The Micromeretics ASAP 2020 is used to perform detailed micropore and mesopore analysis, which reveals a pore size distribution from 0.35 nm to 50 nm in some embodiments. The system produces a nitrogen isotherm starting at a pressure of 10⁻⁷ atm, which enables high resolution pore size distributions in the sub 1 nm range. The software generated reports utilize a Density Functional Theory (DFT) method to calculate properties such as pore size distributions, surface area distributions, total surface area, total pore volume, and pore volume within certain pore size ranges.

The impurity and lead content of the low-gassing carbon particles can be determined by any number of analytical techniques known to those of skill in the art. One particular analytical method useful within the context of the present disclosure is proton induced x-ray emission (PIXE). This technique is capable of measuring the concentration of elements having atomic numbers ranging from 11 to 92 at low ppm levels. Accordingly, in one embodiment the concentration of lead, as well as all other elements, present in the carbon particles or blends is determined by PIXE analysis. Alternatively, the purity measurement can be accomplished by tXRF.

The disclosed low-gassing carbon particles can be used as electrode material in any number of electrical energy storage and distribution devices. One such device is a hybrid carbon/metal battery, for example a carbon/lead acid battery. The high purity, surface area and porosity of the blends impart improved electrical properties to electrodes prepared from the same. Accordingly, the present disclosure provides electrical energy storage devices having longer active life and improved power performance relative to devices containing other carbon materials. Specifically, because of the open-cell, porous network, and relatively small pore size of the low-gassing carbon particles, the chemically active material of the positive and negative electrodes of an electrical energy storage device can be intimately integrated with the current collectors. The reaction sites in the chemically active carbon can therefore be close to one or more conductive carbon structural elements. Thus, electrons produced in the chemically active material at a particular reaction site must travel only a short distance through the active material before encountering one of the many conductive structural elements of a particular current collector.

In addition, the porosity of the disclosed low-gassing carbon particles provides for a reservoir of electrolyte ions (e.g., sulfate ions) necessary for the charge and discharge in chemical reactions. The proximity of the electrolyte ions to the active material is much closer than in traditional electrodes, and as a result, devices (e.g., batteries) comprising electrodes incorporating the carbon material offer both improved specific power and specific energy values. In other words, these devices, when placed under a load, sustain their voltage above a predetermined threshold value for a longer time than devices comprising traditional current collectors made of lead, graphite plates, activated carbon without lead and the like.

The increased specific power values offered by the disclosed devices also may translate into reduced charging times. Therefore, the disclosed devices may be suitable for applications in which charging energy is available for only a limited amount of time. For instance, in vehicles, a great deal of energy is lost during ordinary braking. This braking energy may be recaptured and used to charge a battery of, for example, a hybrid vehicle. The braking energy, however, is available only for a short period of time (e.g., while braking is occurring). Thus, any transfer of braking energy to a battery must occur during braking. In view of their reduced charging times, the devices of the present invention may provide an efficient means for storing such braking energy.

The disclosed low-gassing carbon materials find utility in electrodes for use in lead acid batteries. Accordingly, one embodiment of the present disclosure is a hybrid lead-carbon-acid electrical energy storage device comprising at least one cell, wherein the at least one cell comprises a plurality of low-gassing carbon and lead-based positive electrodes and one or more low-gassing carbon and lead-based negative electrodes. The device further comprises separators between the cells, an acid electrolyte (e.g., aqueous sulfuric acid), and a casing to contain the device.

In some embodiments of the hybrid lead-low gassing carbon-acid energy storage device, each low-gassing carbon-based negative electrode comprises a highly conductive current collector; a low-gassing carbon-lead blend adhered to and in electrical contact with at least one surface of the current collector, and a tab element extending above the top edge of the negative or positive electrode. For example, each low-gassing carbon-lead-based positive electrode may comprise a lead-based current collector and a lead dioxide-based active material paste adhered to, and in electrical contact with, the surfaces thereof, and a tab element extending above the top edge of the positive electrode. The lead dioxide based active material comprises any of the disclosed blends. The lead or lead oxide in the blend serves as the energy storing active material for the cathode.

In other embodiments of the hybrid lead-low-gassing carbon-acid energy storage device, the front and back surfaces of a lead-based current collector each comprise a matrix of raised and lowered portions with respect to the mean plane of the lead-based current collector, and further comprises slots formed between the raised and lowered portions thereof. In this embodiment, the aggregate thickness of the lead-based current collector is greater than the thickness of the lead-based material forming the current collector.

A negative electrode may comprise a conductive current collector; a low-gassing carbon-lead blend; and a tab element extending from a side, for example from above a top edge, of the negative electrode. Negative electrode tab elements may be electrically secured to one another by a cast-on strap, which may comprise a connector structure. The active material may be in the form of a sheet that is adhered to, and in electrical contact, with the current collector matrix. In order for the particles to be adhered to and in electrical contact with the current collector matrix, the particles may be mixed with a suitable binder substance such as PTFE or ultra-high molecular weight polyethylene (e.g., having a molecular weight numbering in the millions, usually between about 2 and about 6 million). In some embodiments, the binder material does not exhibit thermoplastic properties or exhibits minimal thermoplastic properties.

In certain embodiments, each battery cell comprises four positive electrodes that are lead-based and comprise lead dioxide active material. Each positive electrode comprises a highly conductive current collector comprising porous carbon material (e.g., a carbon-lead blend) adhered to each face thereof and lead dioxide contained within the carbon. Also, in this embodiment, the battery cell comprises three negative electrodes, each of which comprises a highly conductive current collector comprising porous carbon material adhered to each face thereof where this low-gassing carbon material comprises lead within the carbon.

In other embodiments, each cell comprises a plurality of positive electrodes and a plurality of negative electrodes that are placed in alternating order. Between each adjacent pair of positive electrodes and the negative electrodes, there is placed a separator. Each of the positive electrodes is constructed so as to have a tab extending above the top edge of each respective electrode; and each of the negative electrodes has a tab extending above the top edge of each of the respective negative electrodes. In certain variations, the separators are made from a suitable separator material that is intended for use with an acid electrolyte, and that the separators may be made from a woven material such as a non-woven or felted material, or a combination thereof. In other embodiments, the material of the current collector is sheet lead, which may be cast or rolled and punched or machined.

Each cell may comprise alternating positive and negative plates, and an electrolyte may be disposed in a volume between the positive and negative plates. Additionally, the electrolyte can occupy some or all of the pore space in the materials included in the positive and negative plates. In one embodiment, the electrolyte includes an aqueous electrolytic solution within which the positive and negative plates may be immersed. The electrolytic solution composition may be chosen to correspond with a particular battery chemistry. In lead acid batteries, for example, the electrolyte may include a solution of sulfuric acid and distilled water. Other acids, however, may be used to form the electrolytic solutions of the disclosed batteries.

In another embodiment, the electrolyte may include a silica gel. This silica gel electrolyte can be added to the battery such that the gel at least partially fills a volume between the positive and negative plate or plates of cell.

In some other variations, the positive and negative plates of each cell may include a current collector packed or coated with a chemically active material. Chemical reactions in the active material disposed on the current collectors of the battery enable storage and release of electrical energy. The composition of this active material, and not the current collector material, determines whether a particular current collector functions either as a positive or a negative plate.

The composition of the chemically active material also depends on the chemistry of the device. For example, lead acid batteries may include a chemically active material comprising, for example, an oxide or salt of lead. In certain embodiments, the chemically active material may comprise lead dioxide (PbO₂). The chemically active material may also comprise various additives including, for example, varying percentages of free lead, structural fibers, conductive materials, carbon, and extenders to accommodate volume changes over the life of the battery. In certain embodiments, the constituents of the chemically active material for lead acid batteries may be mixed with sulfuric acid and water to form a paste, slurry, or any other type of coating material.

The chemically active material in the form of a paste or a slurry, for example, may be applied to the current collectors of the positive and negative plates. The chemically active material may be applied to the current collectors by dipping, to painting, or via any other suitable coating technique.

In certain embodiments, the positive and negative plates of a battery are formed by first depositing the chemically active material on the corresponding current collectors to make the plates. While not necessary in all applications, in certain embodiments, the chemically active material deposited on current collectors may be subjected to curing and/or drying processes. For example, a curing process may include exposing the chemically active materials to elevated temperature and/or humidity to encourage a change in the chemical and/or physical properties of the chemically active material.

After assembling the positive and negative plates to form cells, the battery may be subjected to a charging (i.e., formation) process. During this charging process, the composition of the chemically active materials may change to a state that provides an electrochemical potential between the positive and negative plates of the cells. For example, in a lead acid battery, the PbO active material of the positive plate may be electrically driven to lead dioxide (PbO₂), and the active material of the negative plate may be converted to sponge lead. Conversely, during subsequent discharge of a lead acid battery, the chemically active materials of both the positive and negative plates convert toward lead sulfate.

The blends of the presently disclosed embodiments include a network of pores, which can provide a large amount of surface area for each current collector. For example, in certain embodiments of the above described devices the low-gassing carbon particles are mesoporous, and in other embodiments the low-gassing carbon particles are microporous. Current collectors comprising the blends may exhibit more than 2000 times the amount of surface area provided by conventional current collectors. Further, a low-gassing carbon layer may be fabricated to exhibit any combination of physical properties described above.

The substrate (i.e., support) for the active material may include several different material and physical configurations. For example, in certain embodiments, the substrate may comprise an electrically conductive material, glass, or a polymer. In certain embodiments, the substrate may comprise lead or polycarbonate. The substrate may be formed as a single sheet of material. Alternatively, the substrate may comprise an open structure, such as a grid pattern having cross members and struts.

The substrate may also comprise a tab for establishing an electrical connection to a current collector. Alternatively, especially in embodiments where substrate includes a polymer or material with low electrical conductivity, a carbon layer may be configured to include a tab of material for establishing an electrical connection with a current collector. In such an embodiment, the carbon used to form a tab and the low-gassing carbon layer may be infused with a metal such as lead, silver, or any other suitable metal for aiding in or providing good mechanical and electrical contact to the low-gassing carbon layer.

The blends may be physically attached to the substrate such that the substrate can provide support for the blend. In one embodiment, the blend may be laminated to the substrate. For example, the blend and substrate may be subjected to any suitable laminating process, which may comprise the application of heat and/or pressure, such that the blend becomes physically attached to the substrate. In certain embodiments, heat and/or pressure sensitive laminating films or adhesives may be used to aid in the lamination process.

In other embodiments, the blend may be physically attached to the substrate via a system of mechanical fasteners. This system of fasteners may comprise any suitable type of fasteners capable of fastening a carbon layer to a support. For example, a blend may be joined to a support using staples, wire or plastic loop fasteners, rivets, swaged fasteners, screws, etc. Alternatively, a blend can be sewn to a support using wire thread, or other types of thread. In some of the embodiments, the blend may further comprise a binder (e.g., Teflon and the like) to facilitate attachment of the blend to the substrate.

In addition to the two-layered current collector (i.e., blend plus substrate) described above, the presently disclosed embodiments include other types of current collectors in combination with the two-layered current collector. For example, current collectors suitable for use with the presently disclosed embodiments may be formed substantially from carbon alone. That is, a carbon current collector consistent with this embodiment would lack a support backing. The carbon current collector may, however, comprise other materials, such as, metals deposited on a portion of the carbon surface to aid in establishing electrical contact with the carbon current collector.

Other current collectors may be formed substantially from an electrically conductive material, such as lead. The current collector may be made from lead and may be formed to include a grid pattern of cross members and struts. In one embodiment, the current collector may include a radial grid pattern such that struts intersect cross members at an angle. Current collector may also include a tab useful for establishing electrical contact to the current collector.

In one embodiment, the current collector may be made from lead and may be formed to include a hexagonal grid pattern. Specifically, the structural elements of the current collector may be configured to form a plurality of hexagonally shaped interstices in a hexagonally close packed arrangement. The current collector may also include a tab useful for establishing electrical contact to the current collector.

Consistent with the present disclosure, cells may be configured to include several different current collector arrangements. In one embodiment, one or more negative plates of a cell may comprise a current collector having a carbon layer disposed on a substrate. In this embodiment, one or more positive plates of a cell may include a carbon current collector (e.g., a carbon layer not including a substrate) or a lead grid current collector (e.g., a lead grid collector not including a layer of carbon).

In another embodiment, one or more positive plates of a cell may include a current collector comprising a carbon layer deposited on a substrate. In this embodiment, one or more negative plates of a cell may include a carbon current collector (e.g., a carbon collector not including a substrate) or a lead grid current collector (e.g., a lead grid collector not including a layer of carbon).

In yet another embodiment, both one or more negative plates and one or more positive plates may include a current collector comprising a carbon layer deposited on a substrate. Thus, in this embodiment, the two-layered current collector may be incorporated into both the positive and the negative electrode plates.

By incorporating the blends into the positive and/or negative plates of a battery, corrosion of the current collectors may be suppressed. As a result, batteries consistent with the present disclosure may offer significantly longer service lives. Additionally, the disclosed carbon current collectors may be pliable, and therefore, they may be less susceptible to damage from vibration or shock as compared to current collectors made from graphite plates or other brittle materials. Batteries including low-gassing carbon current collectors may perform well in vehicular applications, or other applications, where vibration and shock are common.

In another embodiment, the blend comprising low-gassing carbon may also comprise certain metal and metal oxide additives that enhance electrochemical performance. To this end, the cathode paste comprising lead and lead oxides can be mixed intimately with low-gassing carbon particles. Minor additions of certain other elements such as tin, antimony, bismuth, arsenic, tungsten, silver, zinc, cadmium, indium, silicon, oxides thereof, compounds comprising the same or combinations thereof offer the potential to increase the chemical energy storage efficiency of the positive active material. Some of these metal elements and their oxides act to replicate the lead dioxide crystal structure and provide additional nucleation sites for the charge discharge processes as well as an additional conductive network within the lead dioxide active material. These materials can be located within the pores of the low-gassing carbon and on the low-gassing carbon surface before the lead paste is applied. These metals can act as conductivity aids for the lead dioxide positive active material as well as increasing the efficiency of the lead dioxide active material through this increased conductivity network within the cathode. In certain embodiments, impurities such as arsenic, cobalt, nickel, iron, chromium and tellurium are minimized in the carbon and the electrode because they increase oxygen evolution on the cathode during the charge cycle.

In other embodiments, the blend does not contain significant quantities of metallic impurities such as sodium, potassium and especially calcium, magnesium, barium, strontium, chromium, nickel, iron and other metals, which form highly insoluble sulfate salts. These impurities will precipitate inside the pores of the carbon material and effectively impede its effectiveness. Sodium and potassium will neutralize an equi-molar amount of hydrogen ions and render them ineffective.

In another embodiment of the disclosure, the low-gassing carbon particles in the blend for use in the hybrid carbon lead energy storage device may be structured with a predominance of mesopores, that is pores from 2 nm to 50 nm in size, that when mixed into the positive or negative electrodes will enhance the electrochemical performance. Without being bound by theory, these mesoporous carbons offer the ability to promote fluid electrolyte to fully penetrate the active material within the electrode. By increasing the fluid penetration within the electrode structure, the diffusion distances between the electrolyte ions (e.g., sulfate) and the active material is reduced and the chemical charge and discharge process can proceed more efficiently. In addition, the low-gassing carbon used in this embodiment may also comprise a number of micropores less than 2 nm in size in conjunction with the mesopores.

The low-gassing carbon materials as described herein can be characterized in electrochemical systems including, but not limited to, capacitors, ultracapacitors (for example, with aqueous electrolyte comprising sulfuric acid, lithium ion battery, and lead acid batteries and related systems. The low-gassing carbon materials can be characterized electrochemically, for example for the capacitance (for example in a capacitor or ultracapacitor, for example to quantitate F/g when employing aqueous sulfuric acid as an electrolyte), the galvanostatic intermittent titration technique (GITT), four point probe measuring technique, electrochemical impedance spectroscopy (EIS), and other electrochemical techniques known in the art.

In certain embodiments, the low-gassing carbon exhibits certain combinations of desired properties, for example low gassing combined with high charge acceptance. In some embodiments, these attributes can be expressed as ratios, for example to describe the charge acceptance per unit gassing current. In certain embodiments, the charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah.

Other combinations of desirable attributes for the low gassing carbon are envisioned. In some embodiments, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a specific surface area greater than 500 m2/g, for example, greater than 700 m2/g, for example greater than 1000 m2/g, for example greater than 1500 m2/g, for example greater than 2000 m2/g.

In other embodiments, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a total pore volume greater than 0.5 cm3/g, for example greater than 0.7 cm3/g, for example greater than 1.0 cm3/g, for example greater than 1.2 cm3/g, for example greater than 1.5 cm3/g.

In other embodiments, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a pH between pH 3.0 and pH 7.0. Alternatively, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a pH between pH 6.0 and pH 8.0. Alternatively, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a pH between pH 7.0 and pH 10.0.

In certain embodiments, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits a particle size between 1 um and 10 micron, for example between 3 and 7 microns.

In certain embodiments, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits greater than 85% micropores, less than 15% mesopores, and less than 1% macropores. Alternatively, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits less than 50% micropores, more than 50% mesopores, and less than 0.1% macropores. Alternatively, the low-gassing carbon exhibits a charge acceptance per unit gassing current can be greater than 8 A/Ah, for example greater than 10 A/Ah, for example greater than 12 A/Ah, for example greater than 15 A/Ah, for example greater than 20 A/Ah, for example greater than 25 A/Ah, for example greater than 30 A/Ah, and in combination with any of the these exemplary charge acceptance per unit gassing current value the low gassing carbon also exhibits less than 30% micropores, and greater than 70% mesopores.

### EXAMPLES

### Example 1

### Preparation of Dried Polymer Gel

A polymer gel was prepared by polymerization of resorcinol and formaldehyde (0.5:1) in water and acetic acid (75:25) and ammonium acetate (RC=25, unless otherwise stated). The reaction mixture was placed at elevated temperature (incubation at 45° C. for about 6 h followed by incubation at 85° C. for about 24 h) to allow for gelation to create a polymer gel. Polymer gel particles were created from the polymer gel and passed through a 4750 micron mesh sieve. The sieved particles were frozen by immersion in liquid nitrogen, loaded into a lyophilization tray at a loading of 3 to 7 g/in², and lyophilized. The time to dry (as inferred from time for product to reach within 2° C. of shelf temperature) varied with product loading on the lyophilizer shelf.

The surface area of the dried polymer gel was examined by nitrogen surface analysis using a Micrometrics Surface Area and Porosity Analyzer (model Tri Star II). The measured specific surface area using the BET approach was in the range of about 500 to 700 m²/g.

Additional methodologies for preparation of dried polymer gel can be found in the art. These additional methodologies include, but are not limited to, spray drying, air drying, oven drying, kiln drying, pyrolysis, freeze drying using shelf or snap freezing, and freeze drying under conditions to obtain dried polymer gel with about 200 to 500 m2/g specific surface area.

### Example 2

### Preparation of a Polymer Gel from Melamine Formaldehyde

A polymer gel was prepared by the polymerization of melamine formaldehyde with resorcinol (85:15). The reaction mixture was placed at elevated temperature (incubation at 90 C for 24 to 48 hours) to allow for gelation to create a nitrogen-rich polymer gel.

### Example 3

### Preparation of a Polymer Gel from Melamine Formaldehyde with the Addition of Pluronic F127

A polymer gel was prepared by the polymerization of melamine formaldehyde with resorcinol and Pluronic F127. The melamine formaldehyde composed the base of the material and resorcinol was added in percentages ranging from 10% to 30% and Pluronic F127 was added in percentages ranging from 3% to 15%. The reaction mixture was placed at elevated temperature (incubation at 90 C for 24 to 72 hours) to allow for gelation to create a nitrogen-rich polymer gel with larger pore volume in the mesopore regime.

### Example 4

### Preparation of a Polymer Gel from Urea Formaldehyde

A polymer gel was prepared by the polymerization of urea formaldehyde with bisphenol-A (in a range of 50:50 to 95:5). The reaction mixture was placed at elevated temperature (incubation at 90 C for 24 to 48 hours) to allow for gelation to create a nitrogen-rich polymer gel.

### Example 5

### Preparation of Pyrolyzed Carbon Material from Dried Polymer Gel

Dried polymer gel prepared according to Example 2 was pyrolyzed by passage through a rotary kiln at 850° C. with a nitrogen gas flow of 200 L/h. The weight loss upon pyrolysis was about 52%-54%.

The surface area of the pyrolyzed dried polymer gel was examined by nitrogen surface analysis using a surface area and porosity analyzer. The measured specific surface area using the standard BET approach was in the range of about 600 to 700 m²/g.

Additional methodologies for preparation of pyrolyzed carbon can be found in the art. These additional methodologies can be employed to obtain pyrolzyed carbon with about 100 to 600 m2/g specific surface area.

### Example 6

### Preparation of Nitrogen-Rich Polymer Gel Via Pre-Treatment of Polymer with Urea

A polymer gel was prepared by polymerization of resorcinol and formaldehyde (0.5:1) in water and acetic acid (75:25) and ammonium acetate (RC=25, unless otherwise stated). The reaction mixture was placed at elevated temperature (incubation at 45° C. for about 6 h followed by incubation at 85° C. for about 24 h) to allow for gelation to create a polymer gel.

The polymer gel was then soaked in an aqueous solution of urea (1:1 urea:water unless otherwise stated) for 24 hours. This gel was dried at 100° C. for 24 hours to remove excess water. Polymer gel particles were created from the polymer gel and passed through a 4750 micron mesh sieve. The sieved particles were frozen by immersion in liquid nitrogen, loaded into a lyophilization tray at a loading of 3 to 7 g/in², and lyophilized. The time to dry (as inferred from time for product to reach within 2° C. of shelf temperature) varied with product loading on the lyophilizer shelf.

### Example 7

### Preparation of Nitrogen-Rich Pyrolyzed Carbon Material from Nitrogen-Rich Polymer Gel

Nitrogen-rich polymer gel prepared according to Examples 2, 3, and 4 was pyrolyzed in static kiln at 750° C. with a nitrogen gas flow of 200 L/h. In other embodiments, the nitrogen-rich polymer gel was passed through a rotary furnace at a temperature of 750° C. with a nitrogen gas flow of 200 L/h. In other embodiments, the pyrolysis temperature was varied from 750° C.-950° C. The weight loss upon pyrolysis was about 65-90%.

The surface area of the pyrolyzed dried polymer gel was examined by nitrogen surface analysis using a surface area and porosity analyzer. The measured specific surface area using the standard BET approach was in the range of about 300-700 m²/g.

### Example 8

### Chemical Treatment of Prior Art to Adjust the pH of the Material

Carbons described in prior art (example 2) can be treated with nitrogen to introduce nitrogen species on to the surface of the carbon. The carbon was treated via soaking in a solution of urea at room temperature, followed by drying to remove water, and a low-temperature pyrolysis step between 600° C. and 800° C. to ensure the nitrogen functionality is bound to the carbon surface. In other embodiments, the carbon is treated with ammonia in the gaseous state at elevated temperatures. In other embodiments, the carbon is treated with solid urea, or other nitrogen-based solids, by heating a mixture of solid urea with a carbon described in the previous art to pyrolysis temperatures between 600° C. and 800° C.

When the prior art is treated with urea in this manner, the pH of the material is increased, as can be seen in Table 2. Material 17-23 is an untreated carbon material while material 17-14 has been treated with urea.

In other embodiments, the carbon was soaked in sulfuric acid solution, in the same manner in which it was soaked in urea at room temperature, followed by drying and pyrolysis, as described for urea treatment. The resulting carbon material had a lower pH than then untreated carbon, as evidenced in Table 2. Material 17-23 is an untreated carbon while 17-15 is a carbon treated with sulfuric acid.

In other embodiments of this art, carbon soaking in a solution of urea can occur under reflux conditions to produce different groups of nitrogen functionality.

### Example 9

Production of Activated Carbon

The pyrolyzed carbon as described in Example 2 was activated in a rotary kiln (alumina tube with 2.75 in inner diameter) at 900° C. under a CO₂ flow rate of 30 L/min, resulting in a total weight loss of about 37%. Subsequently, this material was further activated at 900° C. in batchwise fashion in a silica tube (3.75 inch inner diameter) with 15 L/min CO₂ flow rate, to achieve a final weight loss (compared to the starting pyrolyzed carbon) of about 42 to 44%.

The surface area of the dried gel was examined by nitrogen surface analysis using a surface area and porosity analyzer. The measured specific surface area using the BET approach was in the range of about 1600 to 2000 m²/g.

Additional methodologies for preparation of activated carbon can be found in the art. These additional methodologies can be employed to obtain dried polymer gel with about 100 to 600 m2/g specific surface area.

### Example 10

### Micronization of Activated Carbon Via Jet Milling

The activated ultrapure carbon from Example 3 was jet milled using a 2 inch diameter jet mill. The conditions were about 0.7 lbs of ultrapure activated carbon per hour, nitrogen gas flow about 20 scf per min and about 100 psi pressure. The average particle size after jet milling was about 8 to 10 microns.

Additional methodologies for preparation of micronized particles of activated carbon can be found in the art. These additional methodologies can be employed to obtain micronized particles with mono- or polydisperse particle size distributions. These additional methodologies can be employed to obtain micronized particles with average size of about 1 to 8 microns. These additional methodologies can be employed to obtain micronized particles with average size of greater than 8 microns.

### Example 11

### Purity Analysis of Activated Carbon & Comparison Carbons

Activated carbon samples prepared according to Example 4 were examined for their impurity content via proton induced x-ray emission (PIXE). PIXE is an industry-standard, highly sensitive and accurate measurement for simultaneous elemental analysis by excitation of the atoms in a sample to produce characteristic X-rays which are detected and their intensities identified and quantified. PIXE is capable of detection of all elements with atomic numbers ranging from 11 to 92 (i.e., from sodium to uranium).

The PIXE impurity (Imp.) data for activated carbons as disclosed herein as well as other activated carbons for comparison purposes is presented in Table 1.1. Sample 1, 3, 4 and 5 are activated carbons prepared according to Example 3, Sample 2 is a micronized activated carbon prepared according to Example 4, Samples 6 and 7 are commercially available activated carbon samples).

As seen in Table 1.1, the synthetic activated carbons according to the instant disclosure have a lower PIXE impurity content and lower ash content as compared to other known activated carbon samples.

TABLE 1.1
PIXE Purity Analysis of Activated Carbon & Comparison Carbons

| | Impurity Concentration (PPM) | | | | | | |
|---|---|---|---|---|---|---|---|
| Impurity | Sample 1 | Sample 2 | Sample 3 | Sample 4 | Sample 5 | Sample 6 | Sample 7 |
| Na | ND* | ND | ND | ND | ND | 353.100 | ND |
| Mg | ND | ND | ND | ND | ND | 139.000 | ND |
| Al | ND | ND | ND | ND | ND | 63.850 | 38.941 |
| Si | 53.840 | 92.346 | 25.892 | 17.939 | 23.602 | 34.670 | 513.517 |
| P | ND | ND | ND | ND | ND | ND | 59.852 |
| S | ND | ND | ND | ND | ND | 90.110 | 113.504 |
| Cl | ND | ND | ND | ND | ND | 28.230 | 9.126 |
| K | ND | ND | ND | ND | ND | 44.210 | 76.953 |
| Ca | 21.090 | 16.971 | 6.141 | 9.299 | 5.504 | ND | 119.804 |
| Cr | ND | ND | ND | ND | ND | 4.310 | 3.744 |
| Mn | ND | ND | ND | ND | ND | ND | 7.552 |
| Fe | 7.582 | 5.360 | 1.898 | 2.642 | 1.392 | 3.115 | 59.212 |
| Ni | 4.011 | 3.389 | 0.565 | ND | ND | 36.620 | 2.831 |
| Cu | 16.270 | 15.951 | ND | ND | ND | 7.927 | 17.011 |
| Zn | 1.397 | 0.680 | 1.180 | 1.130 | 0.942 | ND | 2.151 |
| Total | 104.190 | 134.697 | 35.676 | 31.010 | 31.44 | 805.142 | 1024.198 |
| (% Ash) | (0.018) | (0.025) | (<0.007) | (0.006) | (0.006) | (0.13) | (0.16) |

*ND = not detected by PIXE analysis

Activated carbon samples prepared according to Example 17 were examined for their impurity content via total reflection x-ray fluorescence spectroscopy (TXRF). TXRF is an industry-standard, highly sensitive and accurate measurement for simultaneous elemental analysis by excitation of the atoms in a sample to produce characteristic X-ray fluorescence which is detected and the intensities identified and quantified. TXRF is capable of detection of all elements with atomic numbers 13 and higher (Aluminum and heavier elements).

The TXRF impurity (Imp.) data for activated carbons as disclosed herein as well as other activated carbons for comparison purposes is presented in Table 1. Carbons 1 and 2 are comparative prior art carbons.

As seen in Table 1, the synthetic activated carbons according to the instant disclosure have a lower TXRF impurity content and lower ash content as compared to other known activated carbon samples.

TABLE 1.2
TXRF Purity Analysis of Activated Carbon & Comparison Carbons

| | Impurity Concentration (ppm) | | | | | | | | |
|---|---|---|---|---|---|---|---|---|---|
| | BASF- | | M2-33 | M2-23 | | | | | |
| | 1-79 | M2-33 | 30-74 | 30-46 | V2-12 | M2-33 | M2-33 | | |
| | (similar | 30-86 | (similar | (similar | 20-53 | 30-98 | 30-73 | | |
| Imp. | to 17-9) | (17-12) | to 17-12) | to 17-8) | (17-21) | (17-10) | (17-11) | Carbon 1 | Carbon 2 |
| Al | 0 | 0 | 0 | 0 | 0 | 0 | 0 | 0 | 0 |
| P | 0 | 0 | 0 | 0 | 0 | 0 | 0 | 0 | 0 |
| S | 0 | 0 | 0 | 0 | 0 | 0 | 0 | 5524.87 | 1790.09 |
| Cl | 0 | 0 | 0 | 0 | 19.20 | 0 | 0 | 79.35 | 48.32 |
| K | 0 | 0 | 0 | 0 | 0 | 0 | 0 | 439.29 | 3292.04 |
| Ca | 0 | 9.39 | 21.43 | 31.95 | 18.75 | 22.59 | 19.07 | 672.75 | 2189.32 |
| Ti | 0 | 0 | 0 | 0 | 0 | 0 | 0 | 2.86 | 89.90 |
| V | 0 | 0 | 0 | 0 | 0 | 0 | 0 | 0 | 49.09 |
| Cr | 4.99 | 0 | 0 | 0 | 1.73 | 4.36 | 0 | 2.11 | 0 |
| Mn | 0 | 0 | 0 | 0 | 0 | 0 | 0 | 0 | 2.98 |
| Fe | 37.16 | 12.66 | 0.71 | 6.00 | 7.62 | 18.16 | 0.47 | 65.97 | 11.84 |
| Ni | 0 | 0 | 0 | 0 | 2.63 | 1.95 | 0 | 0.71 | 0 |
| Cu | 0 | 0 | 0 | 0 | 0 | 3.25 | 0 | 0 | 0 |
| Zn | 0 | 0.90 | 0.73 | 4.05 | 1.84 | 1.33 | 0.88 | 2.12 | 2.07 |
| Br | 0 | 0 | 0 | 0 | 0 | 0.69 | 0.21 | 3.34 | 1.25 |
| W | 0 | 0 | 0 | 0 | 1.95 | 0 | 0 | 0 | 0 |
| Pb | 2.24 | 0.65 | 0 | 1.34 | 0 | 0.53 | 0 | 32.82 | 4.03 |
| Total | 44.39 | 23.60 | 22.86 | 43.34 | 53.73 | 52.86 | 20.62 | 6826.19 | 7481.01 |
| (% | (0.006%) | (0.003%) | (0.003%) | (0.006%) | (0.005%) | (0.008%) | (0.003%) | (0.104%) | (0.308%) |
| Ash) | | | | | | | | | |

* 0 = not detected by TXRF analysis

### Example 12

### Preparation of NAM Plates Containing a Low-Gassing Carbon

Low-gassing carbon can be incorporated into lead pasted plates using methods known in the art. 500 g of leady oxide powder (an industry standard mixture of lead and lead oxide comprised of less than 30% metallic lead), 1 g of synthetic lignin, 3 g of BaSO₄ and 1 g of low-gassing carbon are mixed in a stand mixer with a glass mixing bowl and a plastic spatula stirring attachment. They are mixed on a low speed to combine all ingredients. To this, 65 mL of distilled water is added and it is mixed to combine. To this mixture, 39 mL of 4.8M sulfuric acid is added dropwise via addition funnel while stirring. At this point a homogeneous grey/orange paste is obtained with the low-gassing carbon fully incorporated. The density of the paste was measured using a small cup with a known volume.

In some embodiments, the high-surface area carbon is wetted with water or formed into a slurry prior to adding to the leady oxide/lignin/BaSO₄ mixture. In other embodiments, more or less solvent (water/acid) is used to bring the paste to a desired/tailored density (e.g. 41 mL acid/63 mL water, 36 mL acid/68 mL water, etc.). In still other embodiments, the content of high-surface area carbon is either increased or decreased from that in Example 1 (e.g. 0.5 wt %, 2 wt %, 3 wt %, etc.). In still other embodiments, the low-gassing carbon is mixed with small amounts of other types of carbon materials (e.g., carbon black, graphite, carbon nanotubes) in varying ratios (e.g. 90:10, 70:30).

The paste density, as known in the lead-acid battery art, should be approximately 4 g/cc. Someone who is familiar in the art would be able to modify the water and carbon content from the table below in order to achieve the optimal paste density.

The paste was applied to lead alloy grids by hand using a plastic spatula. The pasted grids were cured in a humid environment 65° C. for 24 hours, then dried in an oven containing sufficient desiccant at 65° C. for 24 hours, at which point, they were ready for testing.

In another embodiment the pasted grids are dried at lower temperatures (e.g. 30, 40, 50, 60° C.) or higher temperatures (e.g. 80, 90, 100, 120° C.) for longer or shorter periods of time (e.g. 0, 2, 4, 6, 8, 10, 12, 36, 48 hours) at lower percent relative humidity (e.g. 1, 5, 10, 20%) or higher percent relative humidity (e.g. 60, 75, 95, 100%).

### Example 13

### Device with Lead Acid Electrode and Low-Gassing Carbon-Containing Electrode

An energy storage device is constructed from a lead oxide cathode and a low-gassing carbon and lead-containing anode, used to make a 2V scale cell for testing purposes. The anode is prepared as described above. The cathode is prepared by the same method, but excluding the low-gassing carbon, lignin, and BaSO₄.

In this embodiment, it is important to exclude the presence of impurities in the low-gassing carbon such as arsenic, cobalt, nickel, iron, antimony and tellurium in the carbon and from the electrode in general because they increase hydrogen evolution on the anode during the charge cycle.

It is important that the low-gassing carbon not contain metallic impurities such as sodium, potassium and especially calcium, magnesium, barium, strontium, iron and other metals, which form highly insoluble sulfate salts. These will precipitate inside the pores of the carbon and impede its effectiveness. Sodium and potassium will neutralize an equi-molar amount of hydrogen ions and render them ineffective.

If low-gassing carbon as described above is present in the anode paste as concentrations of 0.1 to 10 wt %, cycle life will improve by a factor of 2-10 in partial state of charge applications. Current and energy efficiency will improve also. Hydrogen evolution will not be exacerbated if the low-gassing carbon is used in concentrations of 0.1 to 10 wt %.

### Example 14

### Performance of Device with Lead Acid Electrode and Low-Gassing Carbon-Containing Electrode: Gassing Measured Via Hoffman Apparatus

A slurry of the previously described low-gassing carbon is made by combining a mixture of carbon, conductive binder (e.g., polyvinylidine fluoride) and an organic solvent (e.g. dimethylsulfoxide). This slurry is subsequently coated on to a pure lead wire, and dried in a vacuum. Using the low-gassing carbon-coated lead wire as the anode and a PbO₂ sheet as the cathode, both electrodes are submerged in a 37 wt % sulfuric acid solution. A potential of 5V is applied to produce exacerbated gassing for several hours. The amount of water loss in the apparatus is recorded and relative amounts of water loss are compared. When the low-gassing carbon described herein is employed, the water loss is significantly reduced from previously described carbon systems.

### Example 15

### Performance of Device with Lead Acid Electrode and Low-Gassing Carbon-Containing Electrode: Gassing Measured Via Cyclic Voltammetry

In this embodiment, using the 2V lead/lead oxide cell construction as described previously, a cyclic voltammetry sweep is performed from 2.0V to 2.7V and the current is recorded, as well as the voltage of both the anode and the cathode, with the use of a Hg|Hg₂SO₄ reference electrode. This current (normalized to anode mass) gives a relative measurement of gassing for different cells. When the low-gassing carbon described herein is employed, the gassing current is significantly reduced from previously described carbon systems.

### Example 16

### Performance of Device with Lead Acid Electrode and Low-Gassing Carbon-Containing Electrode: Gassing Measured Via Potentiostatic Hold

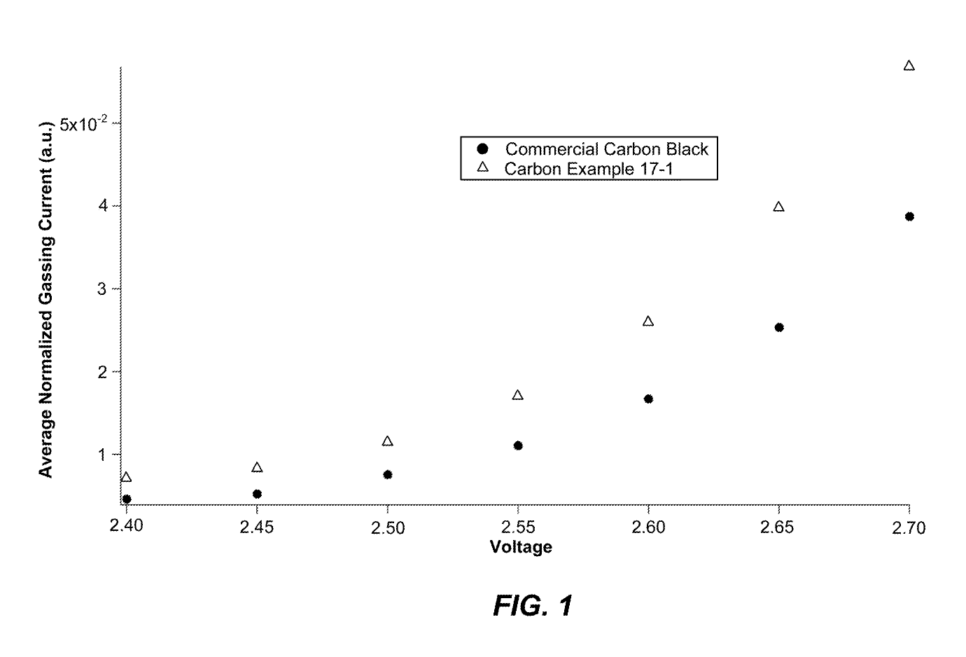

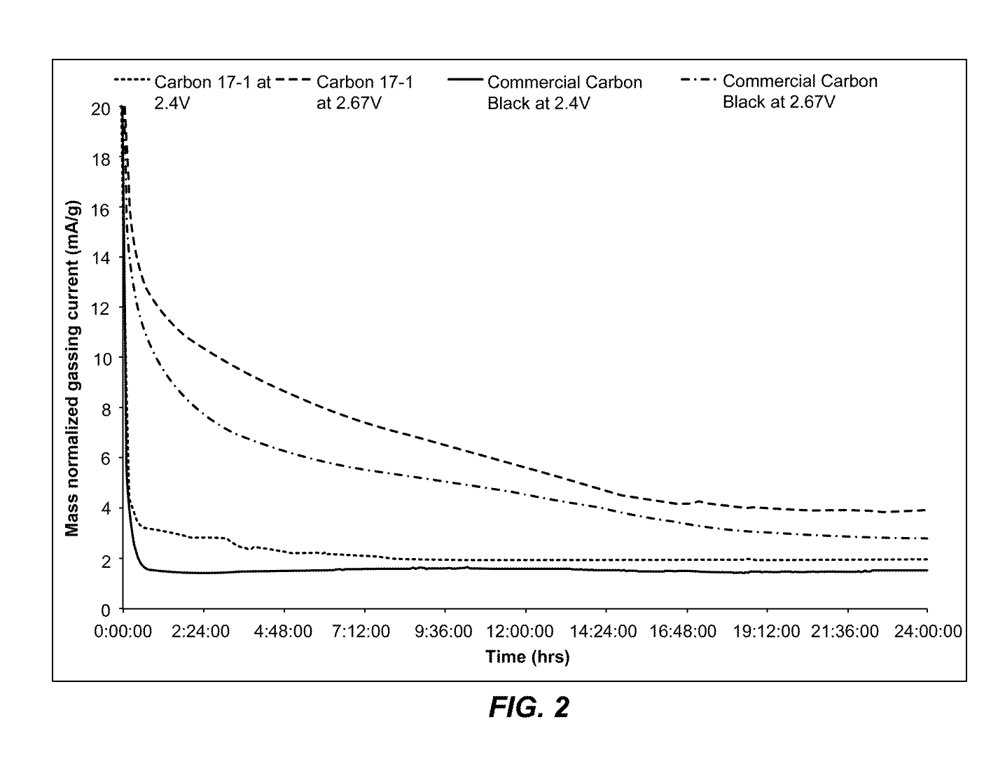

In this embodiment, using the 2V lead/lead oxide cell construction as described previously, a series of potentiostatic holds can be performed and the current at those given potentials measured. Starting with a 4 hour hold at 2.40V, a series of 50 mV potential steps, each accompanied by a 1 hour hold, going from 2.40V to 2.70V. The average current at each potential step is recorded and normalized to anode mass. The output of this test can be seen in FIG. 1 (redo FIG. 1 with mass normalized data?). In other embodiments, the potential steps are smaller (e.g. 10, 20, 30 mV). In still other embodiments, the potential steps are larger (e.g. 75, 100 mV). The current (normalized to anode mass) measured at 2.65V gives a relative measurement of gassing for different cells. In other embodiments, other potentials may be used as a metric for measuring relative gassing (e.g. 2.40, 2.67, 2.70 V). The output of this test can be seen in FIG. 2. When the low-gassing carbon described herein is employed, the gassing current is significantly reduced from previously described carbon systems.

### Example 17

### Properties of Various Carbons

A variety of different carbons were analyzed for their specific surface area and pore volume distribution (% micropore, % mesoopore, and % macropore) via nitrogen sorption, particle size distribution by laser light scattering, pH. The data are presented in Table 2

TABLE 2
Characterization of carbon materials according to Example 17.

| | | | | | | Particle | |
|---|---|---|---|---|---|---|---|
| | | | Total | Tap | Pore | Size | |
| | | SSA | PV | Density | Volume | Distribution | |
| Carbon | Description | (m2/g) | (cm3/g) | (g/cm3) | Distribution | (um) | pH |
| 17-1 | Prior Art: | 705 | 0.57 | 0.44 | 42.5% | Dv,0 = 0.42 | 6.0 |
| | pyrolized | | | | micropores | | |
| | carbon | | | | 57.5% | Dv,1 = 0.73 | |
| | | | | | mesopores | | |
| | | | | | <0.001% | Dv,50 = | |
| | | | | | macropores | 6.19 | |
| | | | | | | Dv,99 = | |
| | | | | | | 17.32 | |
| | | | | | | Dv,100 = | |
| | | | | | | 21.17 | |
| 17-2 | Prior Art: | 708 | 0.79 | 0.35 | 28.1% | Dv,0 = 2.15 | 7.3 |
| | pyrolized | | | | micropores | | |
| | carbon | | | | 71.9% | Dv,1 = 4.81 | |
| | | | | | mesopores | | |
| | | | | | | Dv,50 = | |
| | | | | | | 43.1 | |
| | | | | | | Dv,99 = | |
| | | | | | | 119 | |
| | | | | | | Dv,100 = | |
| | | | | | | 144 | |
| 17-3 | Prior Art: | 1726 | 1.28 | 0.25 | 46.2% | Dv,1 = 0.9 | 8.4 |
| | activated | | | | micropores | | |
| | carbon | | | | 53.8% | Dv,50 = | |
| | | | | | mesopores | 67.6 | |
| | | | | | <0.01% | Dv,99 = | |
| | | | | | macropores | 19.3 | |
| | | | | | | Dv,100 = | |
| | | | | | | 23.9 | |
| 17-4 | Prior Art: | 1582 | 1.21 | 0.33 | 44.8% | Dv,1 = 1.06 | 6.6 |
| | activated | | | | micropores | | |
| | carbon | | | | 55.2% | Dv,10 = | |
| | | | | | mesopores | 2.89 | |
| | | | | | <0.01% | Dv,50 = 6.8 | |
| | | | | | macropores | | |
| | | | | | | Dv,90 = | |
| | | | | | | 11.8 | |
| | | | | | | Dv,100 = | |
| | | | | | | 18.62 | |
| 17-5 | Prior Art: | 1667 | 1.29 | 0.20 | 48.7% | Dv,1 = 1.06 | 7.6 |
| | activated | | | | micropores | | |
| | carbon | | | | 51.2% | Dv,10 = | |
| | | | | | mesopores | 2.89 | |
| | | | | | 0.1% | Dv,50 = 6.8 | |
| | | | | | macropores | | |
| | | | | | | Dv,90 = | |
| | | | | | | 11.8 | |
| | | | | | | Dv,100 = | |
| | | | | | | 18.62 | |
| 17-6 | Prior Art: | 1859 | 0.79 | 0.38 | 89.7% | Dv,1 = 0.71 | 5.6 |
| | activated | | | | micropores | | |
| | carbon | | | | 9.5% | Dv,50 = 5.7 | |
| | | | | | mesopores | | |
| | | | | | 0.8% | Dv,99 = | |
| | | | | | macropores | 14.2 | |
| | | | | | | Dv,100 = | |
| | | | | | | 18.1 | |
| 17-7 | Prior Art: | 1771 | 0.75 | 0.38 | 86.4% | Dv,1 = 0.52 | 8.9 |
| | activated | | | | micropores | | |
| | carbon | | | | 12.1% | Dv,50 = | |
| | | | | | mesopores | 6.44 | |
| | | | | | 1.5% | Dv,99 = | |
| | | | | | macropores | 19.5 | |
| | | | | | | Dv,100 = | |
| | | | | | | 24.1 | |
| 17-8 | Prior Art: | 1711 | 1.29 | 0.29 | 46% | Dv,1 = 0.8 | 7.3 |
| | activated | | | | micropores | | |
| | carbon | | | | 54% | Dv,50 = | |
| | | | | | mesopores | 6.26 | |
| | | | | | 0% | Dv,99 = | |
| | | | | | macropores | 15.84 | |
| | | | | | | Dv,100 = | |
| | | | | | | 18.26 | |
| 17-9 | Low-gassing | 554 | 0.24 | | 95.9% | Dv,1 = 1.3 | 6.4 |
| | carbon: | | | | micropores | | |
| | melamine | | | | 3.9% | Dv,50 = | |
| | formaldehyde | | | | mesopores | 34.7 | |
| | polymer gel | | | | 0.2% | Dv,90 = | |
| | | | | | macropores | 113 | |
| | | | | | | Dv,100 = | |
| | | | | | | 211 | |
| 17-10 | Prior Art: | 674 | 0.68 | 0.57 | % | Dv,1 = 2.0 | 8.1 |
| | pyrolized | | | | micropores | | |
| | carbon | | | | % | Dv,50 = | |
| | | | | | mesopores | 54.7 | |
| | | | | | % | Dv,99 = | |
| | | | | | macropores | | |
| | | | | | | Dv,100 = | |
| | | | | | | 237.6 | |
| 17-11 | Prior Art: | 682 | 0.74 | 0.54 | % | Dv,1 = 5.43 | 8.3 |
| | pyrolized | | | | micropores | | |
| | carbon | | | | % | Dv,50 = | |
| | | | | | mesopores | 44.3 | |
| | | | | | % | Dv,99 = | |
| | | | | | macropores | 173 | |
| | | | | | | Dv,100 = | |
| | | | | | | 269 | |
| 17-12 | Prior Art: | 650 | 0.61 | 0.64 | % | Dv,1 = 6.4 | 6.9 |
| | pyrolized | | | | micropores | | |
| | carbon | | | | % | Dv,50 = | |
| | | | | | mesopores | 55.1 | |
| | | | | | % | Dv,99 = | |
| | | | | | macropores | 197.5 | |
| | | | | | | Dv,100 = | |
| | | | | | | 288.6 | |
| 17-13 | Prior art with | 688 | 0.64 | | 34.2% | Dv,1 = um | 6.5 |
| | chemical | | | | micropores | | |
| | treatment | | | | 65.8% | Dv,50 = | |
| | with peroxide | | | | mesopores | um | |
| | | | | | 0% | Dv,99 = | |
| | | | | | macropores | um | |
| | | | | | | Dv,100 = | |
| | | | | | | um | |
| 17-14 | Prior art with | 666 | 0.47 | | % | Dv,1 = um | 8.6 |
| | chemical | | | | micropores | | |
| | treatment | | | | % | Dv,50 = | |
| | with urea | | | | mesopores | um | |
| | | | | | % | Dv,99 = | |
| | | | | | macropores | um | |
| | | | | | | Dv,100 = | |
| | | | | | | um | |
| 17-15 | Prior art with | 713 | 0.70 | | 32.3% | Dv,1 = um | 6.7 |
| | chemical | | | | micropores | | |
| | treatment | | | | 67.7% | Dv,50 = | |
| | with sulfuric | | | | mesopores | um | |
| | acid | | | | 0% | Dv,99 = | |
| | | | | | macropores | um | |
| | | | | | | Dv,100 = | |
| | | | | | | um | |
| 17-16 | Prior art with | 671 | 0.69 | | 29.7% | Dv,1 = um | 8.7 |
| | heat | | | | micropores | | |
| | treatment | | | | 70.2% | Dv,50 = | |
| | | | | | mesopores | um | |
| | | | | | 0% | Dv,99 = | |
| | | | | | macropores | um | |
| | | | | | | Dv,100 = | |
| | | | | | | um | |
| 17-17 | Prior art | 683 | 0.58 | | 39.0% | Dv,1 = um | 6.7 |
| | pyrolized at | | | | micropores | | |
| | 750 C. | | | | 60.3% | Dv,50 = | |
| | | | | | mesopores | um | |
| | | | | | 0.8% | Dv,99 = | |
| | | | | | macropores | um | |
| | | | | | | Dv,100 = | |
| | | | | | | um | |
| 17-18 | Nitrogen-rich | 456 | 0.20 | | 96.2% | Dv,1 = um | 6.1 |
| | carbon from | | | | micropores | | |
| | melamine | | | | 2.3% | Dv,50 = | |
| | formaldehyde | | | | mesopores | um | |
| | with heat | | | | 1.5% | Dv,99 = | |
| | treatment | | | | macropores | um | |
| | | | | | | Dv,100 = | |
| | | | | | | um | |
| 17-19 | Nitrogen-rich | 522 | 0.22 | | 96.8% | Dv,1 = um | 6.7 |
| | carbon from | | | | micropores | | |
| | melamine | | | | 1.8% | Dv,50 = | |
| | formaldehyde | | | | mesopores | um | |
| | with | | | | 1.4% | Dv,99 = | |
| | chemical | | | | macropores | um | |
| | treatment | | | | | Dv,100 = | |
| | with urea | | | | | um | |
| 17-20 | Prior Art: | 696 | 0.68 | 0.55 | 31% | Dv,1 = 1.1 | 6.4 |
| | pyrolized | | | | micropores | | |
| | carbon | | | | 69% | Dv,50 = | |
| | | | | | mesopores | 33.7 | |
| | | | | | 0% | Dv,99 = | |
| | | | | | macropores | 117 | |
| | | | | | | Dv,100 = | |
| | | | | | | 182 | |
| 17-21 | Prior Art: | 1644 | 0.74 | 0.42 | 89.4% | Dv,1 = 0.7 | 8.0 |
| | activated | | | | micropores | | |
| | carbon | | | | 10.3% | Dv,50 = 6.1 | |
| | | | | | mesopores | | |
| | | | | | 0.3% | Dv,90 = | |
| | | | | | macropores | 11.7 | |
| | | | | | | Dv,100 = | |
| | | | | | | 18.7 | |
| 17-22 | Low-gassing | 500 | 0.21 | | 91.3% | Dv,1 = 0.4 | 6.4 |
| | carbon: urea | | | | micropores | | |
| | formaldehyde | | | | 3.7% | Dv,50 = 4.3 | |
| | polymer gel | | | | mesopores | | |
| | | | | | 5.0% | Dv,99 = | |
| | | | | | macropores | 20.4 | |
| | | | | | | Dv,100 = | |
| | | | | | | 27.3 | |
| | | | | | % | Dv,1 = 1.9 | 8.0 |
| 17-23 | Prior Art: | | | | micropores | | |
| | pyrolized | | | | % | Dv,50 = | |
| | carbon | | | | mesopores | 57.3 | |
| | passed | | | | % | Dv,99 = | |
| | through a | | | | macropores | 175 | |
| | 212 um sieve | | | | | Dv,100 = | |
| | | | | | | 238 | |
| 17-24 | Low-gassing | 383 | 0.21 | | 71.1% | Dv,1 = um | |
| | carbon: | | | | micropores | | |
| | melamine | | | | 28.4% | Dv,50 = | |
| | formaldehyde | | | | mesopores | um | |
| | polymer gel | | | | 0.5% | Dv,99 = | |
| | | | | | macropores | um | |
| | | | | | | Dv,100 = | |
| | | | | | | um | |
| 17-24 | Low-gassing | 571 | 0.44 | | 38% | Dv,1 = um | |
| | carbon: | | | | micropores | | |
| | Pluronic | | | | 56% | Dv,50 = | |
| | F127 additive | | | | mesopores | um | |
| | | | | | 6% | Dv,99 = | |
| | | | | | macropores | um | |
| | | | | | | Dv,100 = | |
| | | | | | | um | |
| 17-25 | Polymer gel | | | | % | Dv,1 = um | |
| | made from | | | | micropores | | |
| | urea | | | | % | Dv,50 = | |
| | formaldehyde | | | | mesopores | um | |
| | | | | | % | Dv,99 = | |
| | | | | | macropores | um | |
| | | | | | | Dv,100 = | |
| | | | | | | um | |
| 17-26 | Polymer gel | | | | % | Dv,1 = um | |
| | made from | | | | micropores | | |
| | melamine | | | | % | Dv,50 = | |
| | formaldehyde | | | | mesopores | um | |
| | | | | | % | Dv,99 = | |
| | | | | | macropores | um | |
| | | | | | | Dv,100 = | |
| | | | | | | um | |
| 17-27 | Dried | | | | % | Dv,1 = um | |
| | polymer gel | | | | micropores | | |
| | | | | | % | Dv,50 = | |
| | | | | | mesopores | um | |
| | | | | | % | Dv,99 = | |
| | | | | | macropores | um | |
| | | | | | | Dv,100 = | |
| | | | | | | um | |
| 17-28 | Macroporous | 700 | 1.1 | | 11% | Dv,1 = um | |
| | non-nitrogen | | | | micropores | | |
| | containing | | | | 80% | Dv,50 = | |
| | carbon | | | | mesopores | <38 | |
| | | | | | 9% | Dv,99 = | |
| | | | | | macropores | um | |
| | | | | | | Dv,100 = | |
| | | | | | | um | |
| Comparative | Carbon black | 117 | 0.24 | | 1.5% | Dv,1 = um | |
| Carbon 1 | | | | | micropores | | |
| | | | | | 43.0% | Dv,50 = | |
| | | | | | mesopores | um | |
| | | | | | 55.5% | Dv,99 = | |
| | | | | | macropores | um | |
| | | | | | | Dv,100 = | |
| | | | | | | um | |
| Comparative | Activated | 1532 | 1.51 | 0.36 | 31.7% | Dv,1 = 0.9 | 9.1 |
| Carbon 2 | carbon | | | | micropores | | |
| | | | | | 67.9% | Dv,50 = | |
| | | | | | mesopores | 11.4 | |
| | | | | | 0.4% | Dv,90 = | |
| | | | | | macropores | 27.8 | |
| | | | | | | Dv,100 = | |
| | | | | | | 45.6 | |

### Example 18

### Performance of Device with Lead Acid Electrode and Low-Gassing Carbon-Containing Electrode: Gassing Measured Via Water Loss

Those in the industry will know the common industry standard of measuring water loss during an extended period of a float hold, at elevated temperatures or room temperature. In this embodiment, 12V lead acid cells will be constructed by battery manufacturers according to their specifications. The anode will contain 0.1 to 10 wt % of the low-gassing carbon material. The battery will be tested for water loss using standard water loss tests known by those in the industry. A common standard is the VDA water loss specification in which a 12V lead acid cell is subjected to a 14.4V overcharge at 60° C. for 12 weeks. The weight loss of the battery is recorded, and if the cell loses more than 3 g of water per Ah of the battery, it does not pass the test. In other embodiments, 2V cells can be used as a proxy for the 12V cells and the water loss is scaled accordingly.

### Example 19

### Performance of Device with Lead Acid Electrode and Low-Gassing Carbon-Containing Electrode: Measurement of Cycle Life

Those in the industry know that the measurement of cycle life depends on the desired performance application of the lead acid battery (e.g. traction, SLI, automotive) and the battery manufacturer specifications. There are many industry-accepted tests for cycle life including the US DOE cycle life test, tests from the International Electrochemical Commission, SAE specifications, VDA specifications, and others. When the low-gassing carbon described herein is employed, the cycle life will be extended by 2-10 times over cells that contain standard carbon materials.

### Example 20

### Performance of Device with Lead Acid Electrode and Low-Gassing Carbon-Containing Electrode: Measurement of Static Charge Acceptance

In this embodiment, the 2V lead acid cell containing low-gassing carbon in the anode as described previously is brought to a specified state of charge from 5 to 50% depth of discharge. At this specified state of charge, a constant potential of 2.0 to 2.6 V is applied for a specified period of time from 1 second to 15 minutes. The charge recovered (in Amps) during this period of time is defined as the charge acceptance. This charge is normalized to the cell capacity (in Amp hours) so that the final unit for static charge acceptance is per hour. An example of two cells during the constant potential hold step of the static charge acceptance test can be found in FIG. 2. When the low-gassing carbon described herein is incorporated in to the anode, the current recorded during the static charge acceptance test will be higher than for cells that do not contain the material.

### Example 21

### Performance of Device with Lead Acid Electrode and Low-Gassing Carbon-Containing Electrode: Measurement of Dynamic Charge Acceptance

In this embodiment, the 2V lead acid cell containing low-gassing carbon in the anode as described previously is used in a modified protocol of the VDA dynamic charge acceptance testing protocol. The cell is brought to a specified state of charge of 90%. At this state of charge, a constant potential of 2.5V is applied for 60 seconds and the charging current is recorded. The cell is then brought to an 80% state of charge, and the same constant potential pulse at 2.5V is applied for 60 seconds and the current recorded. This same protocol is repeated 70% and 60% states of charge. When the low-gassing carbon described herein is incorporated in to the anode, the current recorded during the dynamic charge acceptance tests will be higher than for cells that do not contain the material.

### Example 22

### Wettability of Carbon for Paste Preparation

The amount of additional water needed to properly paste lead grids as negative active material (NAM) depends upon the physical properties of the carbon, such as pore volume and pore type. The point at which the carbon is fully wet is determined through titration of water into carbon and mechanical mixing. Wettability of the carbon is determined as follows: 2.409 grams of mesoporous carbon is combined with water in a planetary mixer. An R-Factor can be used to assess the amount of water needed to fully wet a carbon. At 4 mL (R=1.6603 mL water/g carbon), the mixture visibly transitions from partially wet to fully wet. In one embodiment the carbon has high pore volume where the R-value >1.6 mL/g. In another embodiment the carbon has a medium pore volume where the R-value is between 1.2 and 1.6 mL/g. In yet another embodiment the carbon has a low pore volume where the R-value is less than 1.2 mL/g. The more electrolyte access to the interior of the structure the more active material will be utilized. In some embodiments, the highest pore volume carbon allows for the greatest access of electrolyte to the internal lead structure.

### Example 23

### Acid Titration Properties of Carbon

0.25 grams of carbon are measured into a 60 mL polypropylene bottle. 45% of 37% sulfuric acid aqueous solution is added to the bottle and sealed. The bottle is secured and agitated for 24 hours. The liquid is then filtered from the solids and titrated using NaOH, as known in the art. The change in the molarity of sulfuric acid solution can be plotted versus the pH of activated and pre-actived carbon. A positive change in molarity per carbon indicates that the solution was more acidic after the test. A negative change in molarity per carbon indicates that the solution was more basic after the test.

An unexpected result was the effect of heat treatment on activated carbons. Once activated carbons are heat treated to a pH >7, the change in molarity per gram carbon becomes independent of the carbon pH. It is only for non-heat treated carbon that there is a direct correlation between the change in molarity per carbon and the pH. There is an unexpected maxiuma in the change in molarity of the solution per carbon when carbon is close to a neutral pH (between 5 and 7). This is for both activated and pre-actived carbons. In other embodiments the change in molarity per carbon is negative, indicating more basic from a control, as seen from carbons with low (<5). In yet other embodiments the acid adsorption as measured as a change in molarity per carbon is not dependent upon the pH for pH values above 7.

Yet another surprising result was that the change in molarity of the solution per carbon had no dependence upon the pore volume or pore type (micro versus mesoporous). In fact, the only correlation is between the pH and the change in molarity. In an even more surprising result, the more acid carbon did not yield more acid solution, rather the solution was actually more basic than the control. As previously explained, this unexpected result gives rise to the local maxima for a semi-neutral carbon pH.

### Example 24

### Measurement of Carbon Characteristics: X-Ray Photoelectron Spectroscopy of a Nitrogen-Rich Carbon to Determine Surface Chemistry

The surface chemistry of a nitrogen-rich carbon was determined using x-ray photoelectron spectroscopy. X-ray photoelectron spectroscopy is a research standard used to identify elemental composition and the types of chemical bonds each element participates in. In this case, the nitrogen-rich carbons were analyzed for total surface nitrogen and oxygen content, and the bonding of each of these elements was analyzed. There were significant differences in the type and amount of surface nitrogen for the samples pyrolyzed at higher temperatures (−900° C.) than under lower pyrolysis conditions (−700° C.).

### Example 25

### Measurement of Carbon Characteristics: Combustion to Determine Bulk Carbon and Nitrogen Content

The industry standard of combustion was used to quantify the ratio of the elements carbon, nitrogen and hydrogen. Method obtained from the book, “Methods of Soil Analysis: Part 2. Published 1982.” This method gives the bulk quantities of the non-metallic components of the sample. The samples pyrolyzed in lower temperature ranges (600° C.-850° C.) have higher nitrogen content than those pyrolyzed at higher temperature ranges (900° C. -1150° C.). All samples have higher nitrogen content than standard carbon materials or the previous art, which have little to no nitrogen.

### Example 26

### Effect of Pyrolysis Conditions on the Physical Properties of Nitrogen-Rich Pyrolyzed Carbon Material from Nitrogen-Rich Polymer Gel

Nitrogen-rich carbon materials prepared according to the previous example 2. When varying pyrolysis conditions, the physical properties of the material can be controlled.

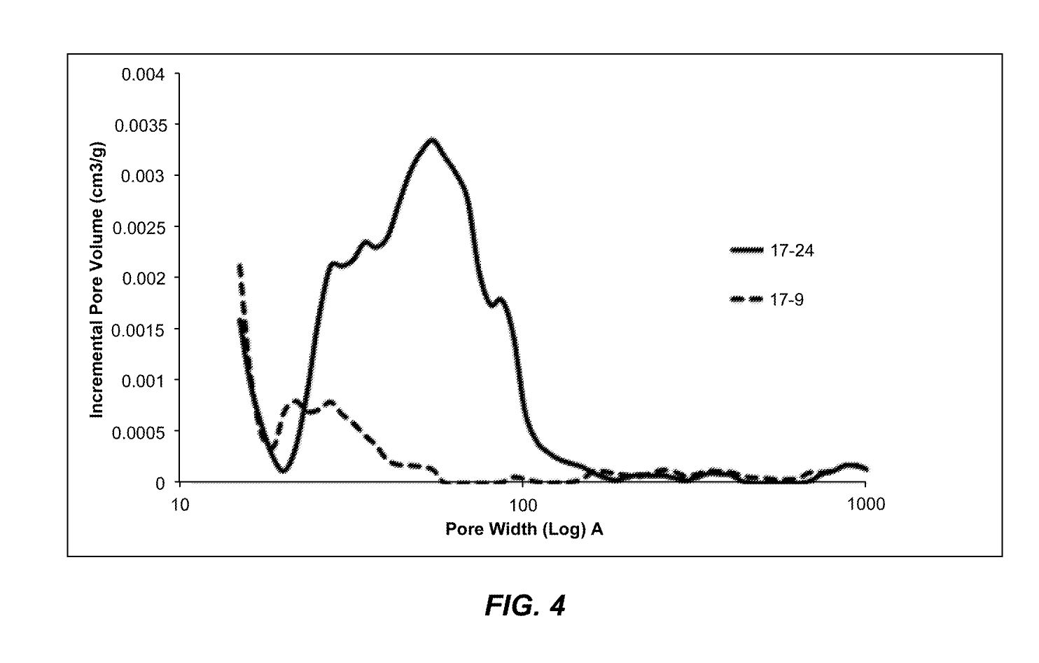

A comparison of the pore structure of two nitrogen-rich materials with resins prepared according to example 2 can be found in FIG. 4 (fast pyrolysis). Material 17-9 is a sample of pyrolyzed in a rotary kiln and material 17-21 is the same material formulation pyrolyzed in a tube furnace. The pyrolysis method (a static method with a gradual temperature ramp from room temperature to pyrolysis temperature) dramatically affects the mesopore structure of the material. The material with a gradual temperature ramp has a much larger mesopore volume than the pore structure pyrolyzed in a rotary kiln. The sample from the rotary kiln still has a significant surface area of 554 m²/g, but most of the mesopore volume collapses with the rapid temperature ramping of a rotary kiln pyrolysis.

### Example 27

### Effect of Pyrolysis Temperature on Nitrogen-Rich Pyrolyzed Carbon Material from Nitrogen-Rich Polymer Gel

Pyrolysis temperature also has a striking effect on the properties of the nitrogen-rich carbon materials. A dramatic effect is observed for the both the nitrogen content and charge acceptance values of these materials (charge acceptance method described in example 20 and elemental analysis described in example 25).

Table 3 displays a variety of nitrogen-rich carbon materials all prepared by the method described in example 2. The ratio of carbon to nitrogen in the pyrolyzed carbon materials ranged from 3:1 to 7:1, and decreases with increasing pyrolysis temperature. This effect is expected, as with higher pyrolysis temperatures, more of the nitrogen functionality is removed from the final carbon species.

The effect that the pyrolysis temperature (and presumably the nitrogen content) on the charge acceptance values is striking and unexpected. There is a robust and dramatic trend among several different sample sets. When the same nitrogen-rich melamine-formaldehyde-resorcinol gel is pyrolyzed at a low temperature (e.g. 750° C.), its charge acceptance value is 25%-30% higher than those pyrolyzed at a high temperature (e.g. 900° C.). While no significant changes in pore structure (including pore volume and surface area) were observed in this change in pyrolysis temperature, the charge acceptance figures changed significantly.

Table 3 contains several different samples demonstrating this trend. Samples containing the same number after the 3-indicate samples that have been prepared from the exact same nitrogen-rich polymer gel material and have been pyrolyzed using the same technique, just at different pyrolysis temperatures.

TABLE 3

| | | | | Specific | | |
|---|---|---|---|---|---|---|
| | | | | Surface | Pore | Charge |
| | PC | PC | C:N | Area | Volume | Acceptance |
| Sample | Temperature | Yield | Ratio | (m2/g) | (cm3/g) | (/hr) |
| 3-1A | 700 | 21% | 3.6 | 280 | 0.159 | 0.317 |
| 3-1B | 750 | 20% | 3.2 | NA | NA | 0.313 |
| 3-1C | 770 | 19% | 4.4 | 384 | 0.208 | 0.323 |
| 3-1D | 820 | 18% | NA | NA | NA | 0.315 |
| 3-1E | 870 | 18% | 4.5 | NA | NA | 0.303 |
| 3-1F | 950 | 17% | 6.5 | 208 | 0.113 | 0.243 |
| 3-2A | 900 | 19% | NA | 723 | 0.44 | 0.233 |
| 3-2B | 750 | 21% | NA | 595 | 0.35 | 0.326 |
| 3-3A | 900 | NA | NA | 303 | 0.17 | 0.265 |
| 3-3B | 750 | NA | NA | 410 | 0.23 | 0.362 |
| 3-4A | 900 | NA | NA | 504 | 0.29 | 0.233 |
| 3-4B | 750 | NA | NA | 467 | 0.26 | 0.332 |

### Example 28

### Effect of Pluronic F127 Additive on the Physical Properties of Nitrogen-Rich Pyrolyzed Carbon Materials from Nitrogen-Rich Polymer Gel

Finally, material 17-22 was prepared from melamine formaldehyde, resorcinol and pluronic F127 and pyrolyzed in a static tube furnace. It is notable that sample 17-22 has significantly higher pore volume in a mesopore region. This was seen consistently with samples containing the pluronic F127 additive.

### Example 29

### Effect of Pyrolysis Temperature on the Previous Art

Dried polymer gel prepared according to Example 1 was pyrolyzed in a static kiln at 750° C. with a nitrogen gas flow of 200 L/h. In other embodiments, the pyrolysis temperature was varied from 750° C.-950° C. The weight loss upon pyrolysis was about 60-70%.

The surface area of the pyrolyzed dried polymer gel was examined by nitrogen surface analysis using a surface area and porosity analyzer. The measured specific surface area using the standard BET approach was in the range of about 500-700 m²/g.

### Example 30

### Performance of Device with Lead Acid Electrode and Low-Gassing Carbon-Containing Electrode: New Metric of Charge Acceptance Per Unit of Gassing Current

In this embodiment, the data obtained as described in example 10 and example 13 are combined to create a new metric: charge acceptance per unit of gassing current. The charge acceptance (in Amps) is divided by the average gassing current (in Amp hours) at 2.65V. This metric, charge acceptance per unit gassing, is indicative of the overall performance of the carbon. A high number indicates a small quantity of gas generation for the low-gassing carbon and a large value for charge acceptance, both key indicators of cycle life in lead acid batteries. An example comparison of two carbons, a commercially available carbon black and a specialty, high surface area carbon (taken from Table 2 in example 17) is found in Table 3. The values obtained are for lead/carbon anode materials that are prepared according to examples 6 and 7.

TABLE 4
Characterization of various carbon
materials according to Example 18.

| | | | | Charge acceptance Per |
|---|---|---|---|---|
| | SSA | Total PV | Wt % | Unit Gassing Current |
| Carbon | (m2/g) | (cm3/g) | carbon | (A/Ah) |
| 17-1 | 705 | 0.57 | 0.2% | 8.50 |
| Commercial | 62 | 0.225 | 0.2% | 11.4 |
| Carbon Black | | | | |

### Example 31

### Preparation of Airbrush Electrodes Containing a Low-Gassing Carbon on Lead Substrates

Low-gassing carbon electrodes can be fabricated onto lead substrate using an airbrush to nebulize and spray low-viscosity carbon inks. The ink is fabricated with 80% low-gassing carbon, 10% conductivity-enhancing carbon black, and 10% aqueous binder solution by mass. The binder solution is a 4:1 mass ratio of 4 parts styrene butadiene rubber (SBR) to 1 part carboxymethyl cellulose (CMC). At 1.0 g scale, the binder solution is diluted in water to produce the desired viscosity (e.g. 3.25 mL water/100 mg binder, 3.5 mL water/100 mg binder, etc.). 100 mg of carbon black and 800 mg of low-gassing carbon are mixed into the binder solution to create a homogenous ink.

To improve electrode adhesion, the lead substrate's surface is roughened with sandpaper. During carbon ink application, the lead substrate is heated to 100° C. and the electrode size and shape is controlled by tape stenciling. The stencil is removed prior to curing the electrode at 110° C. for 30 minutes. Final electrode masses were measured to be 1.0±0.1 mg. Low-gassing carbon electrodes are cooled to room temperature before testing measurements are conducted.

To more accurately test the hydrogen gassing in a lead-carbon battery, this technique magnifies the carbon loading with respect to active lead mass while maintaining similar working conditions to a lead-carbon battery. The use of an airbrush allows for precise size and shape control during electrode application to ensure reproducible electrode production. Other known gassing metrics are less similar to a lead-carbon battery's working conditions and are more time consuming processes to complete.

### Example 32

### Performance of Low-Gassing Carbon Materials: Gassing of Airbrushed Electrodes Measured Via Cyclic Voltammetry

In this embodiment, the airbrush low-gassing carbon electrode as described previously is placed into a 3-electrode Teflon test cell, as known in the art, with a platinum wire counter electrode, a Hg|Hg₂SO₄ reference electrode, and 1 mL of 1.27 s.g. H₂SO₄ electrolyte. A cyclic voltammetry sweep is performed from −0.6V to −1.6V at 20 mV/second and the current is recorded every 0.15 seconds. This current gives a relative measurement of gassing for different carbons as a function of electrode mass, for which all electrodes tested are 1.0±0.1 mg. The gassing value can be reported at any voltage, but unless otherwise stated, the relative amount refers to the current at −1.6V. When the low-gassing carbon described herein is employed, the gassing current is significantly reduced from previously described carbon systems.

### Example 33

### Doping of Previous Art with Beneficial Elements to Reduce Gassing

Pyrolyzed and activated carbon materials as described in the previous art (and examples 5 and 9) can be doped with elements determined to be beneficial for reducing gassing on the carbon materials. Such elements can include, but are not limited to, Bi, Cd, Ge, Sn, Zn, Ag, Pb, In. An aqueous salt of each material (e.g. ZnSO₄) is dissolved in water to form a solution (between 50:50 and 5:95 salt:water). The carbon is them immersed in the salt mixture and left overnight in order to absorb as much salt as possible in to the high surface area structure (5:1 water:carbon ratio). Following an overnight soak, the material was filtered through a Buchner funnel. It was then placed in an oven at 110 C to dry overnight. The final material was re-pyrolzed according to example 5.

### Example 34

### Measurement of Weight Loss of Nitrogen-Containing Polymer Gel and Dry Polymer Gel (Non-Nitrogen Containing)

Thermogravimetric analysis (TGA) was conducted as known in the art using nitrogen gas as the carrier.

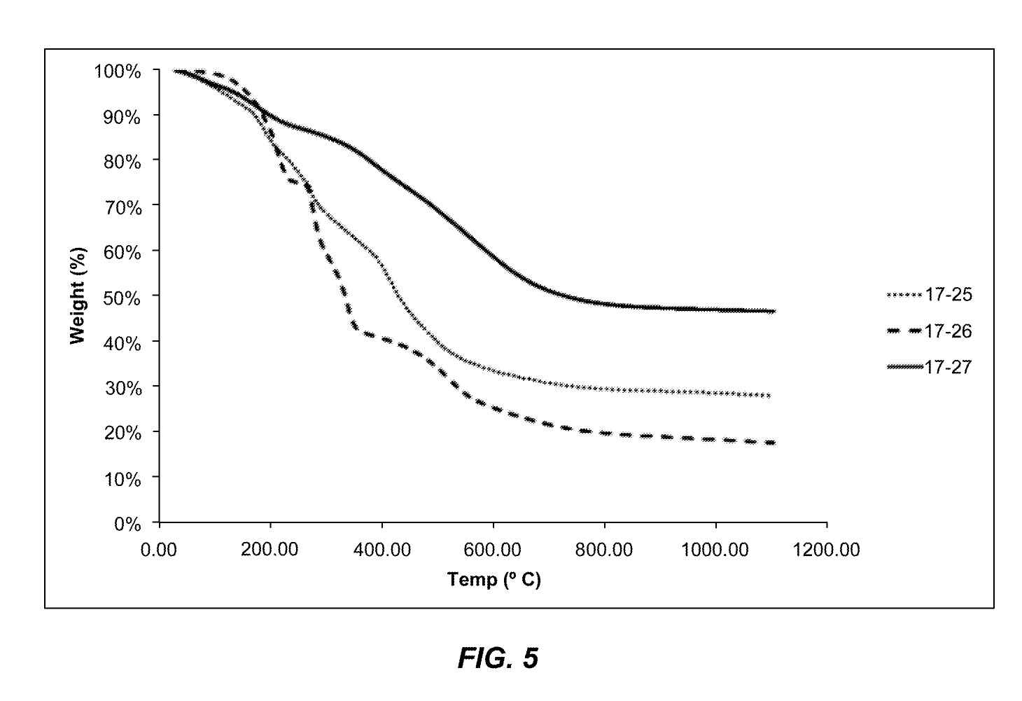

FIG. 5 (TGA of resins) compares several different polymer gel materials. Sample 17-27 is a non-nitrogen containing dried gel prepared according to example 1. Sample 17-25 is a nitrogen-containing resin with a urea-formaldehyde starting material and 17-26 is a nitrogen-containing resin with melamine formaldehyde as the starting material.

### Example 35

### The Effect of Particle Size on Carbon Gassing as Measured by Cyclic Voltammetry

According to example 32, cyclic voltammetry was performed on four carbon slurries. One material (17-10) was used as micronized material without any further manipulation (e.g. sieving), while the another material (17-23) was passed through a 212 um sieve in order to remove particles with a diameter too large to fit through the sieve. Both of these materials had a Dv,50 of 57.3 microns. Material 17-1 has a smaller particle size with a Dv,50 of 6.2 microns. Material 17-20 has an intermediate particle size of Dv,50 of 33.7 microns.

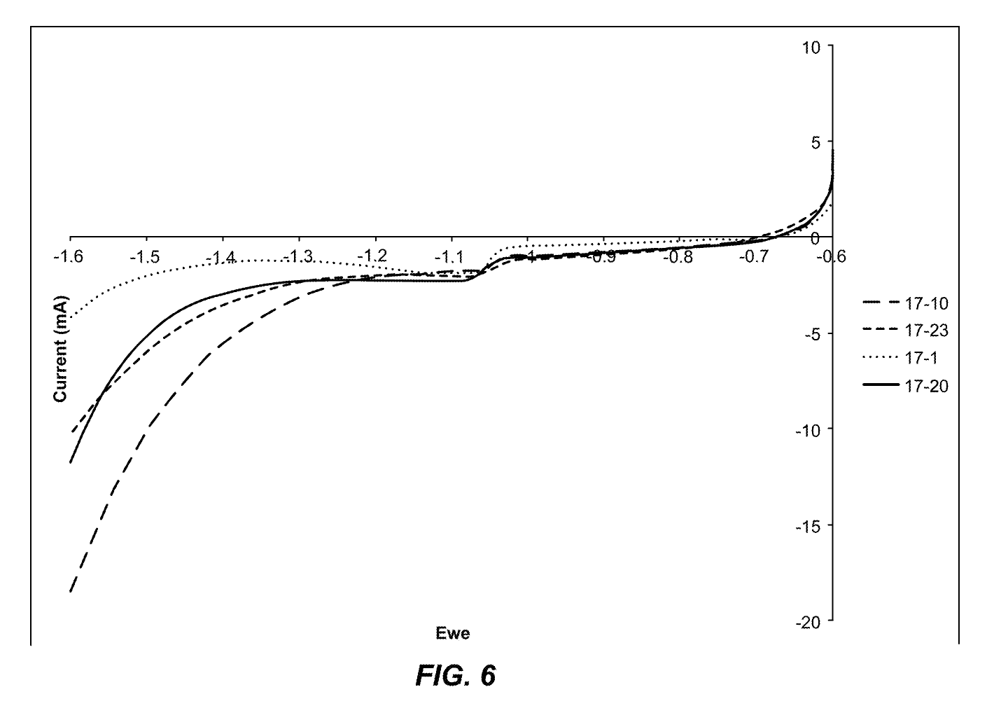

When analyzing cyclic voltammetry scans performed accord to example 32, there are various metrics to determine the extent of gassing. An exemplary metric is a measure of the current at −1.6V, the most negative potential measured in this method. All electrodes presented herein are 1 mg (as described in example 31), and therefore all scans are normalized to electrode mass. The measure of the mA of current produced at −1.6V is designated as the “gassing current.” In FIG. 6, for example, the gassing current for materials 17-1 at −1.6 V is −4.2 mA, while material 17-23 has a current of −10.3 mA at −1.6 V. From this measure we can presume material 17-23 exhibits higher gassing than material 17-1.

An additional exemplary metric to measure the extent of gassing in a cyclic voltammetry scan on an airbrush electrode as previously described in this document is to measure several current ratios at specified voltages. For each scan, the current is measured at −1.6 V, −1.4 V, and −1.2 V, which are defined as I_{1.6}, I_{1.4}, and I_{1.2}. The ratio of I_{1.6}:I_{1.4}, I_{1.6}:I_{1.2}, and I_{1.4}:I_{1.2} is calculated for each material. A material that exhibits no hydrogen gassing would have all ratios approaching unity within this metric. For example, in FIG. 6, material 17-1 has I_{1.2}=−1.5 mA, I_{1.4}=−1.4 mA, and I_{1.6}=−4.2 mA. The ratio of I_{1.6}:I_{1.4}=3.0, I_{1.6}:I_{1.2}=2.8, and I_{1.4}:I_{1.2}=0.9. For material 17-23, I_{1.2}=−2.0 mA, I_{1.4}=−3.6 mA, and I_{1.6}=−10.3 mA. The ratio of I_{1.6}:I_{1.4}=2.9, I_{1.6}:I_{1.2}=5.2, and I_{1.4}:I_{1.2}=1.8. Material 17-1 exhibits ratios closer to unity, which is generally associated with a lower gassing carbon.

Other size sieves can be envisioned as method for decreasing gassing (e.g removal of particles with higher gassing or particles that are not easily dispersed in to the lead electrode, as previously described). These sizes could be lower than 212 um, for example 25 um, 32 um, or 38 um. These sizes could be higher than 212 um, for example 425 um or 650 um. Besides sieving, other methods are known in the art to remove particles of a certain size regime, as described above, and these methods can be applied as an alternative to sieving.

### Example 36

### Surface Chemistry Analysis by Aqueous Carbon pH Measurement

The pH of an aqueous carbon solution provides information related to the surface chemistry of a carbon. 2.000 grams of carbon are suspended in 50 mL of water in a polypropylene cup. The solution is covered with parafilm and sonicated for 20 minutes at room temperature. The pH of the aqueous carbon solution is measured after stirring for 10 minutes using a pH electrode from Mettler Toledo (DG 11-SC probe and T70 KF Titrator) as known in the art.

### Example 37

### Surface Treatment of Pyrolyzed Carbon by Thermal Processing

The surface chemistry of the carbon, for example a pyrolyzed carbon, can be modulated by thermal processing at elevated temperature in the presence of various gases. The range of temperatures and species of gases is described elsewhere in this disclosure. Such surface treatments as known in the art are useful for modifying the non-carbon species, for example oxygen and nitrogen species. Exemplary nitrogen species in carbon include pyridinic, pyrydones, and oxcidic nitrogen species (Carbon 37, 1143-1150, 1999). Likewise, oxygen species are also known in the art.

### Example 38

### The Effect on Surface pH of the Gassing Properties of the Prior Art as Measured by Cyclic Voltammetry

The pH of the prior art was adjusted by a thermal treatment at under nitrogen at 900 C according to example 37. This treatment on the carbon increased the pH of the pyrolyzed carbon material as can be seen in table 17 (17-10 is the pyrolyzed carbon material and 17-23). Next, the surface pH of the same pyrolyzed carbon material was decreased by treating with sulfuric acid.

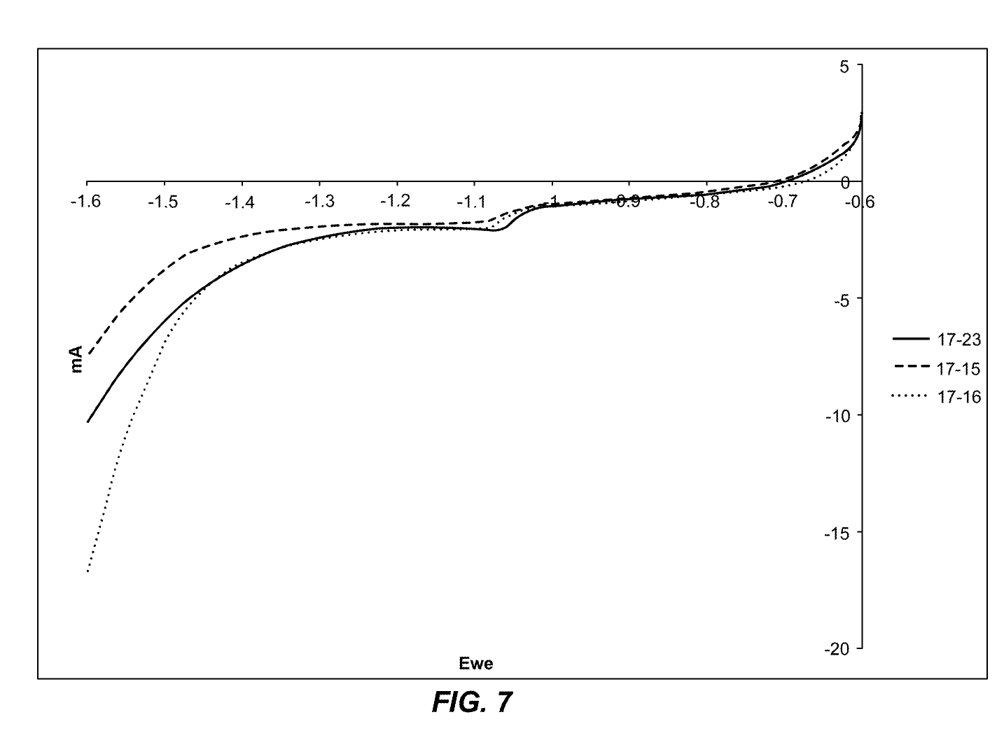

When tested via cyclic voltammetry according to example 32, a clear trend is observed as demonstrated in FIG. 7. Material 17-23 is an untreated pyrolyzed carbon. When treated with sulfuric acid (17-15), gassing decreases due to the lowering of the surface pH. Finally, when treating thermally to increase the pH (17-16), the gassing increases. Therefore, in non-nitrogen containing pyrolyzed carbons, a lower pH (i.e. below 7.5) is desirable for low-gassing carbons.

### Example 39

### A Comparison of the Gassing Properties of Prior Art and Carbons Prepared from Nitrogen-Containing Polymer Gels

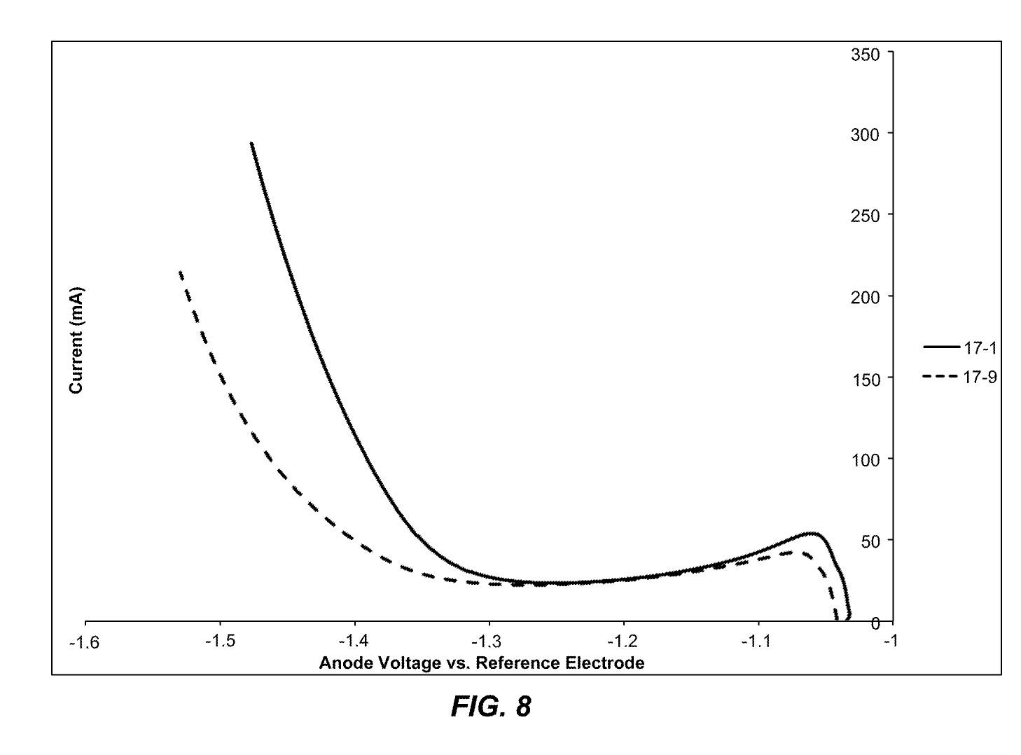

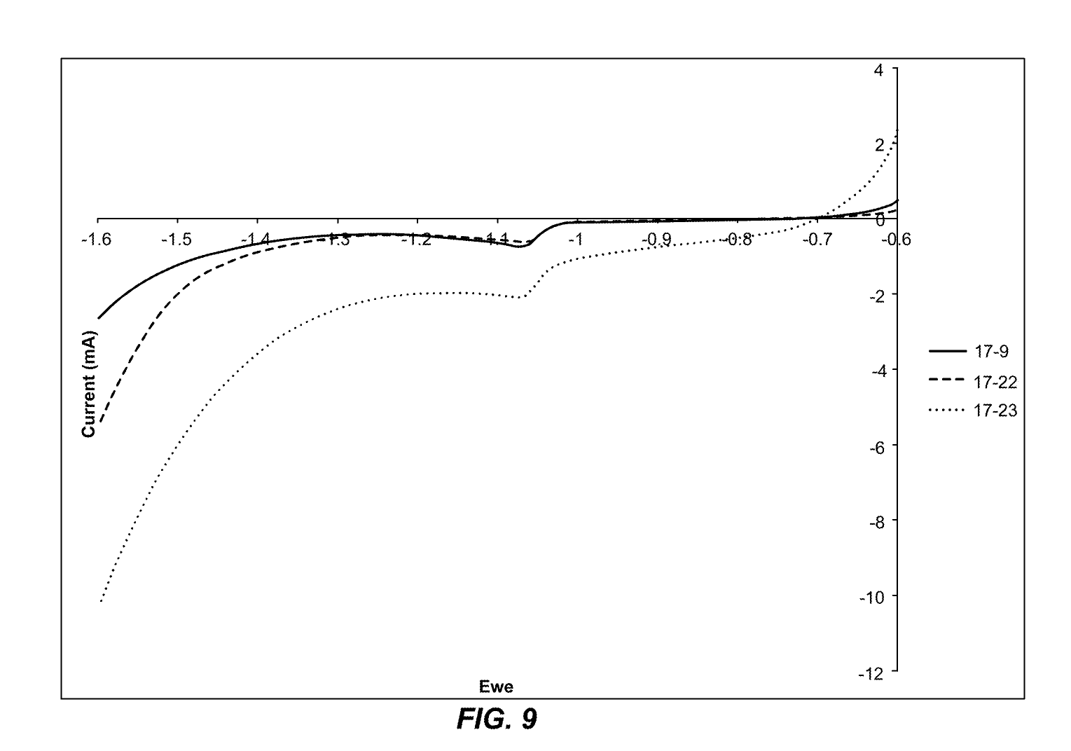

A dramatic and repeatable trend is observed when comparing the gassing behavior of the prior art as described in Example 1 (non-nitrogen containing pyrolyzed carbon) and carbons prepared from nitrogen-containing polymer gels as described in Examples 2 and 4. The gassing levels are measured by cyclic voltammetry in a 2V cell according to Example 15 and shown in FIG. 8. The prior art (17-23) displays a higher gassing current than the material prepared from nitrogen-containing polymer gel (17-9). The same effect was seen in cyclic voltammetry of the airbrushed electrodes tested according to Example 32. FIG. 9 shows the lowest gassing current for material 17-9 (nitrogen-containing gel prepared according to example 2 and pyrolyzed according to example 5). A slightly higher gassing current is observed for material 17-22, which was prepared according to example 4 and pyrolyzed according to example 7. And the non-nitrogen containing pyrolyzed carbon material (17-23) was higher than both of the carbons that contain nitrogen. All materials tested and prepared from nitrogen-rich polymer gel starting materials (examples 2 and 4) resulted in significantly lower gassing characteristics than any other material treatment tested.

### Example 40

### Effect on Gassing of Treating the Prior Art with Urea to Create a Nitrogen-Containing Carbon as Compared to the Gassing of Carbons Prepared from Nitrogen-Containing Polymer Gels

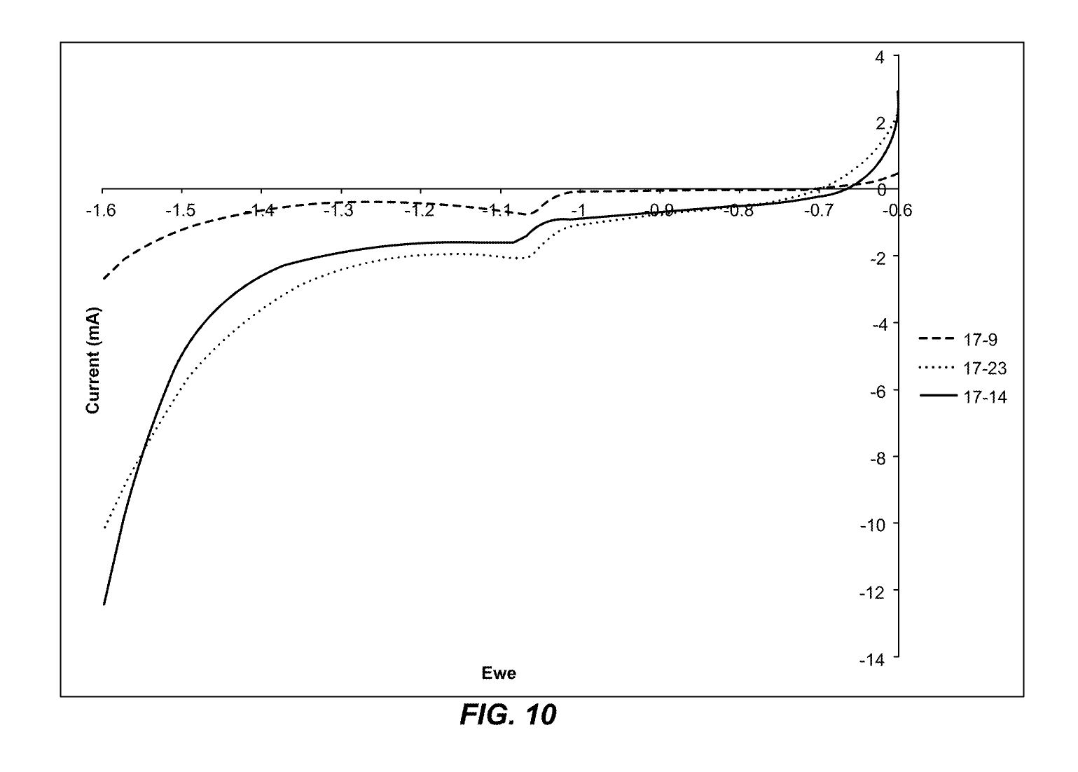

In an attempt to determine if the prior art can be treated with nitrogen surface functionality to achieve the same desirable result as observed with the materials prepared from nitrogen-containing polymer gels (displayed in FIG. 9), the prior art was treated with urea according to example 8. This sample was tested according to Example 32 to determine the gassing behavior. FIG. 10 displays the comparison between the prior art (17-23), a urea treatment of the prior art (17-14) and a sample prepared from a nitrogen-containing polymer gel (17-9). While there may be some effect from adding nitrogen functionality to the surface in reducing gassing in certain voltage regimes, the reduction in gassing does not approach the material made from the nitrogen-containing polymer gel. There is a clear, distinct effect of dramatic reduction in gassing behavior when a material is prepared from a nitrogen-containing polymer gel.

### Example 41

### Increased Gassing Properties when Increasing the pH of the Prior Art Via Treatment with a Peroxide Material

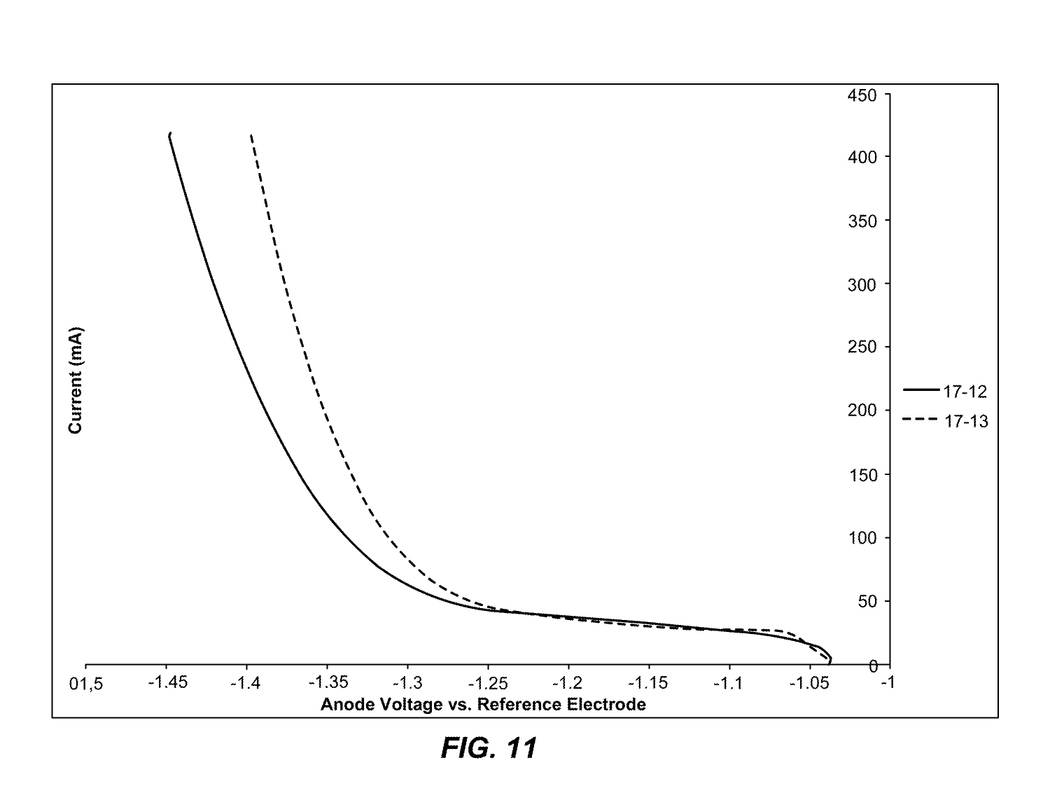

The surface functionality of the prior art was modified with the method described in Example 8, but instead of using urea or sulfuric acid, hydrogen peroxide was used. This change in surface functionality resulted in an increase in gassing current as demonstrated in FIG. 11. Material 17-12 is the untreated pyrolyzed carbon sample and 17-13 has been treated with peroxide.

### Example 42

### The Effect of Heat Treatment on Carbons Prepared from Nitrogen-Containing Polymer Gels

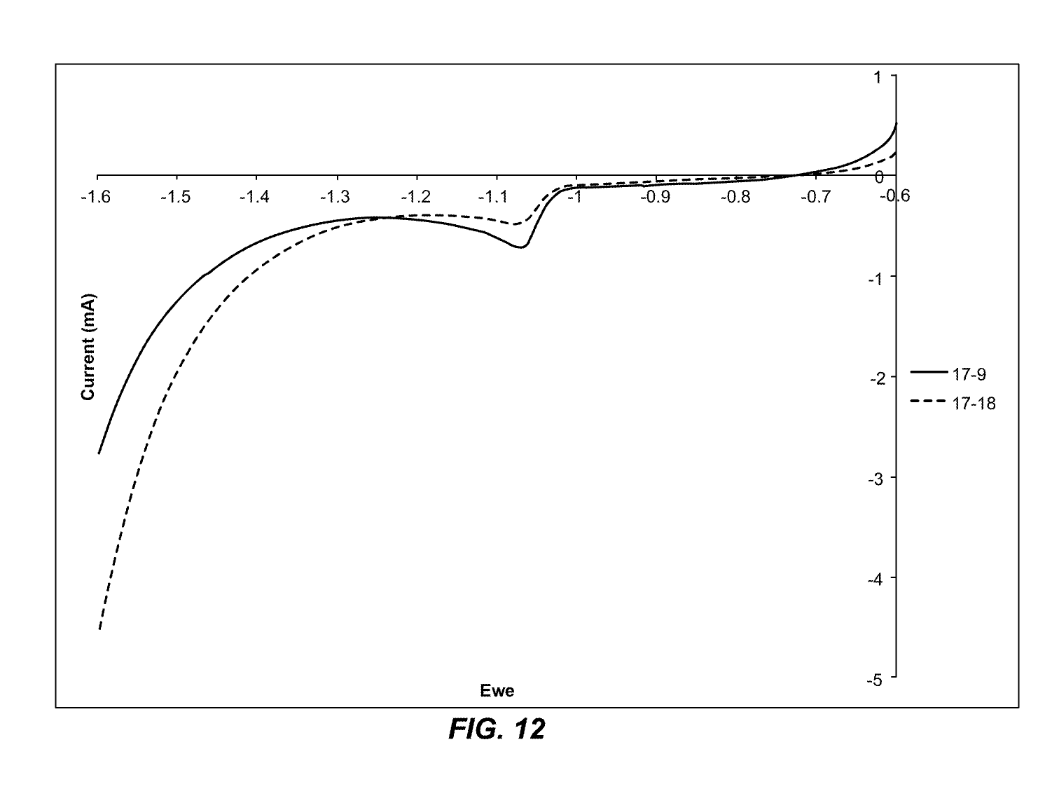

Pyrolyzed carbons prepared from nitrogen-rich polymer gels (example 2) were heat treated according to example 37. The effect on gas generation was similar to what was observed with the prior art (non nitrogen-containing carbons). FIG. 12 shows that material 17-18 (heat treated material) has higher gassing current than 17-9, which has not been heat-treated but contains nitrogen.

### Example 43

### The Effect of Chemical Treatment with Urea on Carbons Prepared from Nitrogen-Containing Polymer Gels

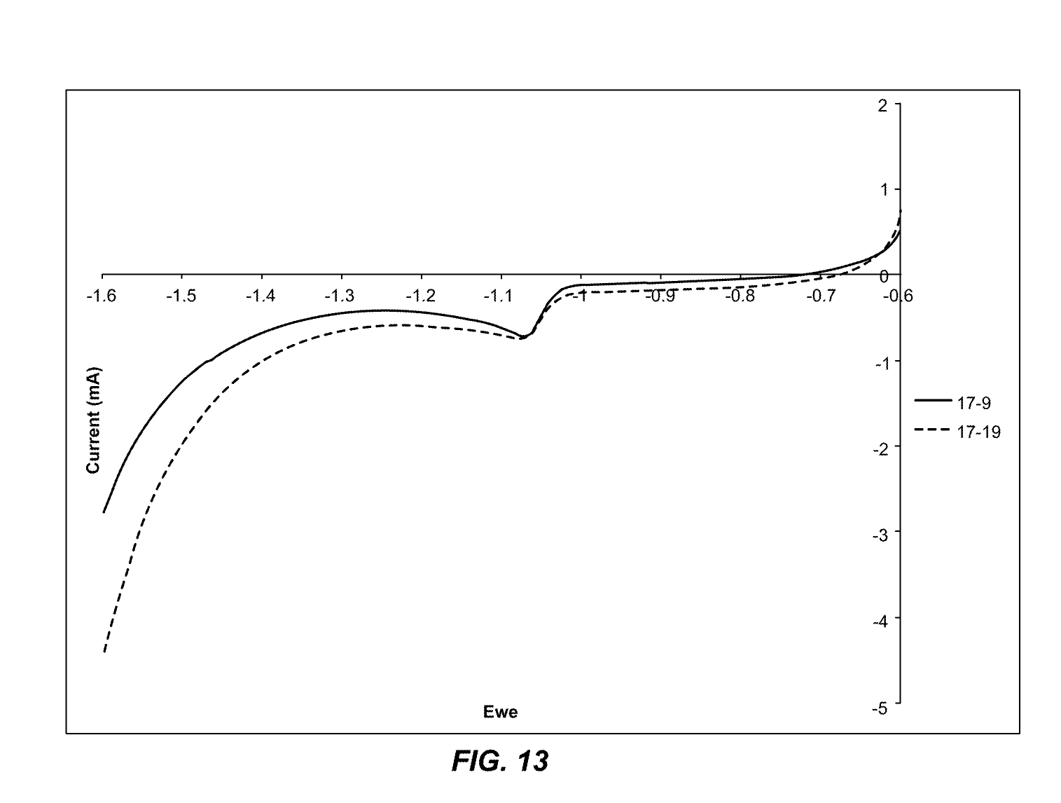

Upon treatment of a nitrogen-containing carbon with urea as described in example 8, the gassing current increases. FIG. 13 demonstrates that a sample treated with urea (17-19) has a higher gassing current than a material that has not had a urea treatment (17-9).

### Example 44

### Extent of Gassing as Determined by Analysis of Voltammogram and It's First and Second Derivatives

When analyzing cyclic voltammetry scans performed accord to example 32, there are various metrics to determine the extent of gassing. An exemplary metric is a measure of the current at −1.6V, the most negative potential measured in this method. All electrodes presented herein are 1 mg (as described in example 31), and therefore all scans are normalized to electrode mass. The measure of the mA of current produced at −1.6V is designated as the “gassing current.” In FIG. 6, for example, the gassing current for materials 17-1 at −1.6 V is −4.2 mA, while material 17-23 has a current of −10.3 mA at −1.6 V. From this measure we can presume material 17-23 exhibits higher gassing than material 17-1.

An additional exemplary metric to measure the extent of gassing in a cyclic voltammetry scan on an airbrush electrode as previously described in this document is to measure several current ratios at specified voltages. For each scan, the current is measured at −1.6 V, −1.4 V, and −1.2 V, which are defined as I_{1.6}, I_{1.4}, and I_{1.2}. The ratio of I_{1.6}:I_{1.4}, I_{1.6}:I_{1.2}, and I_{1.4}:I_{1.2} is calculated for each material. A material that exhibits no hydrogen gassing would have all ratios approaching unity within this metric. For example, in FIG. 6, material 17-1 has I_{1.2}=−1.5 mA, I_{1.4}=−1.4 mA, and I_{1.6}=−4.2 mA. The ratio of I_{1.6}:I_{1.4}=3.0, I_{1.6}:I_{1.2}=2.8, and I_{1.4}:I_{1.2}=0.9. For material 17-23, I_{1.2}=−2.0 mA, I_{1.4}=−3.6 mA, and I_{1.6}=−10.3 mA. The ratio of I_{1.6}:I₄=2.9, I_{1.6}:I_{1.2}=5.2, and I_{1.4}:I_{1.2}=1.8. Material 17-1 exhibits ratios closer to unity, which is generally associated with a lower gassing carbon.

An additional exemplary metric to measure the gassing in a cyclic voltammetry scan is to calculate the point of inflection as described by the second derivative of the line between −1.2 V and −1.6 V. A low gassing carbon exhibits a second derivative minimum closer to −1.6 V while having a low absolute value of that second derivative minimum. High gassing materials will have a point of inflection existing more positive and closer to −1.2 V with a high absolute value of that second derivative minimum.

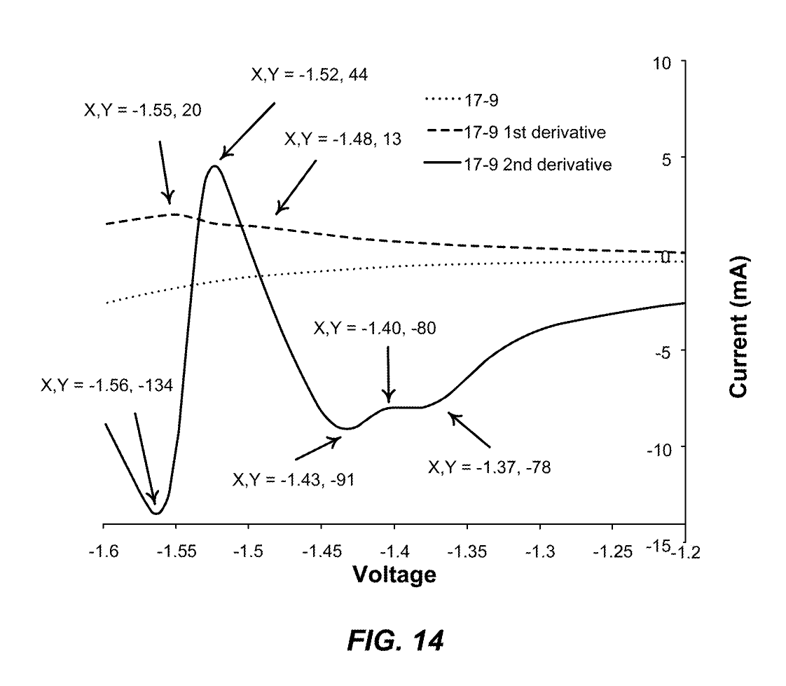

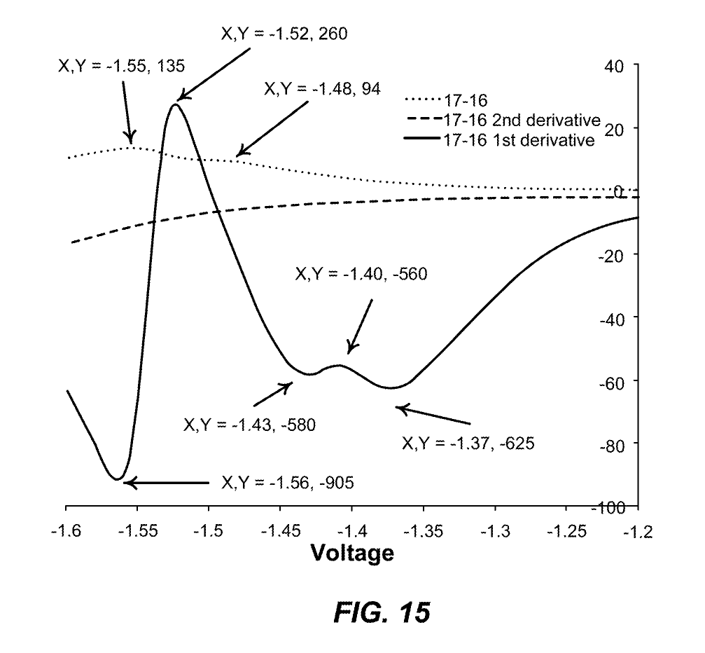

Alternatively, the voltammograms can be analyzed for their first and second derivatives. Local maxima and minima from these derivatives provide information regarding electrochemical events related to gassing. FIG. 14 presents the voltammogram along with its first and second derivates for material 17-9. The original cyclic voltammetry scan is represented by a dotted line, the first derivative of this scan is a light solid line, and the second derivative of this scan is a heavy solid line. Presented in the figure, the characteristic features are annotated along with the values of voltage, ((dV)/(d(mA/mg))) and ((d²V)/(d(mA/mg)²)) for the features derived from the first and second derivatives, respectively. FIG. 15 presents the voltammogram along with first and second derivates of material 17-23. Presented in the figure, the characteristic features are annotated along with the values of voltage, ((dV)/(d(mA/mg))), and ((d²V)/(d(mA/mg)²)) for the features derived from the first and second derivatives, respectively. As can be seen, both figures reveal events in the first and second derivatives occurring in the same location with respect to voltage. Without being bound by theory, the absolute values in terms of the first and second derivatives are linked to the extent of electrochemical events related to gassing. For instance, the maximum value of the first derivate of 17-9 and 17-23 occur at the same voltages (i.e. −1.55 V, −1.48 V), and the value of the maximum of material 17-23 is 6.75-fold greater than 17-9. Also, the maximum value of the second derivate of 17-9 and 17-23 occur at the same voltage (i.e. −1.52 V), and the value of the maximum of material 17-23 is 5.9-fold greater than 17-9. For comparison, the ratio of the current at −1.6 V from the voltammogram for these samples is 6.6-fold.

Without being by theory, the same approach, namely analysis of first and second derivatives of the voltammogram, can also be applied to other device formats, for example 2.0 V lead acid cells. Accordingly, for such devices, the information from the first and second derivatives of the voltammograms reflect electrochemical events related to the gassing of various carbon based materials in these other systems.

Exemplary embodiments of the invention include, but are not limited to, the following embodiments:

### Embodiment 1

A carbon material comprising less than an absolute value of 10 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 2

The carbon material of embodiment 1, comprising less than an absolute value of 5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 3

The carbon material of embodiment 1, comprising less than an absolute value of 3 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 4

The carbon material of embodiment 1, comprising less than an absolute value of 2.5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 5

The carbon material of embodiment 1, comprising less than an absolute value of 2 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 6

The carbon material of embodiment 1, comprising less than an absolute value of 1.5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 7

The carbon material of embodiment 1, comprising less than an absolute value of 1.0 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

### Embodiment 8

A carbon material producing less than 100 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 9

The carbon material of embodiment 8, wherein the carbon material produces less than 50 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 10

The carbon material of embodiment 8, wherein the carbon material produces less than 30 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 11

The carbon material of embodiment 8, wherein the carbon material produces less than 25 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 12

The carbon material of embodiment 8, wherein the carbon material produces less than 20 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 13

The carbon material of embodiment 8, wherein the carbon material produces less than 10 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 14

The carbon material of embodiment 8, wherein the carbon material produces less than 5 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

### Embodiment 15

A carbon material producing less than 200 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 16

The carbon material of embodiment 15, wherein the carbon material produces less than 100 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 17

The carbon material of embodiment 15, wherein the carbon material produces less than 50 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 18

The carbon material of embodiment 15, wherein the carbon material produces less than 40 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 19

The carbon material of embodiment 15, wherein the carbon material produces less than 20 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 20

The carbon material of embodiment 15, wherein the carbon material produces less than 10 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 21

The carbon material of embodiment 15, wherein the carbon material produces less than 5 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

### Embodiment 22

A carbon material producing less than 5:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 23

The carbon material of embodiment 22, wherein the carbon material produces less than 4:1 (mA/mg current at −1.6 V vs Hg/Hg2SO4): (mA/mg current at 1.2 V vs Hg/Hg₂SO₄) when tested by cyclic voltammetry as a working electrode on a substrate comprising lead and employing a platinum counter electrode in the presence of electrolyte comprising sulfuric acid.

### Embodiment 24

The carbon material of embodiment 22, wherein the carbon material produces less than 3:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 25

The carbon material of embodiment 22, wherein the carbon material produces less than 2:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 26

A carbon material producing between 0.75:1 to 1.25:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 27

The carbon material of embodiment 26, wherein the carbon material produces between 0.85:1 to 1.15:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 28

The carbon material of embodiment 26, wherein the carbon material produces between 0.9:1 to 1.1:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

### Embodiment 29

The carbon material of any one of embodiments 1-28, comprising at least 15% nitrogen by weight.

### Embodiment 30

The carbon material of any one of embodiments 1-29, comprising a BET specific surface area of at least 300 m²/g.

### Embodiment 31

A carbon material comprising at least 15% nitrogen by weight and a BET specific surface area of at least 300 m²/g.

### Embodiment 32

The carbon material of any one of embodiment 29-31, comprising between 15% and 30% nitrogen by weight.

### Embodiment 33

The carbon material of any one of embodiments 29-31, comprising up to 20% nitrogen by weight.

### Embodiment 34

The carbon material of any one of embodiments 29-31, comprising up to from 20% to 25% nitrogen by weight.

### Embodiment 35

The carbon materials of any one of embodiments 1-34, comprising less than 500 PPM of total impurities.

### Embodiment 36

The carbon material of embodiment 35, wherein the impurities are elements having an atomic number greater than 10.

### Embodiment 37

The carbon material of any one of embodiments 35 or 36, wherein the level of iron is less than 30 ppm iron, the level of copper is less than 30 ppm, less than 20 ppm nickel, less than 20 ppm manganese, and less then 10 ppm chlorine.

### Embodiment 38

The carbon material of any of embodiments 1-37, wherein the total surface area of the carbon material residing in pores less than 20 angstroms ranges from 20% to 60%.

### Embodiment 39

The carbon material of any one of embodiments 1-37, wherein the total surface area of the carbon material residing in pores less than 20 angstroms ranges from 40% to 60%.

### Embodiment 40

The carbon material of any one of embodiments 1-37, wherein the total surface area of the carbon material residing in pores greater than 20 angstroms ranges from 60% to 99%.

### Embodiment 41

The carbon material of any of embodiments 1-37, wherein the total surface area of the carbon material residing in pores less than 20 angstroms ranges from 80% to 95%.

### Embodiment 42

The carbon material of any one of embodiments 1-41, wherein the ash content of the carbon is less than 0.03%.

### Embodiment 43

The carbon material of any one of embodiments 1-41, wherein the ash content of the carbon is less than 0.01%.

### Embodiment 44

The carbon material of any one of embodiments 1-43, wherein the carbon material comprises a pyrolyzed polymer cryogel.

### Embodiment 45

The carbon material of any one embodiments 1-43, wherein the carbon material comprises a pyrolzyed and activated polymer cryogel.

### Embodiment 46

The carbon material of any one of embodiments 1-43, wherein the carbon material comprises a pyrolyzed polymer.

### Embodiment 47

The carbon material of any one of embodiments 1-43, wherein the carbon material comprises a pyrolyzed and activated polymer.

### Embodiment 48

The carbon material of embodiment 1-47, wherein the carbon material comprises a BET specific surface area of at least 1000 m²/g.

### Embodiment 49

The carbon material of embodiment 48, wherein the carbon material comprises a BET specific surface area of at least 1500 m²/g.

### Embodiment 50

The carbon material of any one of embodiments 1-49, wherein the carbon material comprises a total pore volume between 0.1 to 0.3 cc/g.

### Embodiment 51

The carbon material of any one of embodiments 1-49, wherein the carbon material comprises a total pore volume between 0.3 to 0.5 cc/g.

### Embodiment 52

The carbon material of any one of embodiments 1-49, wherein the carbon material comprises a total pore volume between 0.5 to 0.7 cc/g.

### Embodiment 53

The carbon material of any one of embodiments 1-49, wherein the carbon material comprises a total pore volume between 0.7 to 1.0 cc/g.

### Embodiment 54

The carbon material of any one of embodiments 1-53, wherein the carbon material comprises a water absorption of greater than 0.6 g H₂O/cc of pore volume in the carbon material.

### Embodiment 55

The carbon material of any one of embodiments 1-53, wherein the carbon material comprises a water absorption of greater than 1.0 g H₂O/cc of pore volume in the carbon material.

### Embodiment 56

The carbon material of any one of embodiments 1-53, wherein the carbon material comprises a water absorption of greater than 2.0 g

H₂O/cc of pore volume in the carbon material.

### Embodiment 57

The carbon material of any one of embodiments 1-56, wherein the carbon material comprises a pore volume ranging from 0.4 cc/g to 1.4 cc/g and an R factor of 0.2 or less at relative humidities ranging from about 10% to 100%.

### Embodiment 58

The carbon material of embodiment 57, wherein the carbon material comprises an R factor of 0.6 or less.

### Embodiment 59

The carbon material of any one of embodiments 57 or 58, wherein the carbon material comprises a pore volume ranging from 0.6 cc/g to 1.2 cc/g.

### Embodiment 60

The carbon material of any one of embodiments 1-59, wherein the carbon material has a pH less than 7.5.

### Embodiment 61

The carbon material of any one of embodiments 1-59, wherein the carbon material has a pH between pH 3.0 and 7.5.

### Embodiment 62

The carbon material of any one of embodiments 1-59, wherein the carbon material has a pH between pH 5.0 and 7.0.

### Embodiment 63

The carbon material of any one of embodiments 1-62, comprising a Dv, 50 between 1.0 and 10.0 um.

### Embodiment 64

The carbon material of any one of embodiments 1-62, comprising a Dv, 50 between 10.0 and 20.0 um.

### Embodiment 65

The carbon material of any one of embodiments 1-62, comprising a Dv, 50 between 20.0 and 50.0 um.

### Embodiment 66

The carbon material of any one of embodiments 1-62, comprising a Dv, 50 between 40.0 and 80.0 um.

### Embodiment 67

The carbon material of any one of embodiments 1-66, wherein the carbon material comprises more than 85% micropores, less than 15% mesopores, and less than 1% macropores.

### Embodiment 68

The carbon material of any one of embodiments 1-66, wherein the carbon material comprises less than 50% micropores, more than 50% mesopores, and less than 0.1% macropores.

### Embodiment 69

The carbon material of any one of embodiments 1-66, wherein the carbon material comprises less than 30% micropores and greater than 70% mesopores.

### Embodiment 70

An electrical energy storage device comprising a carbon material according to any one of embodiments 1-69.

### Embodiment 71

The device of embodiment 70, wherein the device is a battery comprising:

a) at least one positive electrode comprising a first active material in electrical contact with a first current collector;

b) at least one negative electrode comprising a second active material in electrical contact with a second current collector; and

c) an electrolyte;

wherein the positive electrode and the negative electrode are separated by an inert porous separator, and wherein at least one of the first or second active materials comprises a carbon material according to any one of embodiments 1-69.

### Embodiment 72

The device of embodiment 71, where the carbon material comprises 0.1 to 2% of the negative electrode.

### Embodiment 73

The device of embodiment 71, where the carbon material comprises 0.2 to 1% of the negative electrode.

### Embodiment 74

The device of embodiment 71, where the carbon material comprises 0.3 to 0.7% of the negative electrode.

### Embodiment 75

The device of any one of embodiments 71-72, wherein the electrolyte comprises sulfuric acid and water.

### Embodiment 76

The device of any one of embodiments 71-74, wherein the electrolyte comprises silica gel.

### Embodiment 77

The device of any of embodiments 71-76, wherein at least one electrode further comprises an expander.

### Embodiment 78

Use of the carbon material of any one of embodiments 1-69 in an electrical energy storage device.

### Embodiment 79

The use of embodiment 78, wherein the electrical energy storage device is a battery.

### Embodiment 80

The use of embodiment 78 or 79 or the device of any one of embodiments 70-78, wherein the electrical energy storage device is in a microhybrid, start-stop hybrid, mild-hybrid vehicle, vehicle with electric turbocharging, vehicle with regenerative braking, hybrid vehicle, an electric vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system.

### Embodiment 81

Use of a device comprising the carbon material of any one of embodiments 1-69 for storage and distribution of electrical energy.

### Embodiment 82

The use of embodiment 81, wherein the device is a battery.

### Embodiment 83

The use of any one of embodiments 81 or 82, wherein the device is in a microhybrid, start-stop hybrid, mild-hybrid vehicle, vehicle with electric turbocharging, vehicle with regenerative braking, hybrid vehicle, an electric vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including U.S. Provisional App. No. 62/242,181, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A carbon material comprising less than an absolute value of 10 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

2. The carbon material of claim 1, comprising less than an absolute value of 5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

3. The carbon material of claim 1, comprising less than an absolute value of 3 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

4. The carbon material of claim 1, comprising less than an absolute value of 2.5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

5. The carbon material of claim 1, comprising less than an absolute value of 2 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

6. The carbon material of claim 1, comprising less than an absolute value of 1.5 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

7. The carbon material of claim 1, comprising less than an absolute value of 1.0 mA/mg current at −1.6 V vs Hg/Hg₂SO₄ when tested by cyclic voltammetry as a working electrode on a substrate comprising lead and employing a platinum counter electrode in the presence of electrolyte comprising sulfuric acid.

8. A carbon material producing less than 100 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

9. The carbon material of claim 8, wherein the carbon material produces less than 50 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

10. The carbon material of claim 8, wherein the carbon material produces less than 30 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

11. The carbon material of claim 8, wherein the carbon material produces less than 25 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

12. The carbon material of claim 8, wherein the carbon material produces less than 20 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

13. The carbon material of claim 8, wherein the carbon material produces less than 10 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

14. The carbon material of claim 8, wherein the carbon material produces less than 5 (mA/mg)/(V) at −1.55 V vs Hg/Hg₂SO₄ when tested by cyclic voltammetry as a working electrode on a substrate comprising lead and employing a platinum counter electrode in the presence of electrolyte comprising sulfuric acid.

15. A carbon material producing less than 200 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

16. The carbon material of claim 15, wherein the carbon material produces less than 100 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

17. The carbon material of claim 15, wherein the carbon material produces less than 50 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

18. The carbon material of claim 15, wherein the carbon material produces less than 40 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

19. The carbon material of claim 15, wherein the carbon material produces less than 20 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

20. The carbon material of claim 15, wherein the carbon material produces less than 10 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

21. The carbon material of claim 15, wherein the carbon material produces less than 5 (mA/mg)²/(V) at −1.52 V vs Hg/Hg₂SO₄ when tested by cyclic voltammetry as a working electrode on a substrate comprising lead and employing a platinum counter electrode in the presence of electrolyte comprising sulfuric acid.

22. A carbon material producing less than 5:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

23. The carbon material of claim 22, wherein the carbon material produces less than 4:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

24. The carbon material of claim 22, wherein the carbon material produces less than 3:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

25. The carbon material of claim 22, wherein the carbon material produces less than 2:1 (mA/mg current at −1.6 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

26. A carbon material producing between 0.75:1 to 1.25:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

27. The carbon material of claim 26, wherein the carbon material produces between 0.85:1 to 1.15:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

28. The carbon material of claim 26, wherein the carbon material produces between 0.9:1 to 1.1:1 (mA/mg current at −1.4 V vs Hg/Hg2SO4): (mA/mg current at 1.2 V vs Hg/Hg2SO4) when tested by cyclic voltammetry as a working electrode on a substrate comprising lead and employing a platinum counter electrode in the presence of electrolyte comprising sulfuric acid.

29. The carbon material of any one of claims 1-28, comprising at least 15% nitrogen by weight.

30. The carbon material of any one of claims 1-29, comprising a BET specific surface area of at least 300 m²/g.

31. A carbon material comprising at least 15% nitrogen by weight and a BET specific surface area of at least 300 m²/g.

32. The carbon material of any one of claim 29-31, comprising between 15% and 30% nitrogen by weight.

33. The carbon material of any one of claims 29-31, comprising up to 20% nitrogen by weight.

34. The carbon material of any one of claims 29-31, comprising up to from 20% to 25% nitrogen by weight.

35. The carbon materials of any one of claims 1-34, comprising less than 500 PPM of total impurities.

36. The carbon material of claim 35, wherein the impurities are elements having an atomic number greater than 10.

37. The carbon material of any one of claim 35 or 36, wherein the level of iron is less than 30 ppm iron, the level of copper is less than 30 ppm, less than 20 ppm nickel, less than 20 ppm manganese, and less then 10 ppm chlorine.

38. The carbon material of any of claims 1-37, wherein the total surface area of the carbon material residing in pores less than 20 angstroms ranges from 20% to 60%.

39. The carbon material of any one of claims 1-37, wherein the total surface area of the carbon material residing in pores less than 20 angstroms ranges from 40% to 60%.

40. The carbon material of any one of claims 1-37, wherein the total surface area of the carbon material residing in pores greater than 20 angstroms ranges from 60% to 99%.

41. The carbon material of any of claims 1-37, wherein the total surface area of the carbon material residing in pores less than 20 angstroms ranges from 80% to 95%.

42. The carbon material of any one of claims 1-41, wherein the ash content of the carbon is less than 0.03%.

43. The carbon material of any one of claims 1-41, wherein the ash content of the carbon is less than 0.01%.

44. The carbon material of any one of claims 1-43, wherein the carbon material comprises a pyrolyzed polymer cryogel.

45. The carbon material of any one claims 1-43, wherein the carbon material comprises a pyrolzyed and activated polymer cryogel.

46. The carbon material of any one of claims 1-43, wherein the carbon material comprises a pyrolyzed polymer.

47. The carbon material of any one of claims 1-43, wherein the carbon material comprises a pyrolyzed and activated polymer.

48. The carbon material of claim 1-47, wherein the carbon material comprises a BET specific surface area of at least 1000 m²/g.

49. The carbon material of claim 48, wherein the carbon material comprises a BET specific surface area of at least 1500 m²/g.

50. The carbon material of any one of claims 1-49, wherein the carbon material comprises a total pore volume between 0.1 to 0.3 cc/g.

51. The carbon material of any one of claims 1-49, wherein the carbon material comprises a total pore volume between 0.3 to 0.5 cc/g.

52. The carbon material of any one of claims 1-49, wherein the carbon material comprises a total pore volume between 0.5 to 0.7 cc/g.

53. The carbon material of any one of claims 1-49, wherein the carbon material comprises a total pore volume between 0.7 to 1.0 cc/g.

54. The carbon material of any one of claims 1-53, wherein the carbon material comprises a water absorption of greater than 0.6 g H₂O/cc of pore volume in the carbon material.

55. The carbon material of any one of claims 1-53, wherein the carbon material comprises a water absorption of greater than 1.0 g H₂O/cc of pore volume in the carbon material.

56. The carbon material of any one of claims 1-53, wherein the carbon material comprises a water absorption of greater than 2.0 g H₂O/cc of pore volume in the carbon material.

57. The carbon material of any one of claims 1-56, wherein the carbon material comprises a pore volume ranging from 0.4 cc/g to 1.4 cc/g and an R factor of 0.2 or less at relative humidities ranging from about 10% to 100%.

58. The carbon material of claim 57, wherein the carbon material comprises an R factor of 0.6 or less.

59. The carbon material of any one of claim 57 or 58, wherein the carbon material comprises a pore volume ranging from 0.6 cc/g to 1.2 cc/g.

60. The carbon material of any one of claims 1-59, wherein the carbon material has a pH less than 7.5.

61. The carbon material of any one of claims 1-59, wherein the carbon material has a pH between pH 3.0 and 7.5.

62. The carbon material of any one of claims 1-59, wherein the carbon material has a pH between pH 5.0 and 7.0.

63. The carbon material of any one of claims 1-62, comprising a Dv, 50 between 1.0 and 10.0 um.

64. The carbon material of any one of claims 1-62, comprising a Dv, 50 between 10.0 and 20.0 um.

65. The carbon material of any one of claims 1-62, comprising a Dv, 50 between 20.0 and 50.0 um.

66. The carbon material of any one of claims 1-62, comprising a Dv, 50 between 40.0 and 80.0 um.

67. The carbon material of any one of claims 1-66, wherein the carbon material comprises more than 85% micropores, less than 15% mesopores, and less than 1% macropores.

68. The carbon material of any one of claims 1-66, wherein the carbon material comprises less than 50% micropores, more than 50% mesopores, and less than 0.1% macropores.

69. The carbon material of any one of claims 1-66, wherein the carbon material comprises less than 30% micropores and greater than 70% mesopores.

70. An electrical energy storage device comprising a carbon material according to any one of claims 1-69.

71. The device of claim 70, wherein the device is a battery comprising:
a) at least one positive electrode comprising a first active material in electrical contact with a first current collector;
b) at least one negative electrode comprising a second active material in electrical contact with a second current collector; and
c) an electrolyte;
wherein the positive electrode and the negative electrode are separated by an inert porous separator, and wherein at least one of the first or second active materials comprises a carbon material according to any one of claims 1-69.

72. The device of claim 71, where the carbon material comprises 0.1 to 2% of the negative electrode.

73. The device of claim 71, where the carbon material comprises 0.2 to 1% of the negative electrode.

74. The device of claim 71, where the carbon material comprises 0.3 to 0.7% of the negative electrode.

75. The device of any one of claims 71-72, wherein the electrolyte comprises sulfuric acid and water.

76. The device of any one of claims 71-74, wherein the electrolyte comprises silica gel.

77. The device of any of claims 71-76, wherein at least one electrode further comprises an expander.

78. Use of the carbon material of any one of claims 1-69 in an electrical energy storage device.

79. The use of claim 78, wherein the electrical energy storage device is a battery.

80. The use of claim 78 or 79 or the device of any one of claims 70-78, wherein the electrical energy storage device is in a microhybrid, start-stop hybrid, mild-hybrid vehicle, vehicle with electric turbocharging, vehicle with regenerative braking, hybrid vehicle, an electric vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system.

81. Use of a device comprising the carbon material of any one of claims 1-69 for storage and distribution of electrical energy.

82. The use of claim 81, wherein the device is a battery.

83. The use of any one of claim 81 or 82, wherein the device is in a microhybrid, start-stop hybrid, mild-hybrid vehicle, vehicle with electric turbocharging, vehicle with regenerative braking, hybrid vehicle, an electric vehicle, industrial motive power such as forklifts, electric bikes, golf carts, aerospace applications, a power storage and distribution grid, a solar or wind power system, a power backup system such as emergency backup for portable military backup, hospitals or military infrastructure, and manufacturing backup or a cellular tower power system.
